(19) United States
(12) Patent Application Publication
(10) Pub. No.: US 2004/0093817 A1
(43) Pub. Date: May 20, 2004

(54) Refinements to the construction systems for structures in reinforced concrete or some other material by means of high-precision integral modular forms

(76) Inventor: Salvador Pujol Barcons, Puerto de Santa Maria (ES)

Correspondence Address: Striker, Striker & Stenby, 103 East Neck Road, Huntington, NY, 11743, US

(21) Appl. No.: 10/697,203

(22) Filed: Oct. 30, 2003

(30) Foreign Application Priority Data
Nov. 18, 2002 (ES) 200202648

(51) Int. Cl. E04B 1/00; E02D 1/00; E04G 1/00; B28B 7/22; E04F 10/00

(52) U.S. Cl. 52/294; 249/13

(57) ABSTRACT

A foundation framework for structures in a reinforced setting material includes a foundation raft with a form having a plurality of modular panels and angular reinforcements for joining at least two faces of at least one right-angle dihedral formed by faces of the modular panels. A layout and positioning template is disposed on top of the form of the foundation raft for correctly dimensioning, positioning, and fitting walls, installations and reinforcements in the foundation raft. Adjustment legs for centering the layout and positioning template are provided, as well as self-centering clamps and a stabilizer having security pins and an anchorage mechanism for securing the form to a support surface.

### SCOPE OF INVENTION

The refinements proposed in the present invention patent consist, essentially, of the improvement and optimisation with regards to mechanisation, industrialisation and operability of the various elements, parts, panels and fittings in the system referred to in the previous patent number P9401135 from the same applicant, as well as the creation of other new elements that come to meet an essential demand in the field of construction in general and, specifically, in the complete construction sequence for the present system, as covered by this invention, which has been specially conceived for the construction of structures in reinforced concrete or any other material that solidifies.

Against this background, complete mechanisation of the construction system is achieved, using, for such purposes, the basic principles of high precision in each and every one of the parts, panels and fittings that make up the same, with the aim that both the construction process itself and the results obtained with the same will be governed by rationality and, consequently, prove the best and most efficient way of planning and executing a construction of any kind. In this way, high-quality finishes are achieved, which do not require subsequent treatments, which has the direct repercussion of substantial savings in time and costs, and, at the same time, operability is increased in the construction and the general end quality of structures, whatever their nature: buildings, individual dwellings, commercial premises, boundary walls, or similar structures.

It is a matter of using a revised and practical technology and working mechanics, which combines two essential aspects: natural materials from our own environment in conjunction with the practical mechanisation of the system used for construction. The principal material used is concrete, due to its resistance, durability and low cost, among other outstanding features. With this basic element and applying a mechanisation process that is monitored and systematised at every stage, it is possible to achieve simplified and rational execution of the work carried out by the worker on site, which does away, once and for all, with the skilled craftmanship aspect that has governed the field of construction since practically the beginning of time. In this way, it is possible to reduce, to the minimum, the faults, errors and defects that are the result of human improvisation and the absence of strict measures, which result in constant maladjustments in a structure during the construction process, since, with the present system, everything is planned down to the last detail from start to finish in the different logical phases within the process: measurements, distances, thicknesses, etc, irrespective of the type of structure to be realised, since the principles are common to all of them without being limitative with regards to their nature or the specific characteristics of each of them.

Owing to the fact that the invention is based on the principles and elements explained in the previous patent number P9401135, from the same applicant, with a view to extending and perfecting utilisation of the system as a whole, the present patent will contain points in common with the previous one with regards to the high-precision principle as well as in respect of some of the elements and parts described and referred to in the same. However, such repetition is fundamental for explaining each and every one of the refinements implemented in respect of the parts, tools and fittings, as well as for explaining and expounding, in its entirety, the improved planning that takes place in different phases or stages of the construction process that is the subject of the present invention.

In this way, as a whole, refinement of the main elements that make up the system is obtained, such improvements being aimed, essentially, at the practical aspect, and, which is even more important, achieving global mechanisation of the system from start to finish, which allows for achieving a construction sequence that is industrialised, safe, rational, fast and economic, thanks to logical and detailed planning of the phases that have to be carried out within the construction process, in order to obtain excellent results.

Purpose of Invention

Details are provided, below, of the full and complete construction sequence arranged in chronological order, and accompanied by drawings and technical information for the construction of a single-family dwelling. This has been taken by way of an example, for reference purposes, for describing the system covered by the present patent, since it is a middle term in construction values as far as dimensions are concerned. However, the system explained, as will be described below, can be applied to any type of construction, since it involves a generalised principle that can be freely adapted to suit the specific characteristics of each individual construction as well as standards in force and specific regulations in each area considered within the general field of construction, such as sound-proofing, thicknesses, lifetime and quality of materials, resistances, basic standards for electrical and sanitary installations, etc.

The basis for the construction system covered by the present patent is shared with that indicated in the previous patent from the same applicant. It consists of constructing in integral monolithic manner, having as its maxim the principle of high precision, and aiming, at all times, to bring about quality and resistance of the construction, as well as savings in terms of time and the actual cost of the structure, all of this on the basis of technical planning and proper design of the moulds, modules and parts for each of the constructions to be realised, such work assisting enormously with work on site.

On the basis of what has already been stated, and in the knowledge that many practical and functional elements are available, as referred to in the previous patent from the same applicant, the new development stems from conversion of such elements into operational elements in a rational manner. That is to say, there is indication of what the operating sequence to be followed for construction should be and how existing elements have to be coordinated with the refinements proposed and the new developments put forward in order to achieve, in short, a major generalised improvement in operation and coordination of construction work with the said system, which, with its mechanisms that are proof against human error, ensures that site workers do not have to improvise at any time to find temporary or alternative solutions for the various problems that may arise during the construction process.

State of Technique

On the basis of the basic elements and techniques used in high-precision modular construction, as explained in the previous patent no. P9401135 granted in favour of the same applicant, the present invention patent aims to resolve difficulties and shortcomings arising in the construction sequence for the high-precision modular construction system described in the said patent. Such shortcomings, the result of a lack of coordination in the various phases of construction, as well as the existence of operational gaps in the construction process, prejudice its very essence, since the lack of rational organisation and coordination impair the systematic and industrialised character that is the basic and new point of reference for the high-precision modular construction system that is the subject of the present patent.

Most of the refinements that form part of the system, as developed in the previous patent no. P9401135 from the same applicant, are improved in the system covered by the present patent, since it is complemented and extended by new parts and fittings which afford the system considerable improvements in the construction process and, consequently, in the results obtained through the use thereof indicated.

This important improvement in terms of functionality and the greater diversity of operational elements is duly accompanied by coordination and rational organisation of the high-precision modular construction process. There is therefore evolution of the system insofar as it ensures the creation of a real construction industry that is fully mechanised, which allows for planning work and the various tasks by making the best possible use of the materials used, the times necessary for building a fully finished, monolithic and integral construction and the costs thereof. This is an orderly and organised construction system that leaves no room for improvisation, which makes provision for the purposes, results and means of achieving the same in the best, fastest and most efficient manner possible, this being the main contribution of the present patent to refinements in the high-precision modular and integral formwork systems described in the previous patent from the same applicant.

This system allows for the systematic construction of any kind of building without constructional limitations, that is to say, all the elements necessary are provided for and designed, so that, subsequently, they can serve their purpose within each of the phases in the construction process, irrespective of the kind of building they are used on, in terms of design, architecture, dimensions, etc. The system therefore becomes a mechanised and systematic principle that uses certain specific elements in a defined order and operating method, with a view to optimising the process at each stage and as a whole. Thus, using manpower than is not necessarily specialised, high output is achieved, saving time, thanks to prior planning and the studied mechanical process that is implemented, using elements and tools inherent in the system, as well as lowering costs, since it allows for realising any kind of construction of integral monolithic form with integrated electrical and sanitary installations, optimum quality of finishes, provision for all manner of detail, etc., without requiring any prior treatment or subsequent work and modifications, which implies a considerable saving in all fields.

As an essential point of reference for the present patent, the vital importance of the manufacture of each of the parts, modules and moulds that make up the system is strictly maintained, with a dimensional tolerance of tenths of a millimetre, so that the fit between the same is always perfect. Moreover, this high-precision manufacture is accompanied by the use of specific tools that do not damage the parts that make up the system, as well as other elements which contribute, in simple but safe and efficient form, to ensuring that the process of installing and dismantling the mould is realised under safe conditions, in the most efficient manner possible and in such a way as to guarantee, at all times, achievement of the results envisaged. All of this allows for achieving an integral monolithic construction that is completely smooth and flat on its surfaces which, thanks to the integration and simplification of the construction process, to the exact fit between all parts that make up the same and to perfect alignment which is achieved by means of the construction method implemented at each stage in the sequence, does not require plastering, floating or any other subsequent surface treatments, which means that the costs and time taken are considerably reduced. Therefore, the system covered by the invention constitutes a modem, complete, safe and viable alternative to traditional construction, for reasons such as foresight and overall planning of the work in the technical office, the high precision that governs the system from the start, the flexibility of the construction sequence achieved thanks to the high levels of coordination for all phases in the process, the procedures implemented and the inherent tools and technologies used.

All the parts and elements used for construction with this integral and modular system are studied and designed so that they afford great durability in practice without, at any time, forfeiting precision in terms of adjustment with one another, or suffering deformation or deterioration in respect of their structure. This precision is essential at all stages of the construction sequence, since it is what determines the alignments, plumb levels, squaring and levelling of the construction itself. It therefore results in a construction that is perfect, flexible in terms of the process for installing and dismantling the modular structure, fast, efficient and low-cost.

The present patent also affords diversity in terms of alternative solutions for problems that exist within the field of modular construction. The system does not try to resolve certain specific situations that may arise at the time of implementing a specific construction idea, but aims to put forward a new method of construction, in which rationality, organisation, coordination and mechanisation of each of the phases of construction are reflected as a whole, taking on greater dimensions as a state-of-the-art construction system with great future potential.

Another aspect of the present invention is the improvement put forward regarding operability of the system. Thanks to the use of elements referred to in the previous patent belonging to the same applicant, that have now been improved, and to other new ones which will be listed and described below, it is ensured that both installation and dismantling of the mould necessary for construction are realised with total precision and, at the same time, quickly, simply and without effort on the part of the construction worker. For this, the patent in question covers the development of a series of tools, parts and implements specifically conceived and designed for the system, without it being necessary to resort to extraneous bought-in elements and parts. The system comprises all the operational elements necessary for each of the phases inherent in the construction sequence, consequently constituting a mechanised whole which allows for industrialised construction with the consequent savings in time and money that this implies and, at the same time, improving quality and precision.

All the elements, parts, tools and implements within the system combine to form a sequential process that is planned, orderly and monitored by the construction method itself via a whole series of verification elements, such as the layout and positioning template, the wall template, centring elements, etc. which will be specified below, making the system a mechanised and exact method that allows for implementing any constructional idea in an industrialised manner, by optimising each phase in the sequence in order to achieve a high yield at low cost and with all the guarantees that may be required.

With a view to detailing the refinements and new developments of the system covered by the present patent as fully as possible, and explaining clearly the new dimension that this takes on, thanks to mechanisation of the construction sequence, a series of drawings is attached to this description which, purely by way of illustration and without being limitative, accurately detail the refinements to the high-precision integral and modular construction system covered by the present invention. By following the construction process for a single-family dwelling, basically taken as a reference example for the chronological and orderly explanation of the said system, the actual construction sequence for the process is detailed and described below, in such a way that the operational order that has to be followed for implementing the new construction concept put forward in this invention patent is rigorously explained. This is a method of construction based on an industrialised system via the mechanisation of each and every one of the elements, parts and operations that make up the construction phases thereof, as well as rationalisation of the process, aspects which result in the guaranteed attainment of maximum yield, by considerably cutting costs and noticeably reducing timescales.

### Operational Chronological Order of Construction Process

There is an account, below, of practical implementation of the refinements to the high-precision integral modular construction system covered by the present patent, following the rational, mechanised and systematised operational order that is the key to the system.

The importance of the said organisational structure lies in the fact that it is the only formula capable of implementing any construction idea, without limits of any kind, guaranteeing strict precision in the results that are achieved, thanks to the new parts, modular panels and other new elements that form part of the system, the rigorous nature of the construction process and the mechanised and rationalised methods that are implemented.

Therefore, and starting at the beginning of the process, there is a list of each of the reference figures that visually support the general workings of the industrialised high-precision modular construction system that is the subject of the present invention patent.

In these drawings:

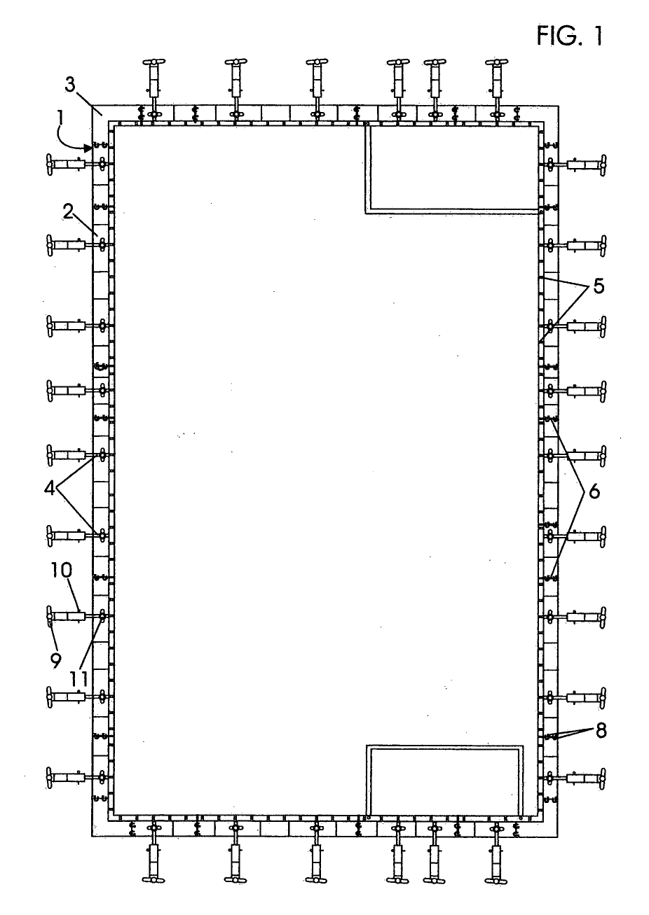

FIG. 1 is a plan view of a complete foundations formwork, fully assembled and anchored to the ground, for fabrication of the foundation raft for the dwelling to be constructed;

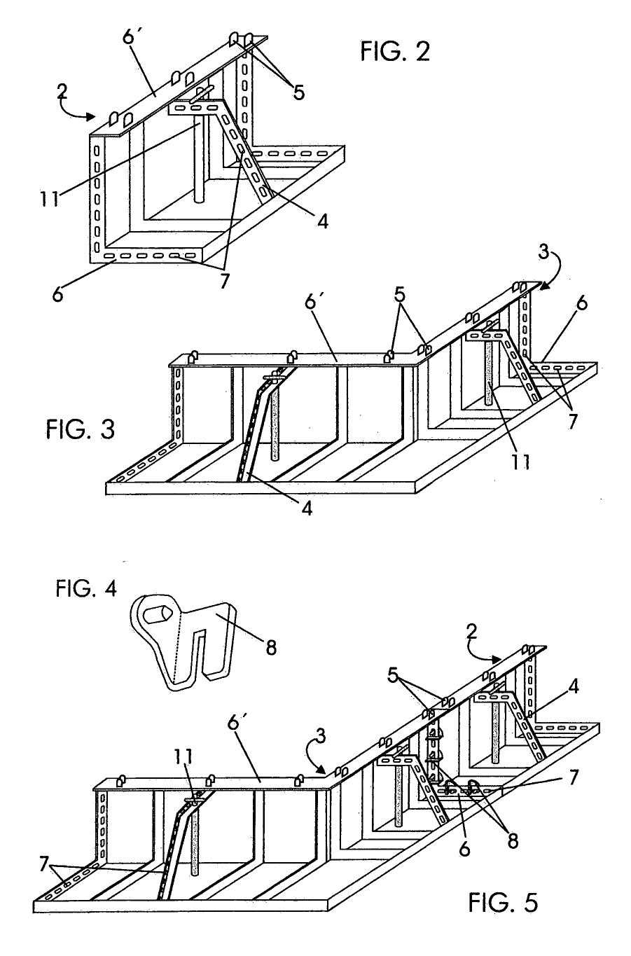

FIG. 2 shows a detail, in perspective, of a simple standard modular dihedral part for assembly of the formwork for the foundation raft for the dwelling;

FIG. 3 is another detail, likewise in perspective, of another part for installation of the formwork for the foundation raft, consisting of an angle, likewise dihedral, for the corners of the same formwork;

FIG. 4 is a view, in perspective, of a standard self-centring clamp for joining the various modular parts that make up the system with total precision;

FIG. 5 shows a detail, likewise in perspective, of the way in which the basic parts of the formwork for the foundation raft, as represented in FIGS. 2 and 3, are joined together, by means of the self-centring clamps in FIG. 4;

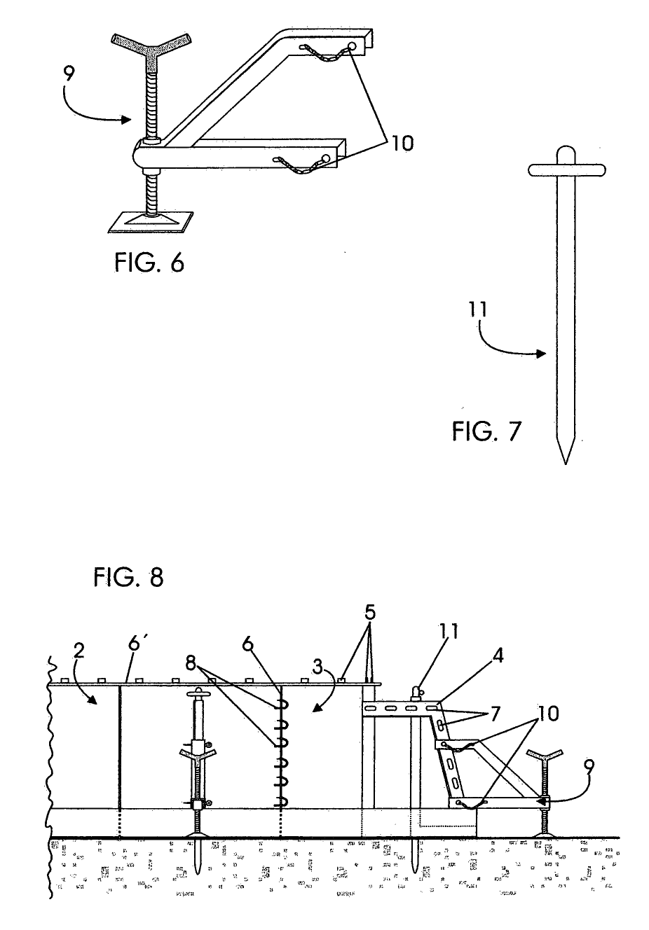

FIG. 6 is another detail, in perspective, of a type of stabiliser for the formwork for the foundation raft;

FIG. 7 is a view of an anchorage for securing the formwork for the foundation raft to the ground;

FIG. 8 shows a detail, in cross-section, of the same formwork for the foundation raft for the dwelling, in which the elements that make up the same and which serve for anchoring, seating, aligning and stabilising the same with total precision can be seen;

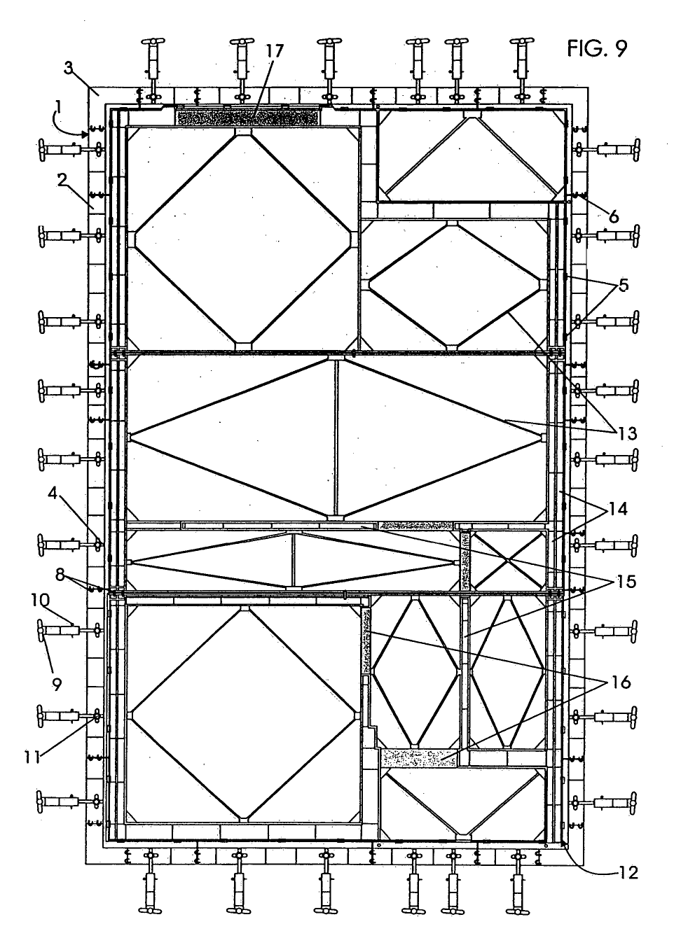

FIG. 9 shows a plan view of a layout and positioning template for walls, installations and reinforcements positioned on top of the formwork for the foundation raft, fully mounted and anchored to the ground;

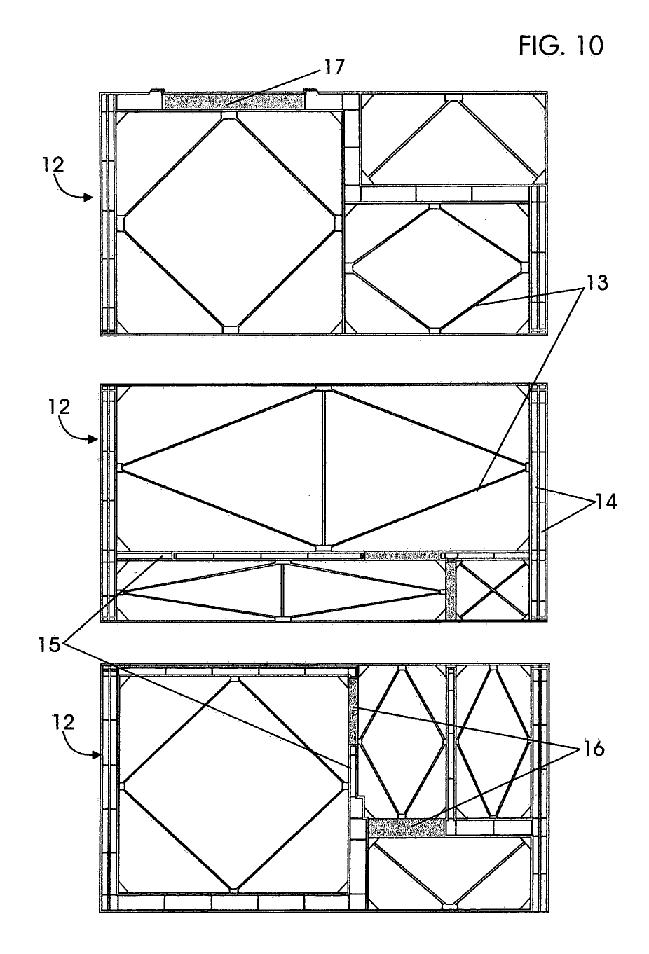

FIG. 10 shows a plan view of the layout and positioning template, separated, in this case, into three elements that make up the same, to facilitate manoeuvrability;

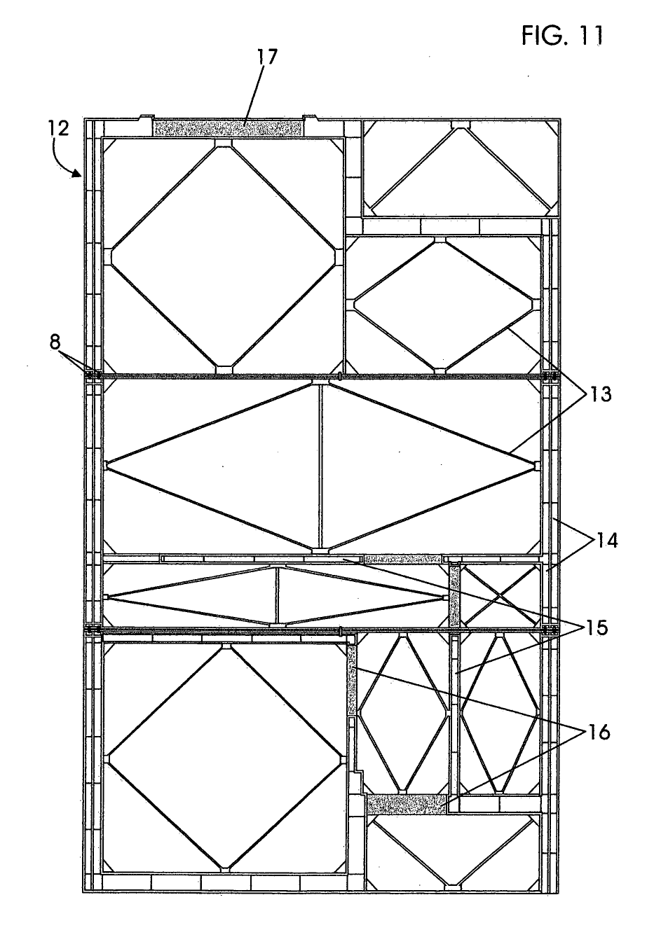

FIG. 11 shows the same layout and positioning template as in the previous figure, but this time with the three elements joined together to form a single part which will serve as a basic element for measurement and positioning of the walls, installations and reinforcements of what will be the foundation raft, both before and after concreting;

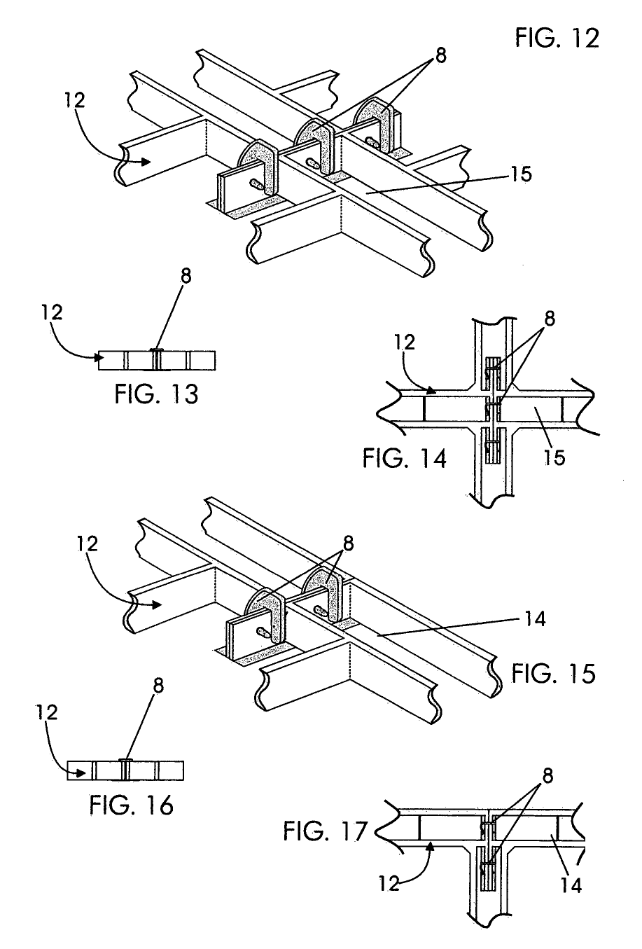

FIG. 12 is a detail, in perspective, showing the system for joining two elements of the layout and positioning template in the central areas of the same, using self-centring clamps;

FIG. 13 is a detail, in cross-section, of the same central joint between elements of the layout and positioning template, using a self-centring clamp, as represented in the previous figure;

FIG. 14 is another detail, in plan view, of the same central joint using self-centring clamps as per the previous two figures, 12 and 13;

FIG. 15 is a detail, in perspective, showing the system for joining two elements of the layout and positioning template at the corners of the same using self-centring clamps;

FIG. 16 is a detail, in cross-section, of the same joint at the corner of two elements of the layout and positioning template using self-centring clamps, as represented in the previous figure;

FIG. 17 is another detail, in plan view, of the same joint at the corner using self-centring clamps as per the two previous figures, 15 and 16;

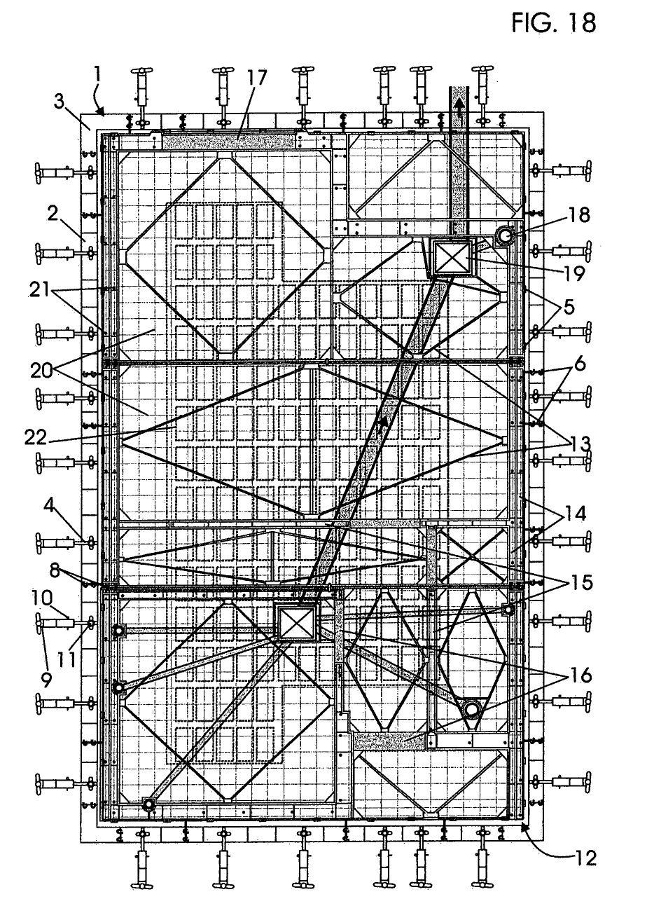

FIG. 18 shows a plan view of the layout and positioning template, once its elements have been joined together, positioned on top of the complete anchored formwork for the foundation raft, where, thanks to such template, all the sanitary and electrical installations, as well as insulation of the foundation raft, are provided for, positioned and centred, leaving it ready for proceeding with concreting;

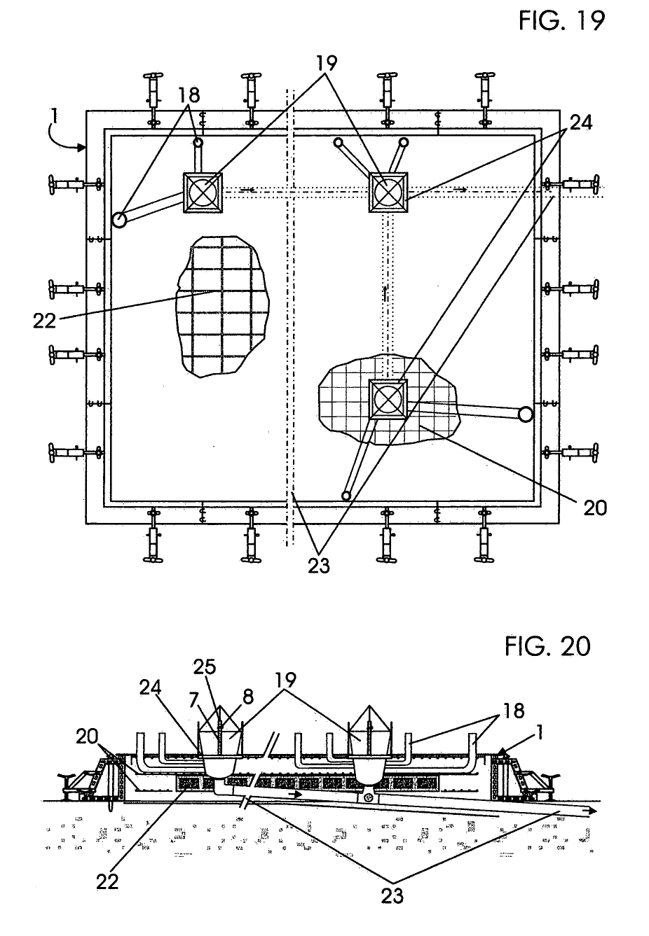

FIG. 19 is a plan view showing the location of the sanitation chambers and piping within the formwork for the foundation raft, as well as showing the position of reinforcements and insulation inside what will be the foundation raft, once concreting has taken place and the said formwork removed;

FIG. 20 is a section view of the previous figure, showing the position of the elements located within the said formwork for the foundation raft and which also allows for seeing the gradient of the sanitation drains;

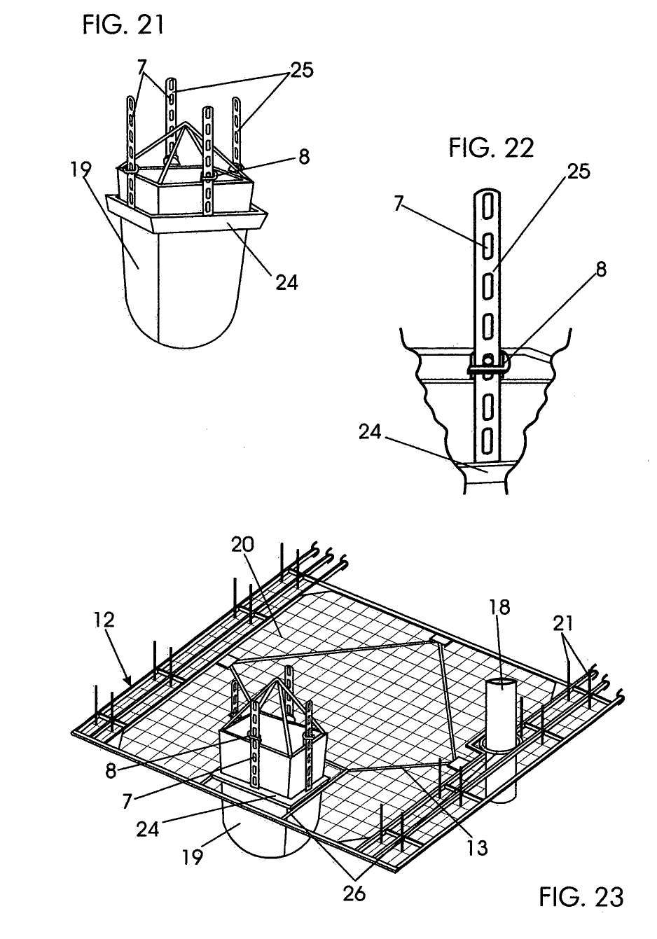

FIG. 21 is a detail, in perspective, of the mould for a sanitation chamber in the foundation raft;

FIG. 22 is a detail, in cross-section, of the system for securing the frame for the sanitation chamber cover using a self-centring clamp;

FIG. 23 shows a detail, in perspective, of part of a layout and positioning template, the centring elements of which, provided for in the template itself, correctly centre and position the outlets from the piping and sanitation chambers, as well as the position of reinforcements and standby bars for the peripheral walls;

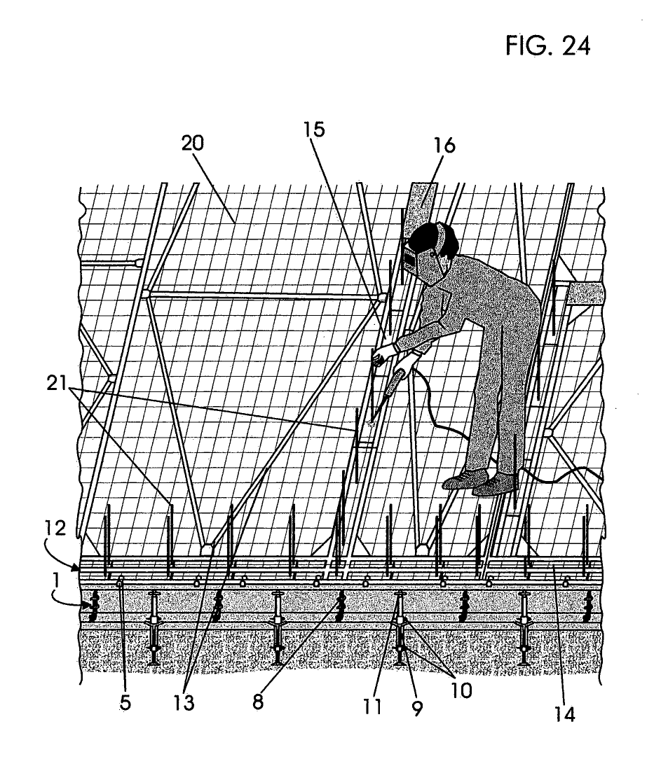

FIG. 24 is a detail, in perspective, showing the moment of welding the standby bars for partition walls to the reinforcements positioned inside the formwork for the foundation raft, in accordance with the positions indicated by the layout and positioning template situated and fitted within the formwork;

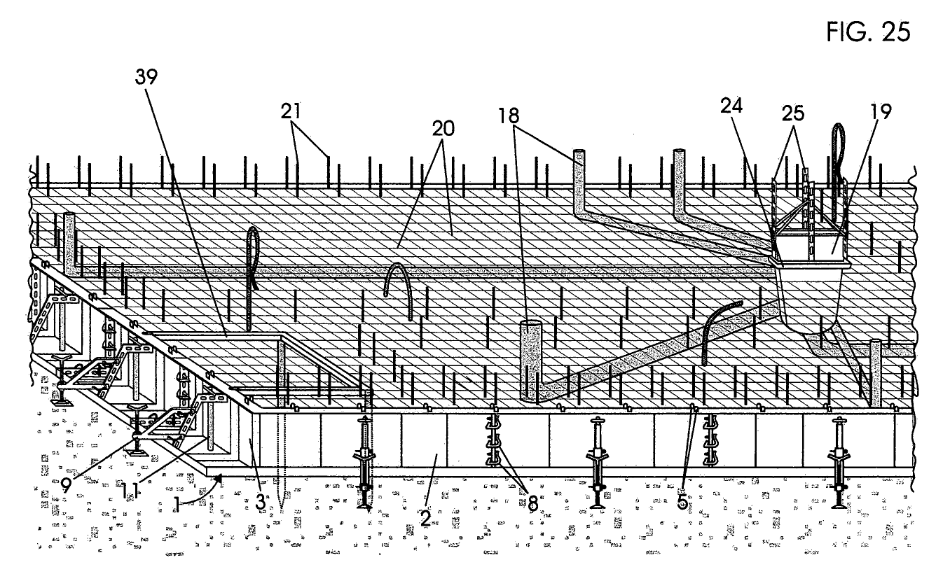

FIG. 25 is a general perspective of a large area of the formwork for the foundation raft, without the layout and positioning template, and with all the elements necessary for proceeding with concreting the inside of the formwork, thus fabricating the necessary foundation raft for the dwelling;

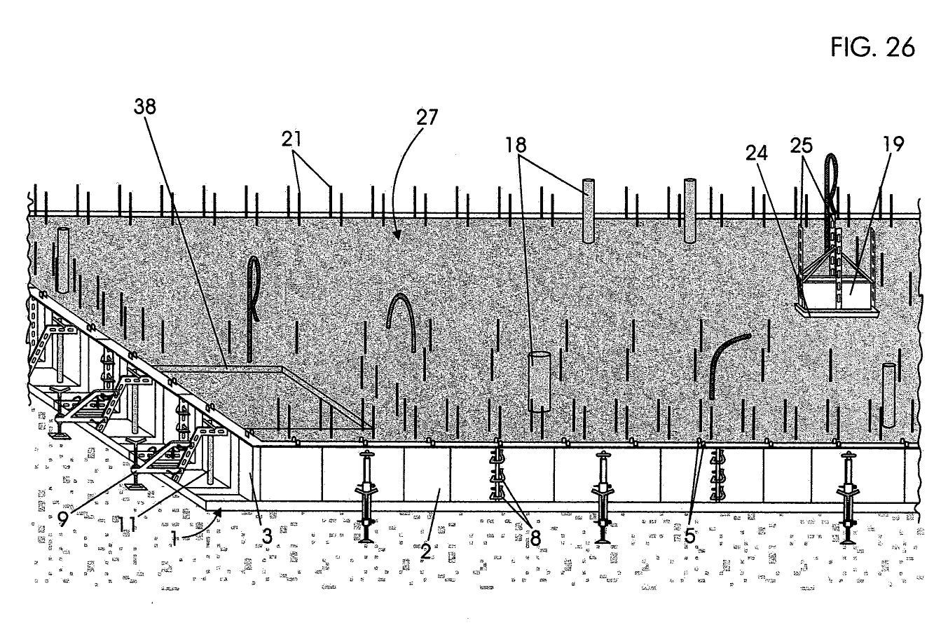

FIG. 26 shows the same perspective as the previous figure, but with the foundation raft duly concreted, and containing all the installations inside the same, but without the formwork for the foundations for the same being removed;

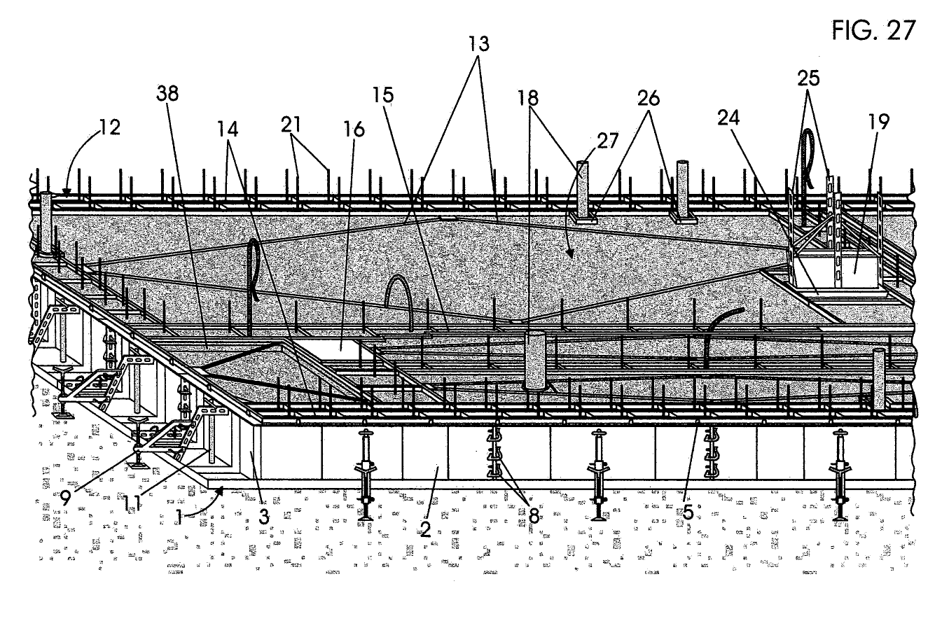

FIG. 27 again shows the same general perspective view of the concreted foundation raft, with the formwork not yet removed, but with the layout and positioning template again placed in position on top of the same in order to check that all elements and installations are in the correct position and have not suffered any variation during the concreting process, and for indicating the points at which U-shaped parts are to be driven in, to form stops for centring of the appropriate walls and partitions of the dwelling;

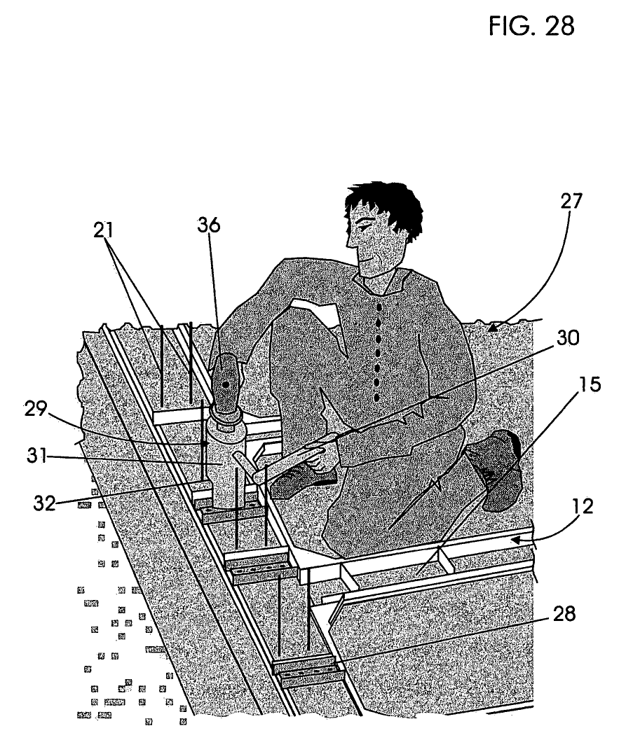

FIG. 28 is a detail, in perspective, showing the operation of driving in the said U-shaped stop parts using a manual percussion unit expressly designed for such purposes;

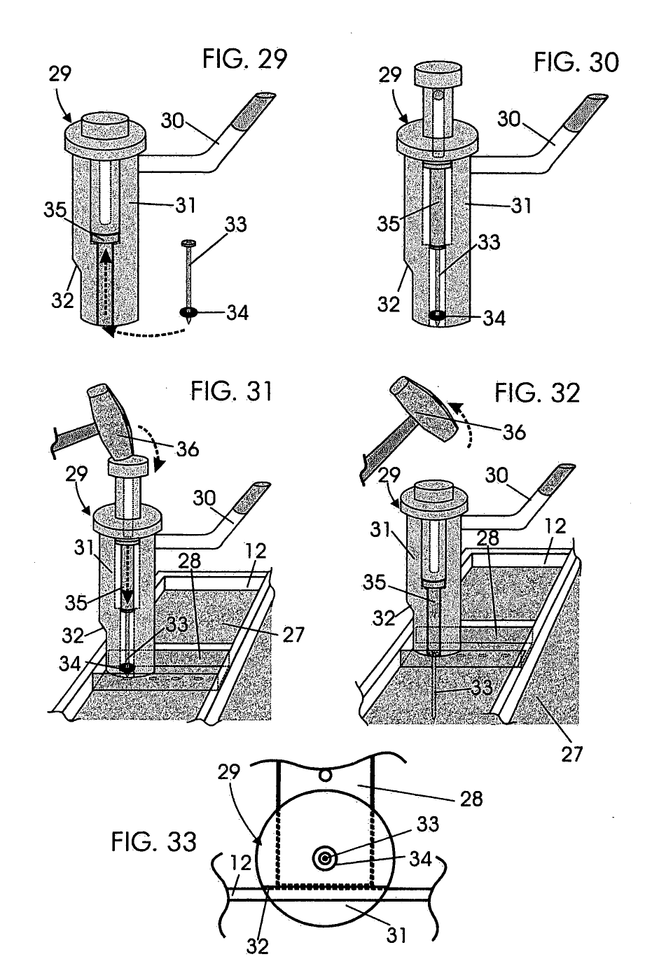

FIGS. 29, 30, 31 and 32 show, in detailed perspectives, the different stages in the sequence of deployment and operation of the manual percussion unit for securing the U-shaped stop pieces for walls in the positions indicated by the layout and positioning template;

FIG. 33 is a plan view of the interior of the manual percussion unit with a view to clarifying, to the maximum, the system for securing the U-shaped stop parts to the foundation raft by means of the said manual percussion unit;

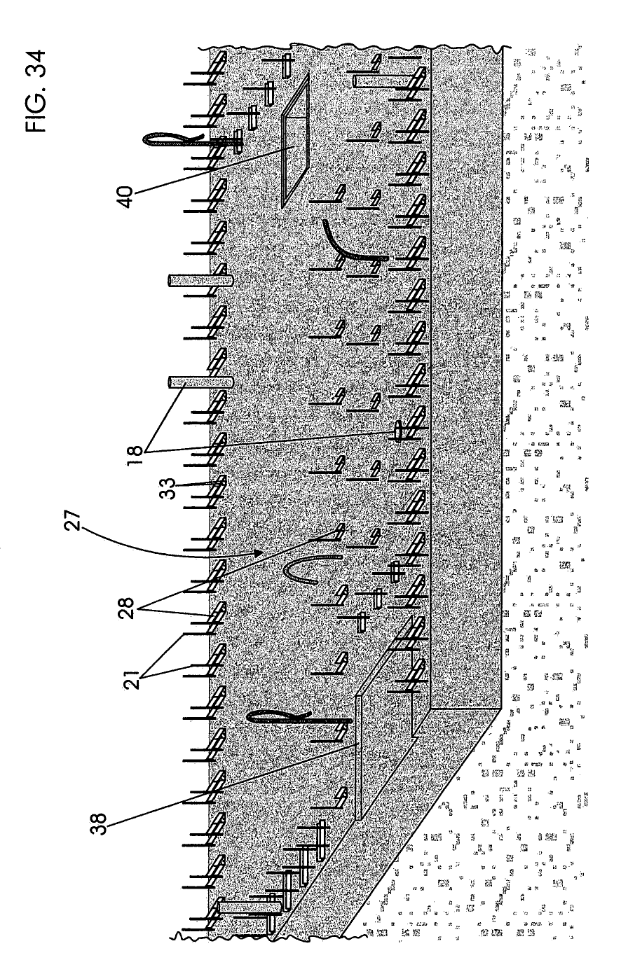

FIG. 34 shows, in perspective, a large area of the foundation raft for the dwelling already concreted and with the formwork removed, with the U-shaped stop parts for peripheral walls and internal partitions nailed in position and with the sanitation and electrical installations already integrated into the said raft;

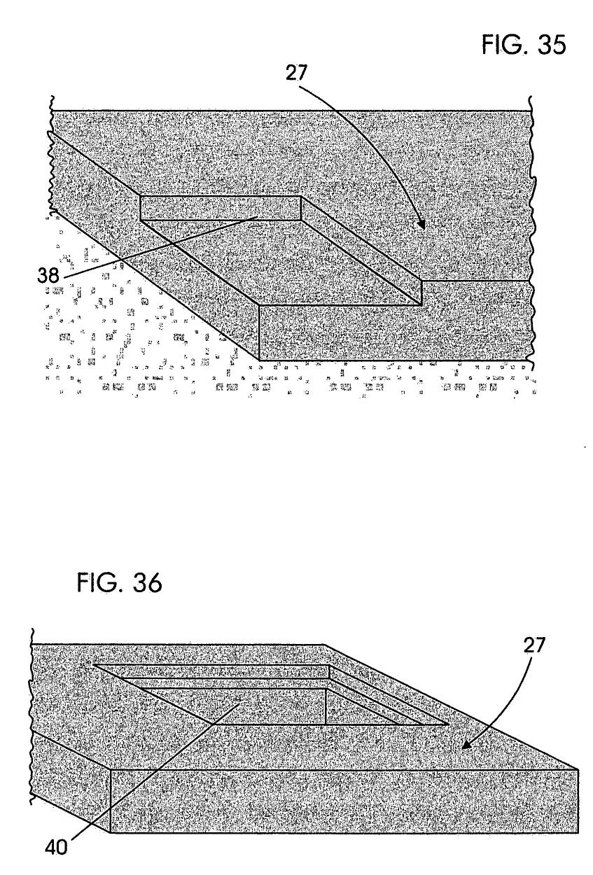

FIG. 35 is a detail, in perspective, of a step leading into the dwelling formed in the said foundation raft once concreting of the inside of the foundations formwork has been completed;

FIG. 36 is another detail, in perspective, of a sanitation chamber likewise formed in the said foundation raft once concreting of the inside of the foundation raft formwork has been completed and following removal of the mould that gave form to the said chamber;

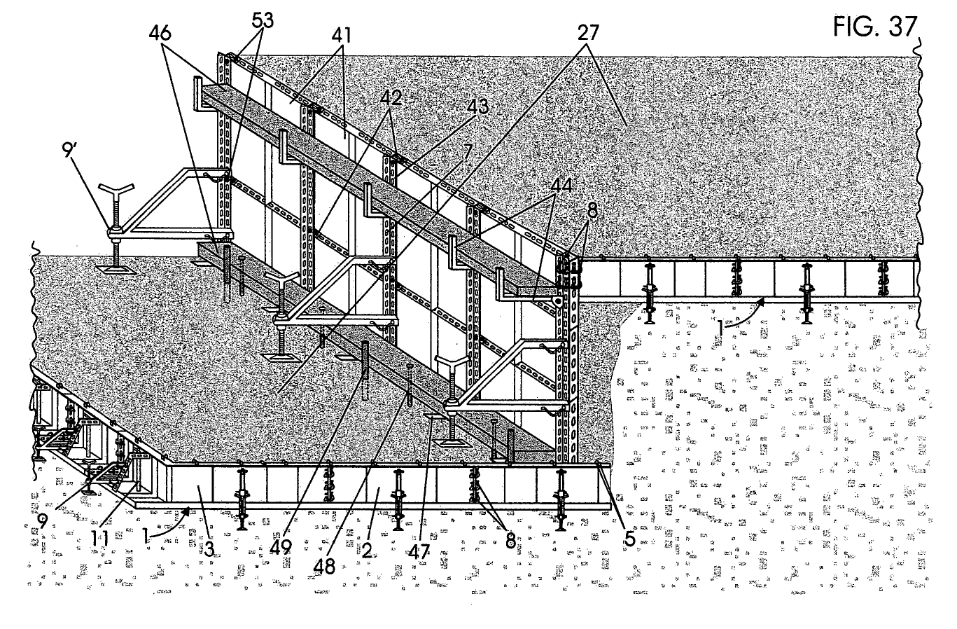

FIG. 37 is a view in perspective, suitably cross-sectioned, of the formwork system conceived for constructing foundation rafts on land where there are differences in level or terraces of variable heights;

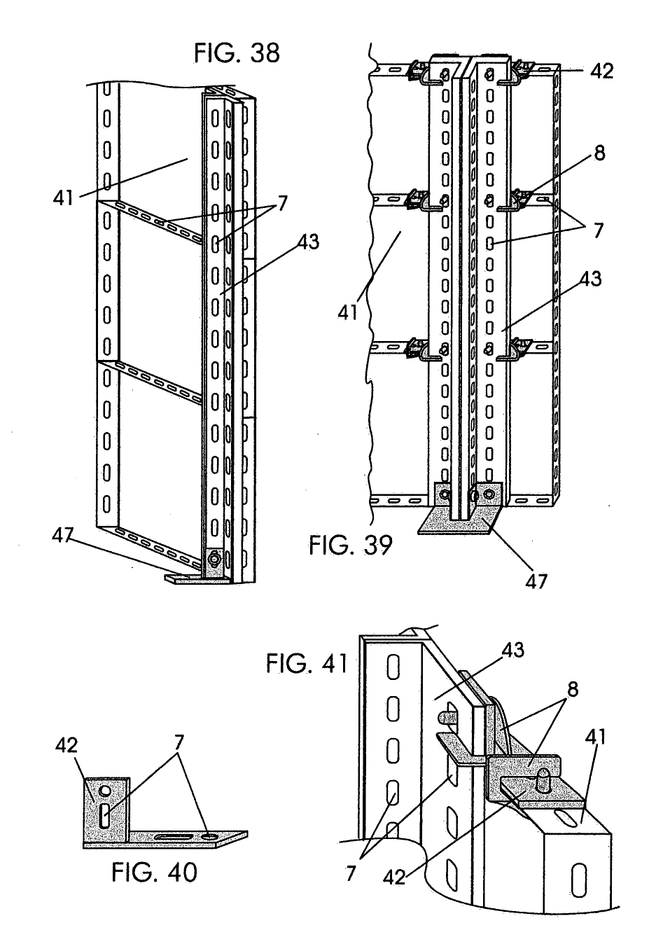

FIG. 38 is a detail, in perspective, of the securing angle profile that forms part of the formwork system for the foundation raft to be constructed in cases of differences in level, as indicated in the previous figure;

FIG. 39 shows a front perspective of the same angle as per the previous figure;

FIG. 40 is a detail, in perspective, of a plate for joining the angle that appears in FIGS. 38 and 39 to modular panels that form the formwork for the foundation raft on terraces or differences in ground level of variable heights;

FIG. 41 is a detail, likewise in perspective, showing how such a fastening, as depicted in the previous figure, is realised to attach the angle represented in FIGS. 38 and 39 to the modular panel, by means of the plate, using self-centring clamps;

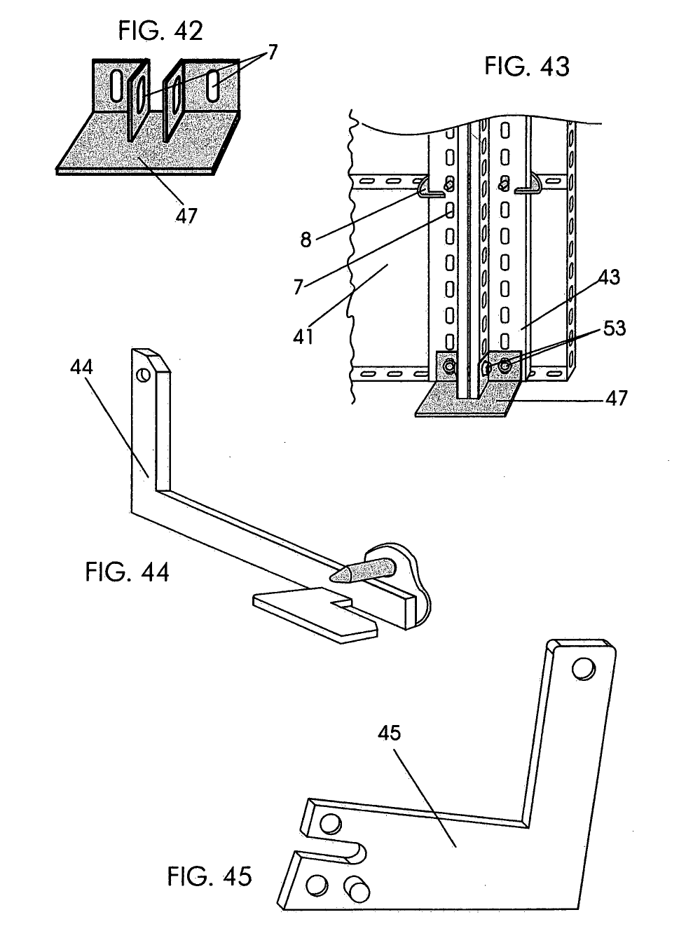

FIG. 42 is a view, in perspective, of a support foot which is attached to the angle, as shown in FIGS. 38 and 39, and on which an alignment joist (not represented here) will be positioned for the foundation raft formwork on terraces or differences in ground level of variable heights, as considered in FIG. 37;

FIG. 43 shows an enlarged detail of FIG. 39 and likewise a perspective view of the method of securing the support foot in the previous figure to the angle that is attached to the modular formwork panel;

FIG. 44 represents, in perspective, a bracket for securing the appropriate joist to be installed for upper alignment of the foundation raft formwork on terraces of variable height;

FIG. 45 is a view, in perspective, of a variant of the bracket in the previous figure, but with a reinforced structure;

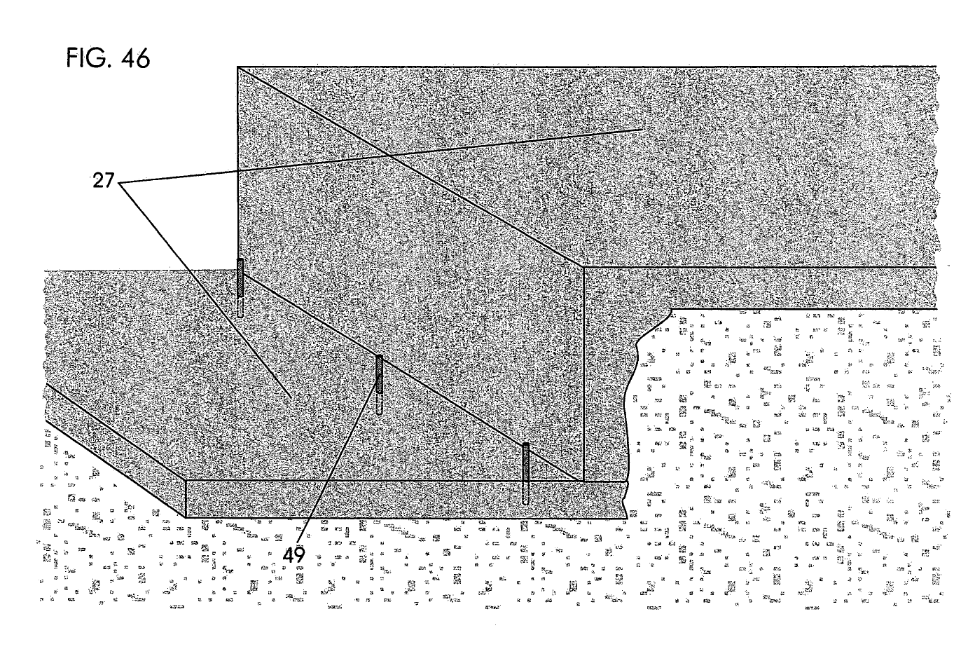

FIG. 46 is a view, in perspective, of the foundation raft for terraces of variable heights already concreted and with the foundations formwork, shown under construction in FIG. 37, removed;

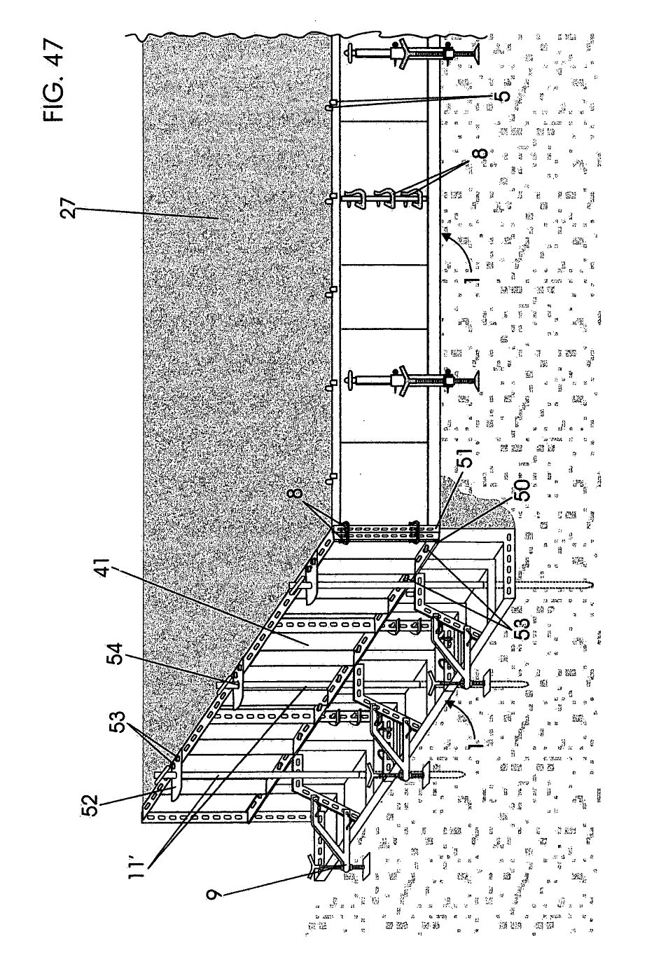

FIG. 47 is a perspective view, duly cross-sectioned, of the formwork system used for constructing the foundation raft on land where there are not very pronounced differences in levels or terraces;

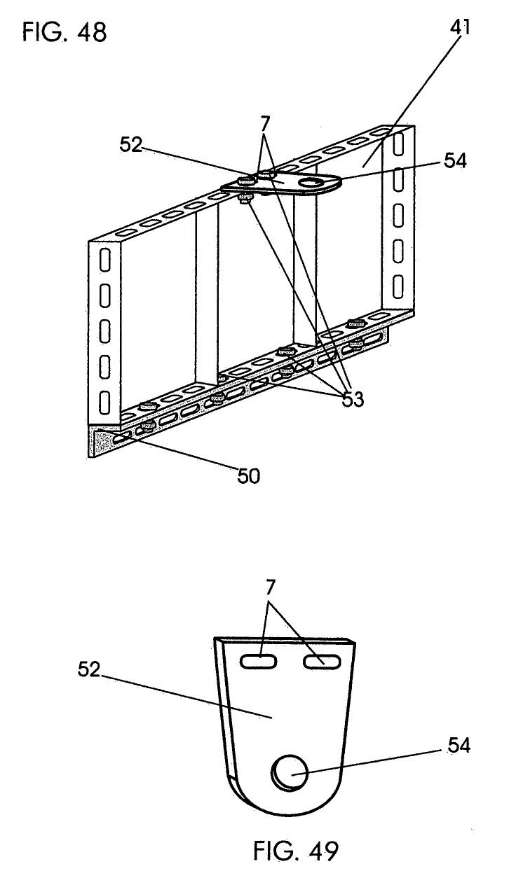

FIG. 48 represents, as an enlarged perspective, an assembly made up of a standard panel secured to a joining angle for panels and a securing plate for anchorages which are used in the formwork for foundation rafts on terraces or differences in ground level that are not very pronounced, as considered in the previous FIG. 47;

FIG. 49 is a perspective, likewise enlarged, of the said plate for securing the anchorage for the formwork of the type indicated in FIGS. 47 and 48;

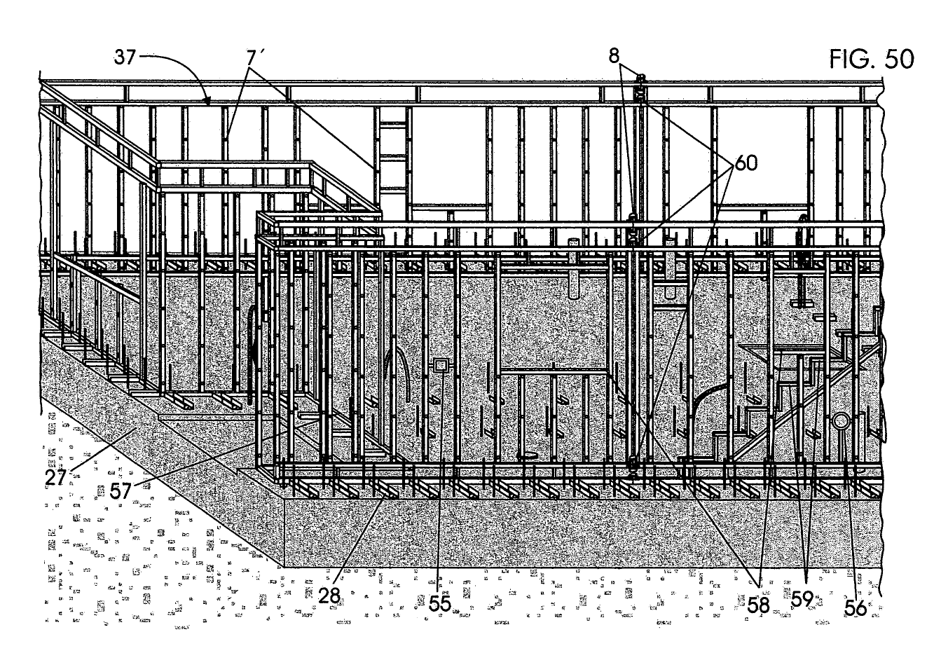

FIG. 50 shows a general perspective of a large part of a wall template positioned on top of the concreted foundation raft for the dwelling in order to make provision for the positioning of doors and windows in the walls, as well as the location of electrical boxes and outputs from sanitation piping and also the position of the steps in the stairway inside the dwelling;

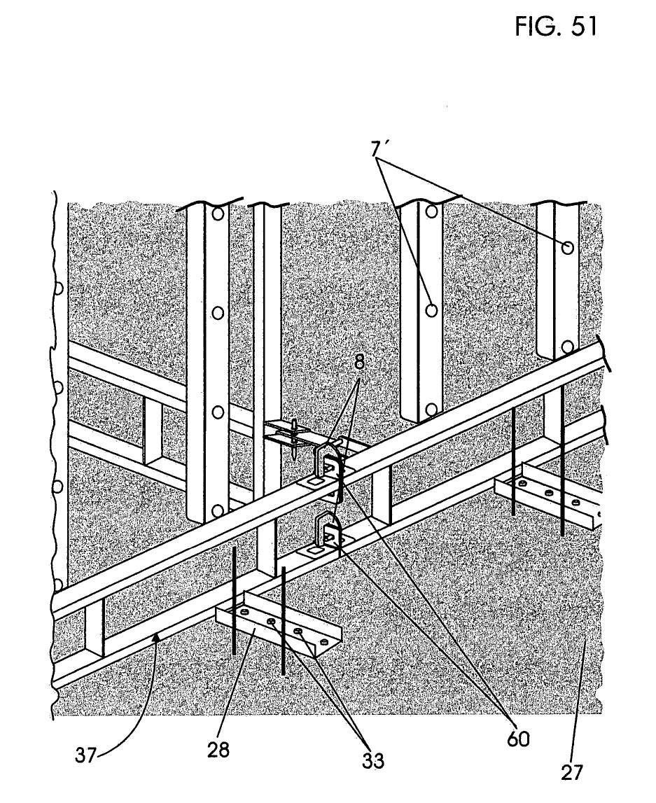

FIG. 51 shows a detail, on a larger scale, and in perspective, of the system for joining sections of the wall template using self-centring clamps of the type represented in FIG. 4;

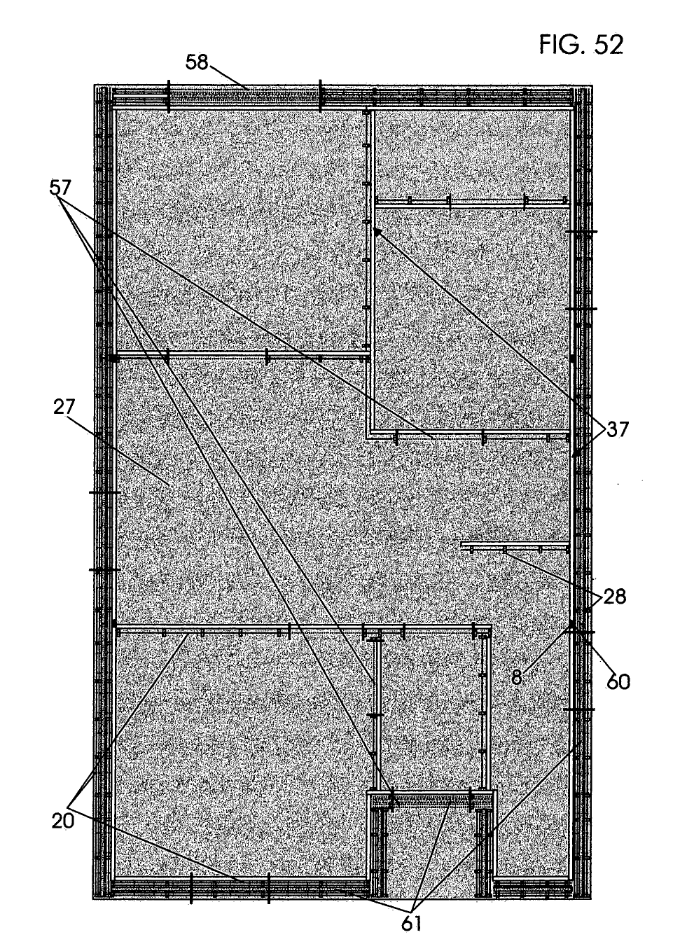

FIG. 52 shows a plan view of the concreted foundation raft for the dwelling with the wall template positioned on top of the raft, as well as the double reinforcements and peripheral insulation for the walls and also the simple reinforcements for the internal partitions of the dwelling;

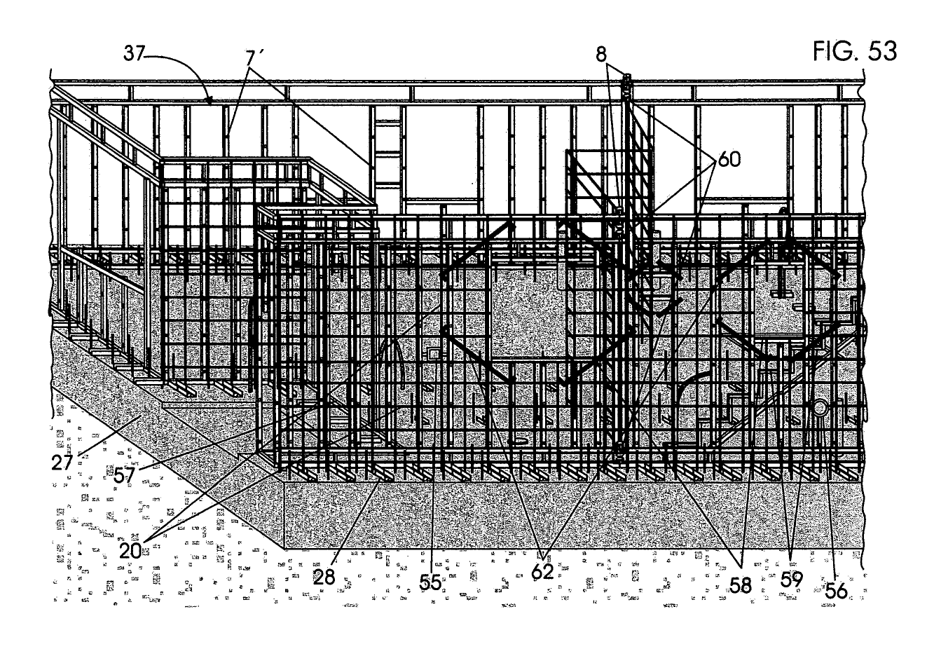

FIG. 53 is a perspective view of an initial phase in progressive installation of the reinforcements both for the peripheral walls and for the internal partitions of the dwelling, as per the indications and provisions determined using the said wall template;

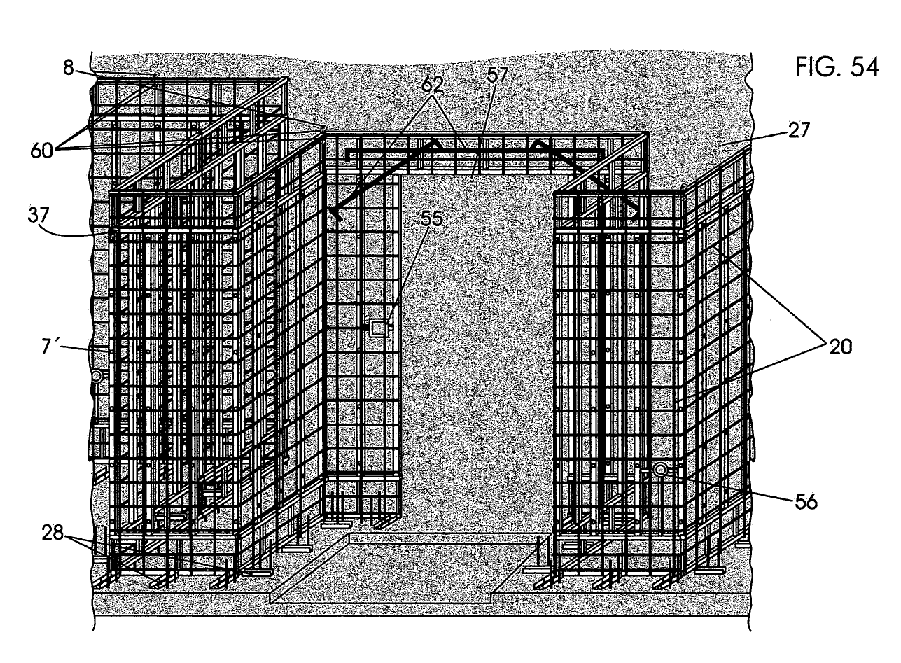

FIG. 54 is a detail, in perspective, of an entrance door to the dwelling, determined and marked out using the wall template and during an initial phase of installation of the reinforcements for the wall;

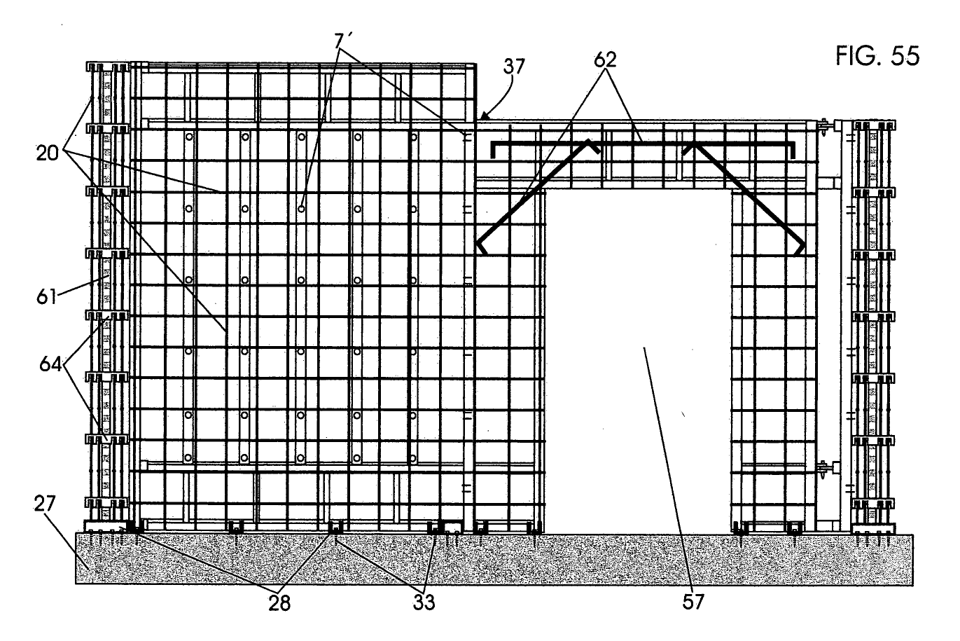

FIG. 55 is a detail, in cross-section, of the wall template for the internal partitions of the dwelling with the single reinforcements installed on the said template as per the indications thereof;

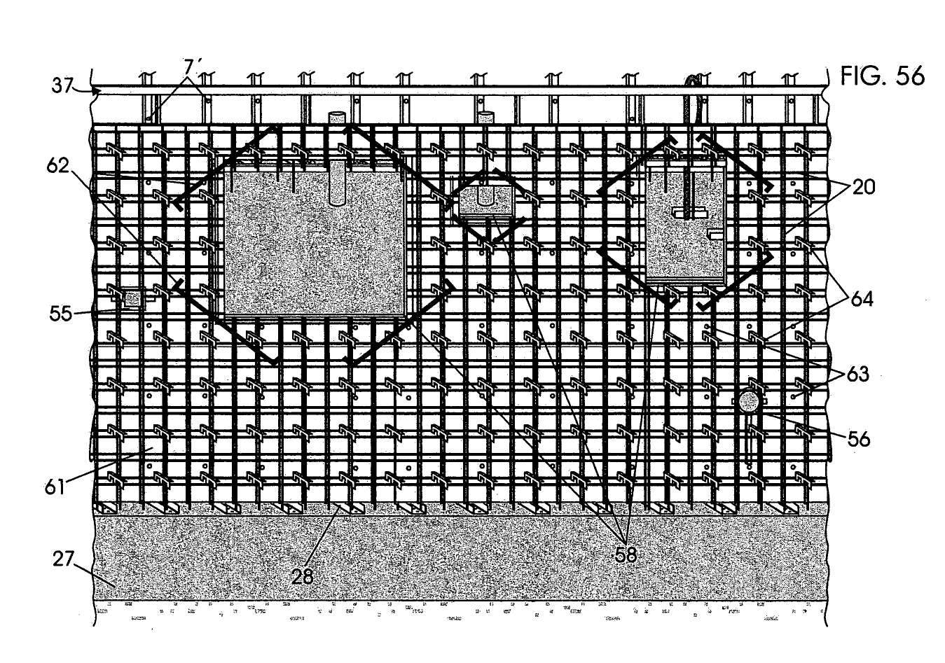

FIG. 56 shows a detail, in perspective, of a second phase in installation of the elements inherent in the wall template prior to installation of the mould to be realised, and showing the spaces set aside for positioning insulation in the peripheral walls of the dwelling respecting the spaces indicated in the said wall template for the positions of doors, windows and any kinds of installation necessary;

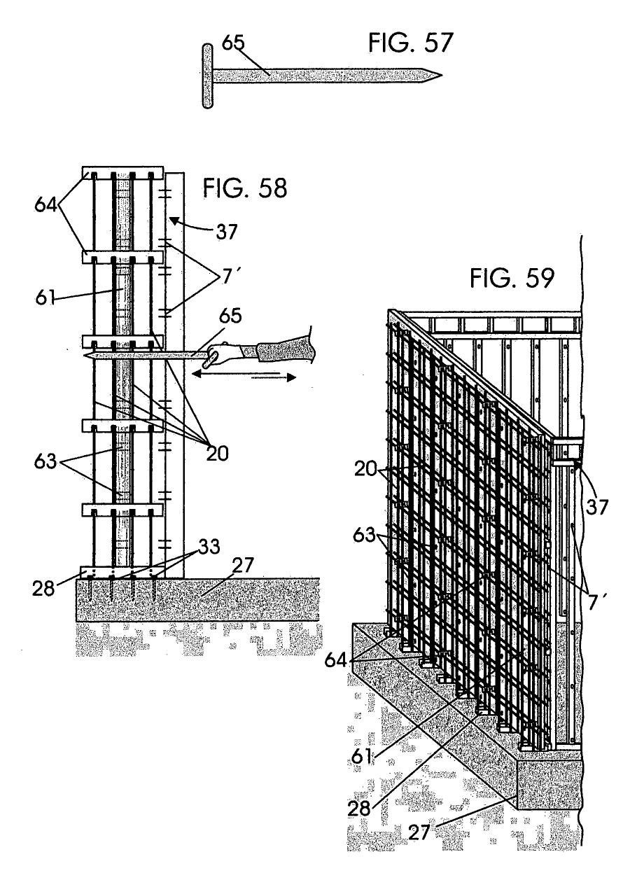

FIG. 57 shows a type of boring tool for piercing the insulation in the walls;

FIG. 58 is a detail, in cross-section, showing deployment of the boring tool in the previous figure for piercing the said insulation in the walls at the points specified and indicated by the wall template;

FIG. 59 shows a detail, in perspective, of one side of the wall template with the insulation in the peripheral wall held in place by the aforementioned double reinforcement bars, as represented in FIG. 52, and also permanent separators which secure the assembly;

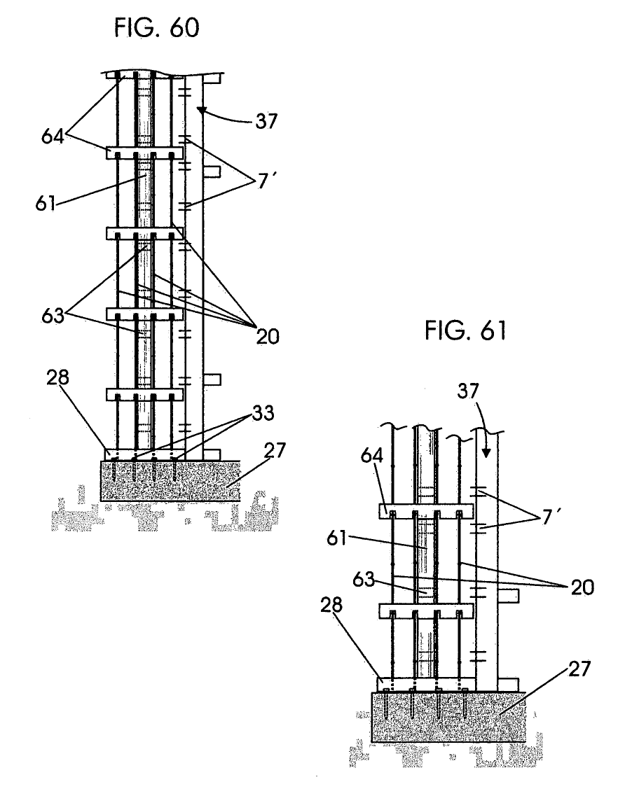

FIG. 60 is a section view showing the elements referred to in the previous figure;

FIG. 61 is an enlarged detail of FIG. 60;

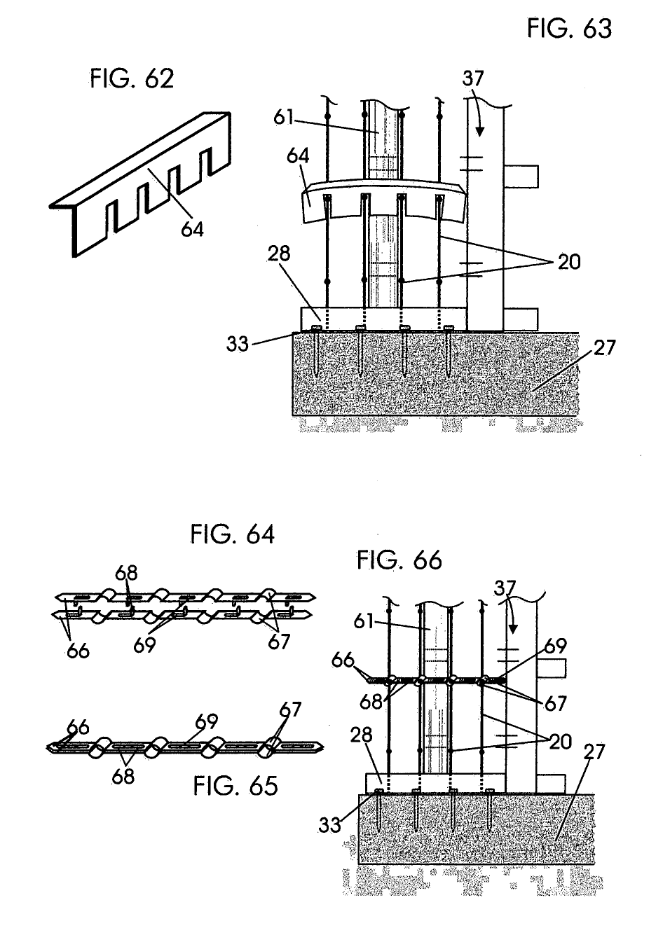

FIG. 62 is a view, in perspective, of one type of permanent separator with an L-shaped section, with recesses on one of its faces, as represented in the previous three figures;

FIG. 63 is a detail, in cross-section, of the installation and bending system used in respect of the separator represented in the previous figure and positioned on the reinforcements and insulation in the wall;

FIG. 64 is a detail, in perspective, of a variant of the permanent separator, this time comprising two matching halves provided with securing flanges, shown in the open position;

FIG. 65 is a detail, in perspective, of the same separator as in the previous figure in the closed position, achieved by folding down the said flanges;

FIG. 66 shows a detail, in cross-section, of the type of separator represented in the previous figure positioned on the reinforcements and insulation for the wall;

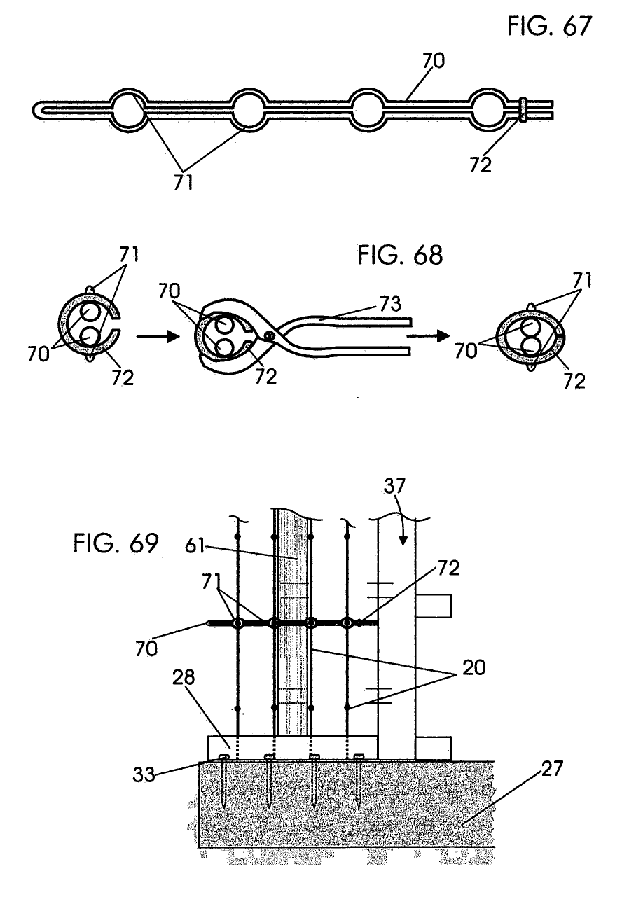

FIG. 67 shows another variant of the permanent separator/tie consisting of a single part with a circular cross-section folded back on itself and with matching semi-circular bends formed therein;

FIG. 68 shows, in cross-section, three views of the attachment of a washer that fits around the separator shown in the previous figure;

FIG. 69 is a detail, in cross-section, of the positioning of a separator of the type represented in the previous two figures;

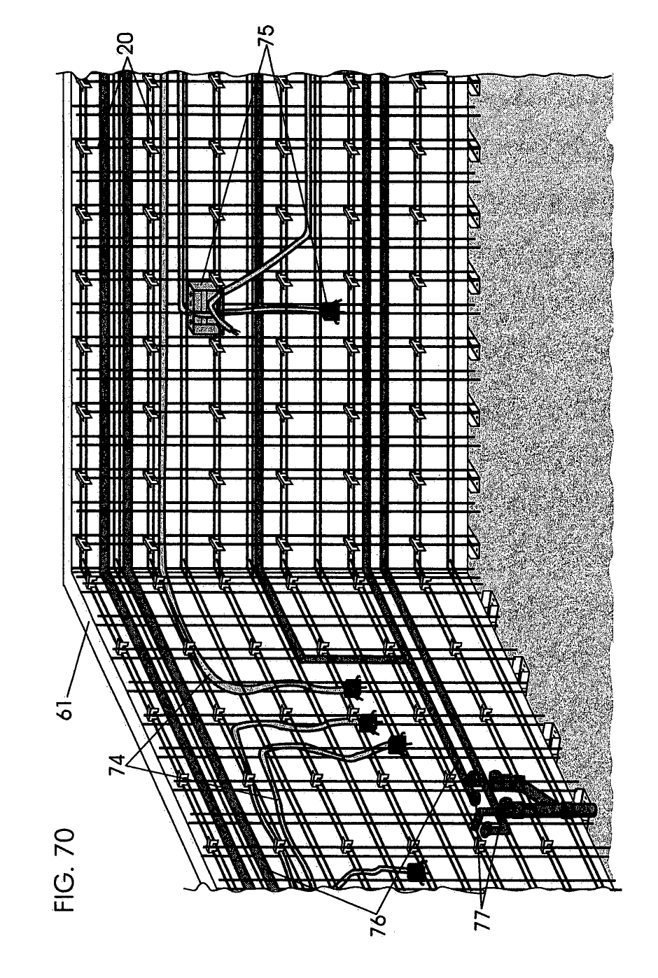

FIG. 70 is a view, in perspective, of a section of the wall template for the dwelling showing provision for the positioning of electrical installations, boxes and cabling, and water installations, piping and drains, that will be integrated within the walls once the assembled mould has been installed and subsequently concreted;

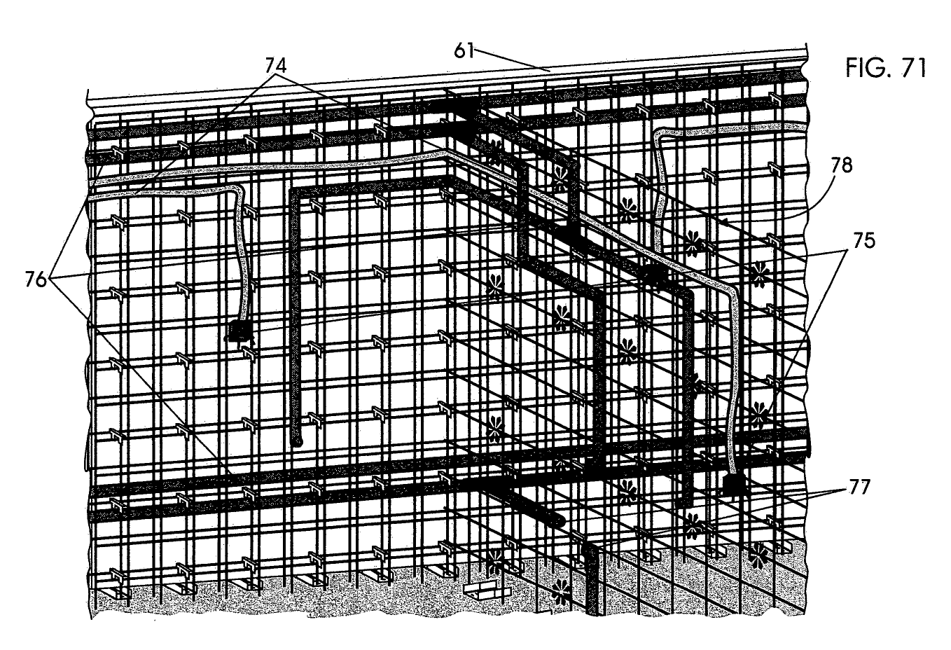

FIG. 71 is a detail, in perspective, showing the position of the general sanitation and electrical installations, both in the peripheral walls and in internal partitions for the dwelling;

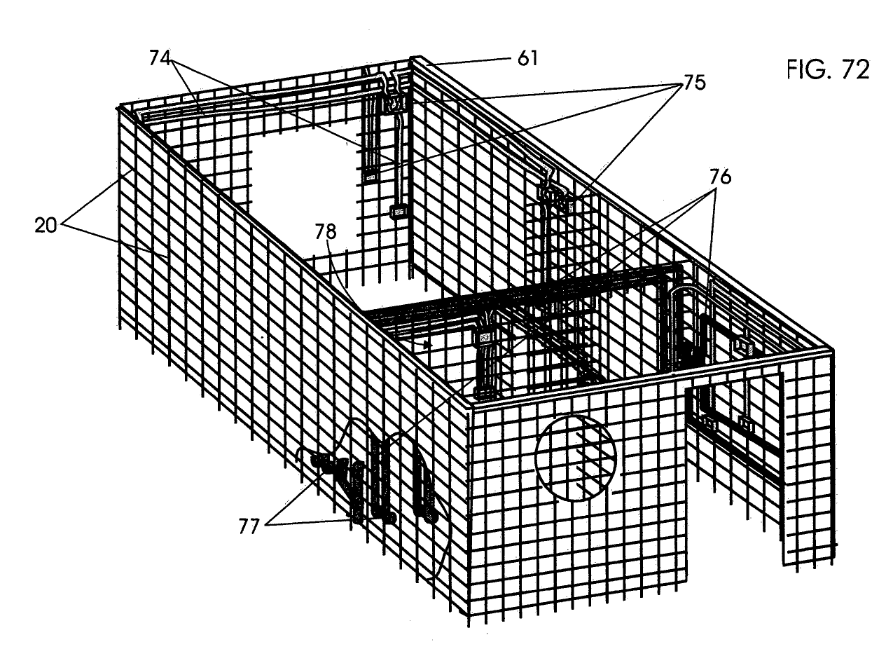

FIG. 72 is a general view from above and in perspective of the ground floor of a dwelling, showing, in schematic form, the position of all general electrical and sanitary installations for the same;

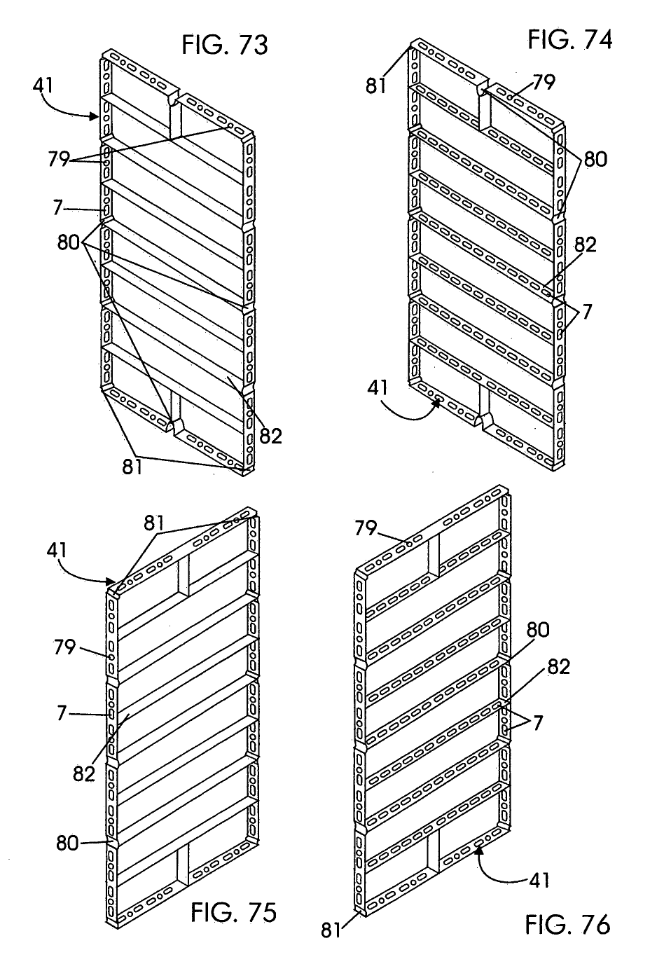

FIG. 73 shows a basic modular rectangular panel, for assembly and realisation of the complete mould, viewed in perspective from behind, which is provided with a series of parallel and transversal reinforcement battens. The said panel has peripheral plates drilled with oblong and innovative round holes for centring, as well as similarly innovative semicircular recesses, formed in both the lateral plates and in the centre of the upper and lower plates of the same, and quarter-circle recesses on the peripheral corners of the panel;

FIG. 74 shows a variant of the modular rectangular panel in the previous figure, viewed in perspective from behind, the reinforcement battens of which have holes consisting of oblong orifices that are aligned and equidistant in respect of one another;

FIG. 75 represents another variant of a modular rectangular panel similar to that in FIG. 73, viewed in perspective from behind, which has only semicircular recesses made in the lateral plates and quarter-circle recesses on the peripheral corners;

FIG. 76 shows yet another variant of a modular rectangular panel similar to that in FIG. 74, viewed in perspective from behind, which has only the semicircular recesses made in the lateral plates and quarter-circle recesses on the peripheral corners;

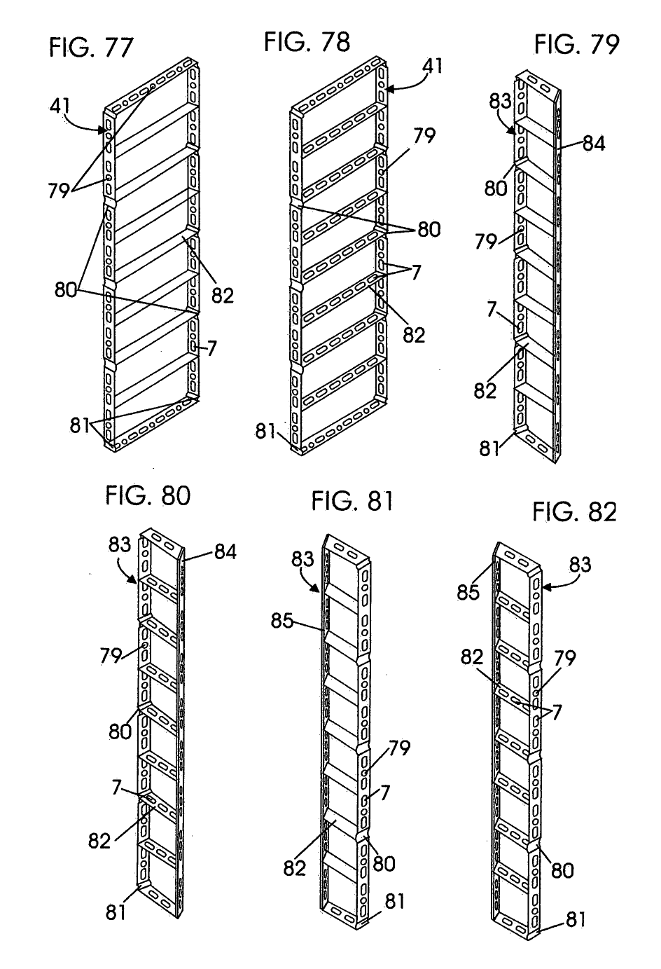

FIG. 77 shows, in rear perspective, a modular panel with similar characteristics to that in FIG. 75, but of a smaller size;

FIG. 78 is a rear perspective view of a variant of the panel represented in FIG. 76, but also of a smaller size;

FIG. 79 represents a rectangular panel similar to that shown in FIG. 75, but narrower and with one of the lateral plates at a sloping angle and without recesses, thus forming, as it were, a mitred module;

FIG. 80 shows a variant of a similar panel to that depicted in FIG. 76, likewise narrower and with one of the lateral plates at an angle, therefore forming a mitred module similar to that depicted in the previous figure;

FIG. 81 is a representation of a similar and complementary mitred panel to that shown in FIG. 79, with its opposite lateral plate at an angle in the other direction;

FIG. 82 is a representation of a similar and complementary mitred panel to that shown in FIG. 80, with its opposite lateral plate at an angle in the other direction;

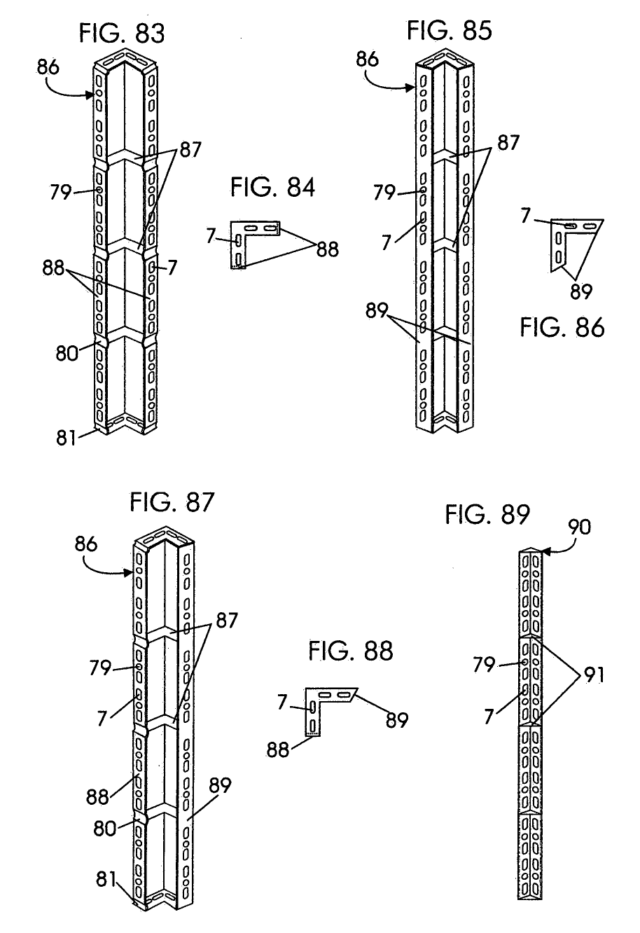

FIG. 83 depicts a view, in perspective from behind, of an internal right-angle angle piece with internal reinforcements and fitted with adjustment plates drilled with oblong and round centring holes, the lateral plates having the respective semi-circular recesses and with quarter-circle recesses on the peripheral corners;

FIG. 84 is a plan view of the previous figure;

FIG. 85 shows an internal angle similar to that in FIG. 83, without semicircular recesses in its lateral plates, or quarter-circle recesses on its peripheral corners, and the lateral plates of which are inclined at a variable angle;

FIG. 86 is a plan view of the previous figure;

FIG. 87 is another variant of a likewise internal angle similar to that represented in FIG. 83, with one of the lateral plates at right-angles and with its respective semicircular and quarter-circle recesses, and the other plate flat and inclined at an angle;

FIG. 88 is a plan view of the previous figure;

FIG. 89 is a view, in perspective, of a reinforced external angle;

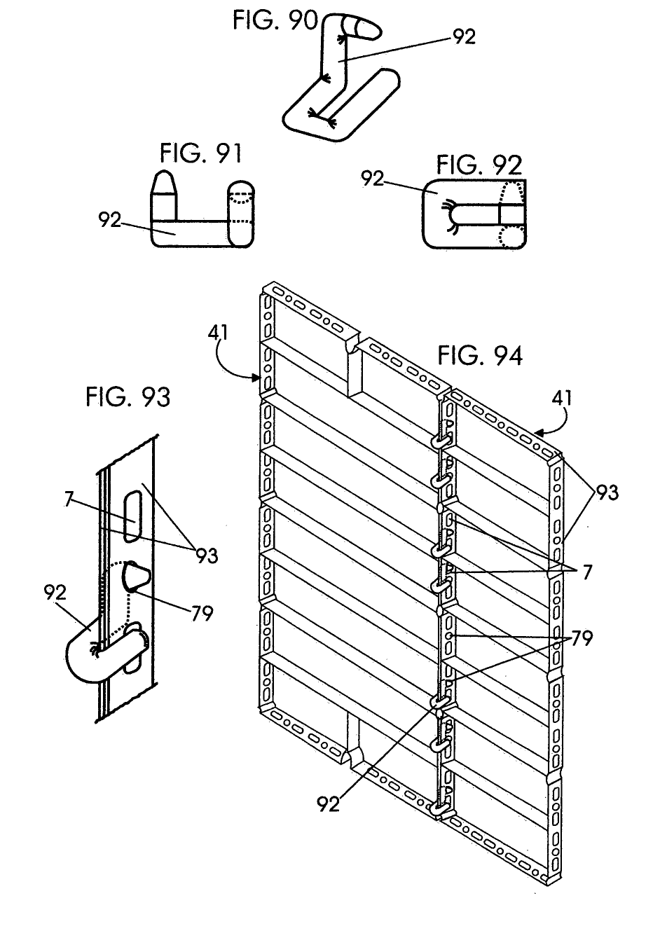

FIG. 90 depicts, in perspective, a new variant of the self-centring clamp that joins together the different modular panels that form part of the system;

FIG. 91 shows a section view of the clamp depicted in the previous figure;

FIG. 92 is a plan view of the same clamp as in the previous two figures;

FIG. 93 is a detail, in perspective, of a self-centring clamp, as depicted in the previous three figures, joining two plates;

FIG. 94 shows a view, in perspective from behind, of the joining of two adjoining modular panels using self-centring clamps of the type represented in FIGS. 90 to 93;

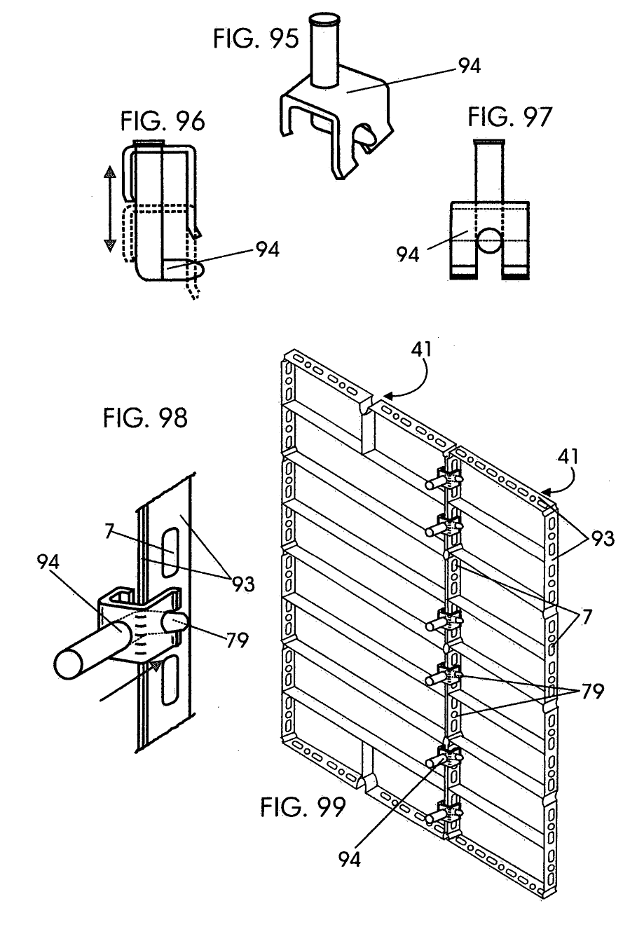

FIG. 95 shows, in perspective, another different variant of the self-centring clamp;

FIG. 96 shows a frontal cross-section view of the clamp in the previous figure, the dotted line showing the movement of a section of the part for attachment purposes;

FIG. 97 is a lateral cross-section view of FIG. 95;

FIG. 98 is a detail, in perspective, of a self-centring clamp depicted in FIGS. 95 to 97, joining two abutting plates;

FIG. 99 shows a view, in perspective, from behind, of the joining of two adjoining modular panels using self-centring clamps of the type represented in FIGS. 95 to 98;

FIG. 100 depicts, in perspective, yet another variant of the self-centring clamp;

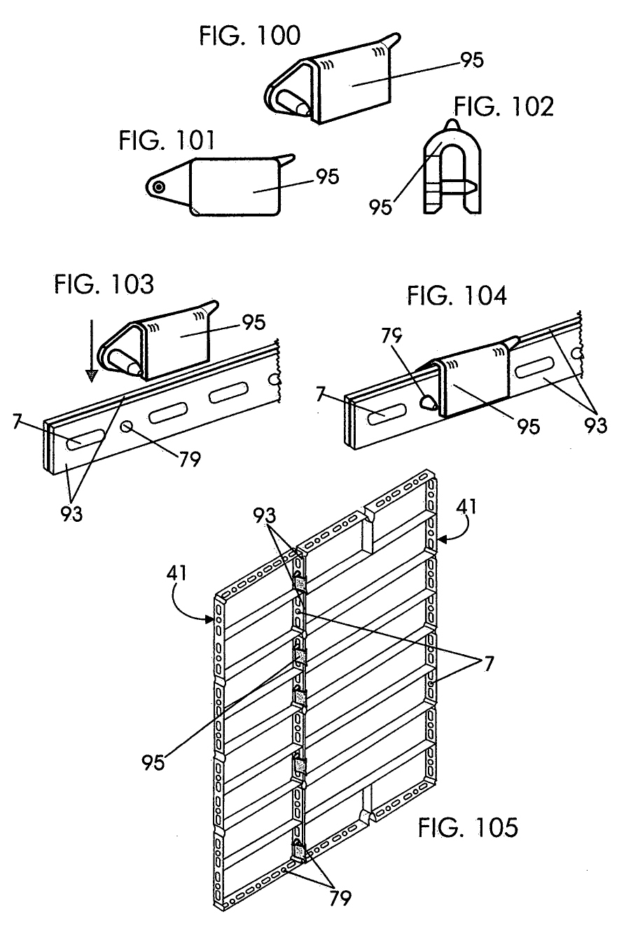

FIG. 101 shows a lateral cross-section view of the clamp depicted in the previous figure;

FIG. 102 shows a frontal cross-section view of the clamp represented in the previous two figures;

FIGS. 103 and 104 depict, in perspective, and in detail, the sequence of the system for joining two abutting plates using the type of self-centring clamp represented in FIGS. 100 to 102;

FIG. 105 shows a view, in perspective, from behind, of the joining of two adjoining modular panels using the self-centring clamp depicted in FIGS. 100 to 104;

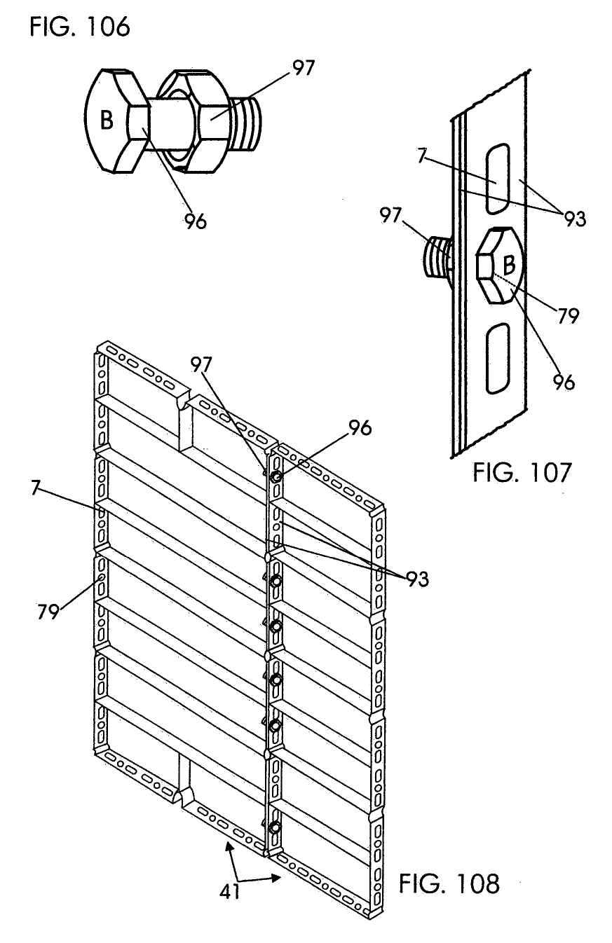

FIG. 106 shows, in perspective, a self-centring screw used for joining the plates on two adjoining modular panels;

FIG. 107 is a detail, in perspective, of the self-centring screw, as referred to in the previous figure, joining, by means of the matching circular orifices provided, the two plates that abut against one another;

FIG. 108 represents, in perspective, and from behind, the joining of two modular panels using the self-centring screw in the previous two figures;

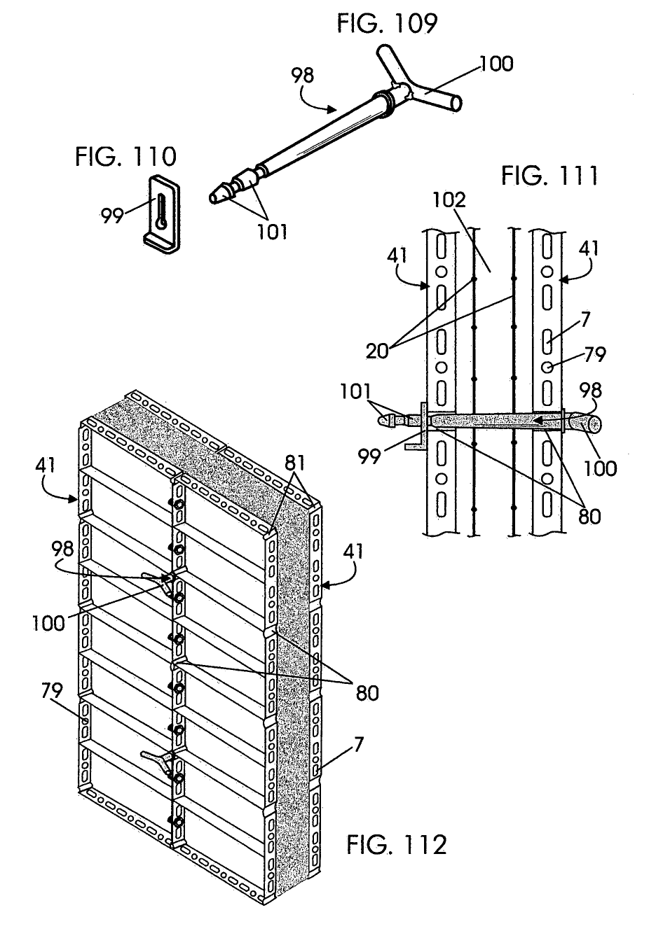

FIG. 109 shows, in perspective, a tapered separator for the panels that make up the walls;

FIG. 110 is a view, in perspective, of the locking clip for securing the wall separator in the previous figure;

FIG. 111 is a lateral cross-section view showing the equidistant securing of two modular panels with the help of a separator and locking clip, as represented in the previous two figures;

FIG. 112 is a view, in perspective, from behind, of positioning and deployment of the wall separator represented in the previous three figures, ensuring equidistant separation of the panels that make up the same;

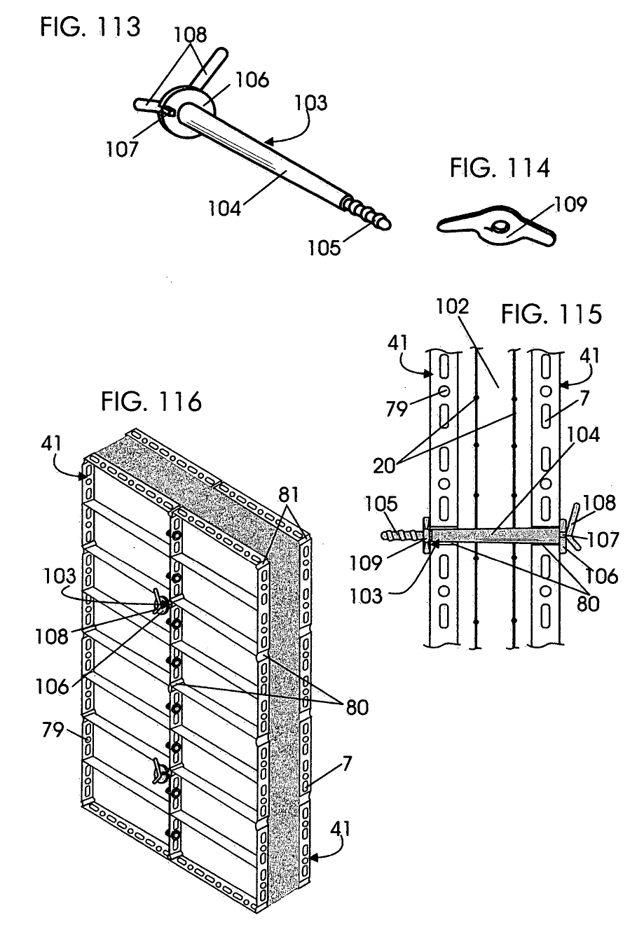

FIG. 113 is a view, in perspective, of a variant of the tapered wall separator, with a threaded point;

FIG. 114 shows a threaded securing washer for tightening the separator depicted in the previous figure;

FIG. 115 is a lateral cross-section view showing the equidistant securing of two modular panels, with the help of a separator and a washer, as represented in the previous two figures;

FIG. 116 is a view, in perspective, from behind, of positioning and deployment of the wall separator depicted in the previous three figures, likewise ensuring equidistant separation of the panels;

FIG. 117 shows, in perspective, a centring hook, for the installation, dismantling and adjustment of panels;

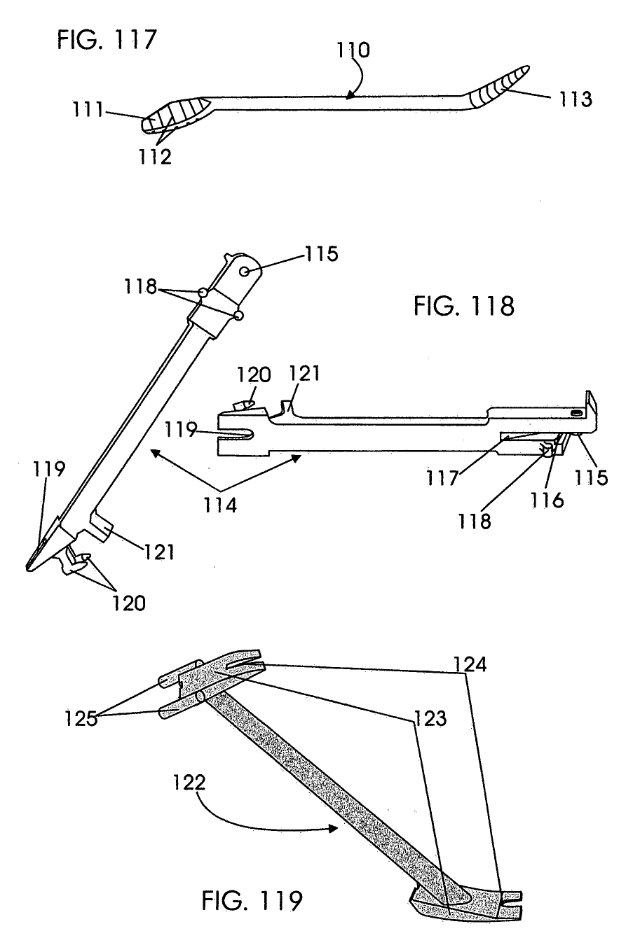

FIG. 118 shows two views, in perspective, of a multi-use lever, for mould adjustment;

FIG. 119 is a perspective of a mould lever, this implement being used for the installation and dismantling of panels;

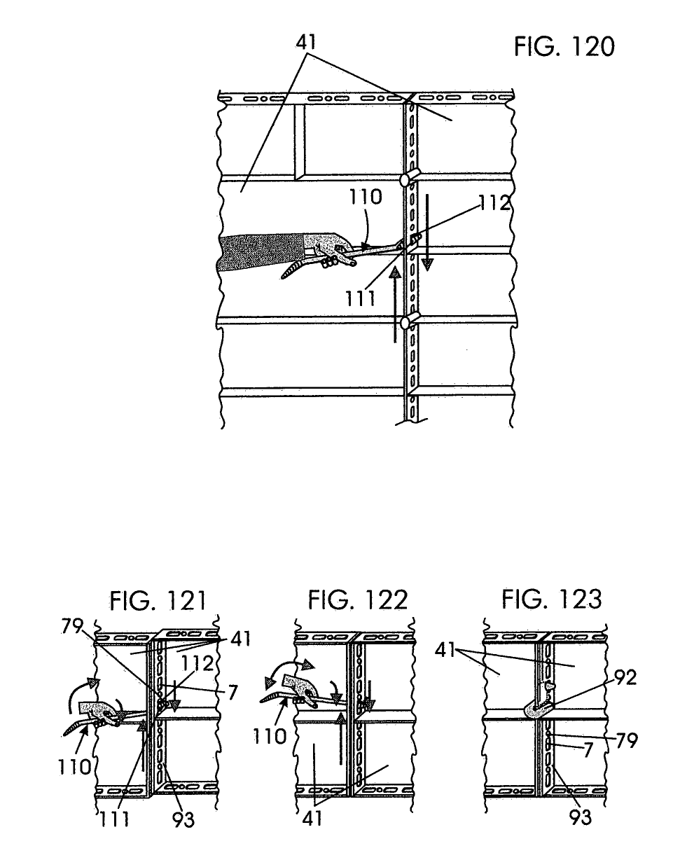

FIG. 120 is a view, in perspective, showing deployment of the centring hook in FIG. 117, for vertically levelling two adjoining modular panels by means of their respective plates;

FIGS. 121 and 122 show two phases in the vertical levelling of two adjoining panels in the formwork assembly using the flat end of the said centring hook;

FIG. 123 shows how the self-centring clamp in FIG. 90 is finally placed in position, to join, by means of their matching plates, two adjoining panels, once these have been levelled;

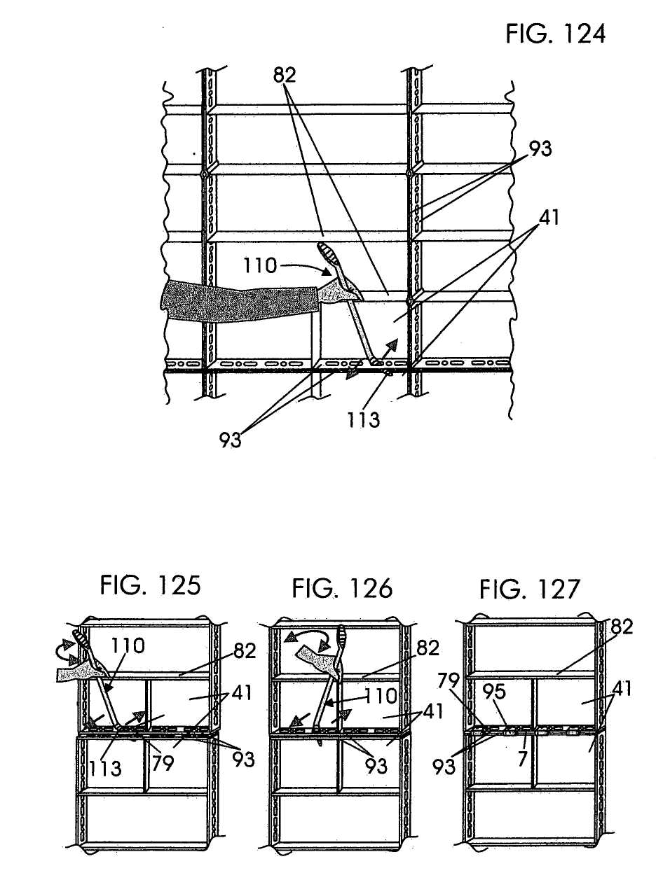

FIG. 124 is a view, in perspective, showing deployment of the said centring hook for horizontally levelling two adjoining modular panels by means of their respective plates;

FIGS. 125 and 126 show two phases in the horizontal levelling of two adjoining panels using the pointed end of the said centring hook in FIG. 117;

FIG. 127 shows self-centring clamps of the type in FIG. 100, placed in position between the plates on two adjoining panels for joining the same once they have been horizontally levelled;

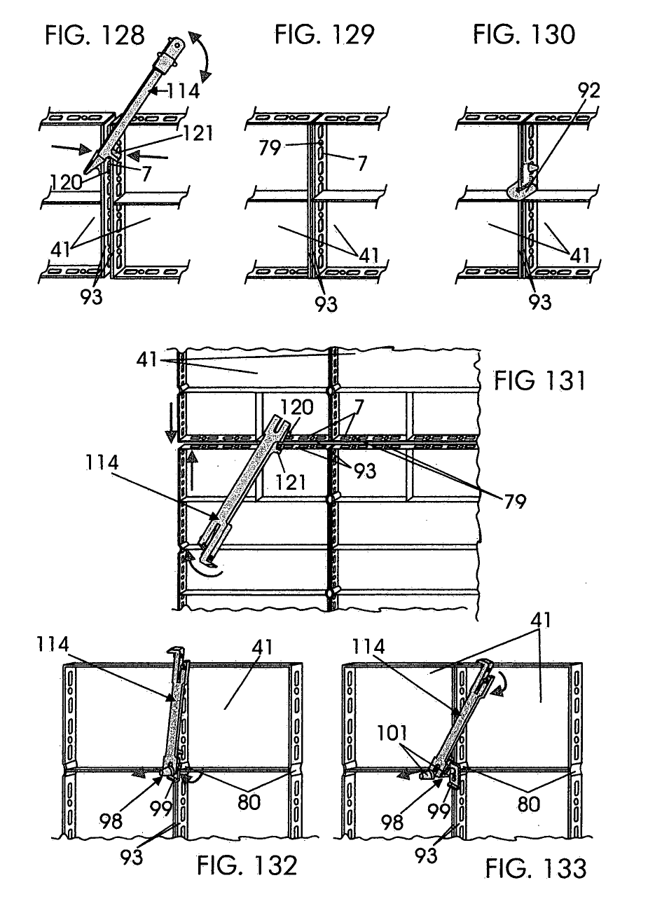

FIGS. 128 and 129 show details, in perspective, of the sequence for using the multi-use lever in FIG. 118 to bring two adjoining modular panels together by means of their plates;

FIG. 130 shows the positioning of the self-centring clamp in FIG. 90 to join the plates on two adjoining modular panels once they have been pushed together and levelled by using the aforementioned multi-use lever, as indicated in the previous sequence;

FIG. 131 shows, in perspective, the same multi-use lever joining two adjoining panels, positioned one on top of the other, by means of their plates;

FIGS. 132 and 133 are views, in perspective, of the sequence showing the said multi-use lever pulling on the tapered separator in FIG. 109 and positioning of the appropriate locking clip in FIG. 110 in order to secure the panels that make up the wall in an equidistant manner;

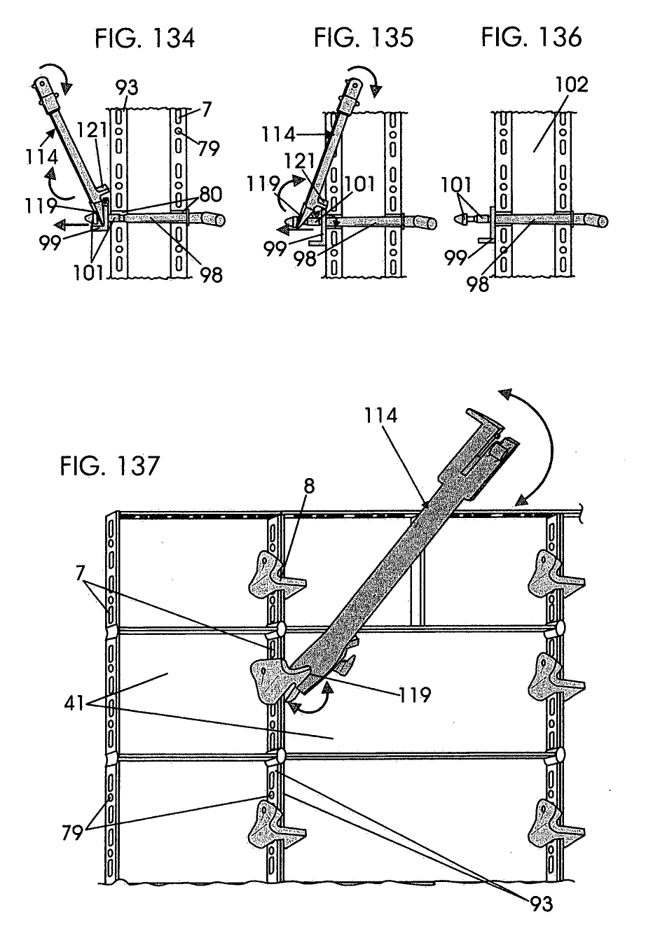

FIGS. 134, 135 and 136 are three lateral views showing the same operation as above but in which it can be seen, more clearly, how such action is realised with the help of the pivot that the aforesaid multi-use lever is fitted with;

FIG. 137 shows, in perspective, the said multi-use lever, removing self-centring clamps represented in FIG. 4 which join the modular panels by means of their plates;

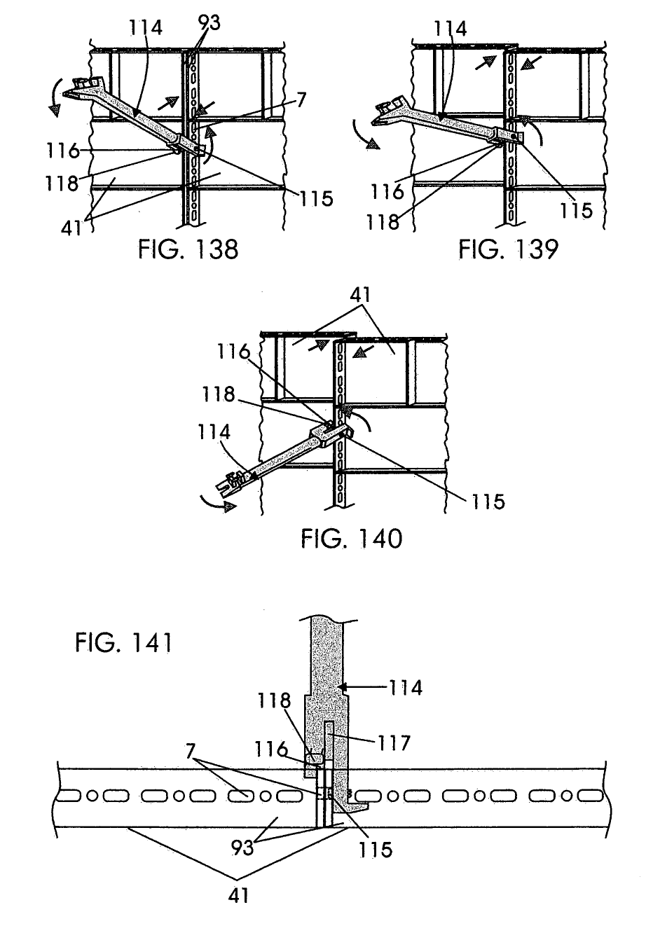

FIGS. 138, 139 and 140 show, in perspective, a sequence that follows on from that in the previous figure, consisting of the unlocking and separation of two adjoining panels in the formwork, with the help of the said multi-use lever;

FIG. 141 is a detail of the positioning of the multi-use lever on the plates for unlocking the adjoining panels, as indicated in the previous sequence;

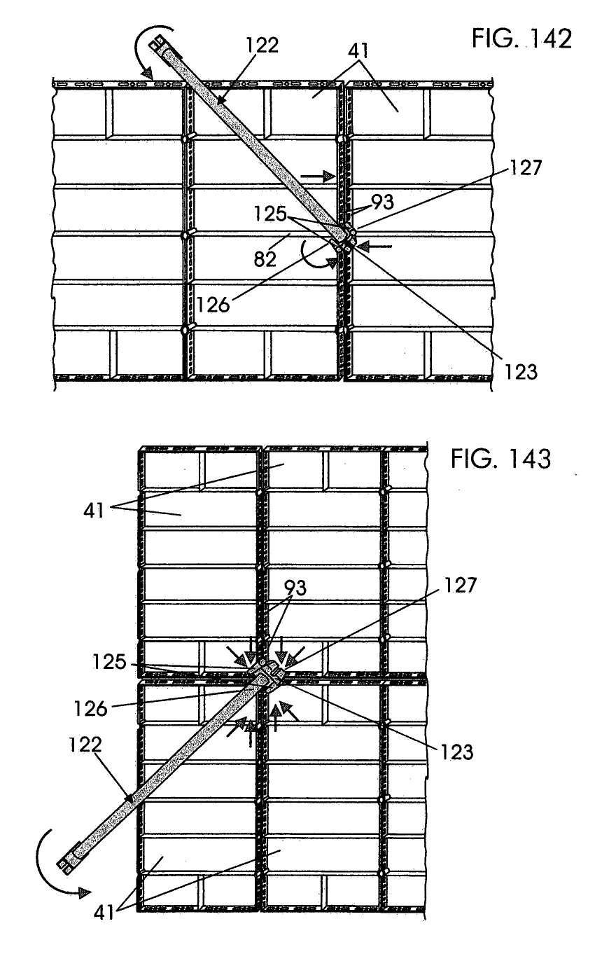

FIG. 142 is a view, in perspective, of deployment of the mould lever in FIG. 119 for joining two adjoining panels by means of their plates;

FIG. 143 shows, in perspective, deployment of the said mould lever for levelling an assembly of four panels that meet at their corners;

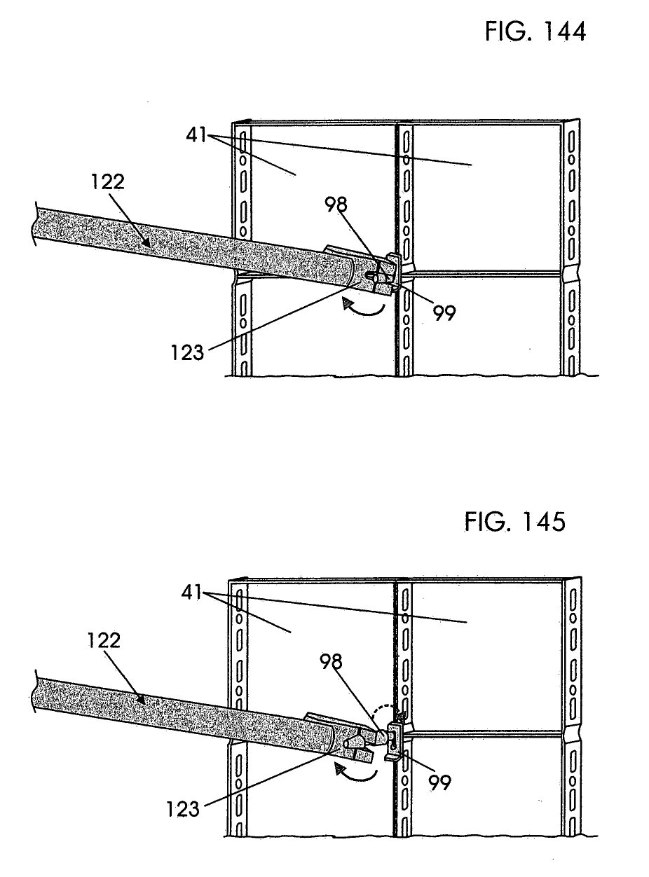

FIGS. 144 and 145 show, in two phases, a sequence, in perspective, involving the said mould lever in FIG. 119, using the other end of the same and pulling on a tapered wall separator of the type represented in FIG. 109 and moreover positioning a locking clip, as represented in FIG. 110;

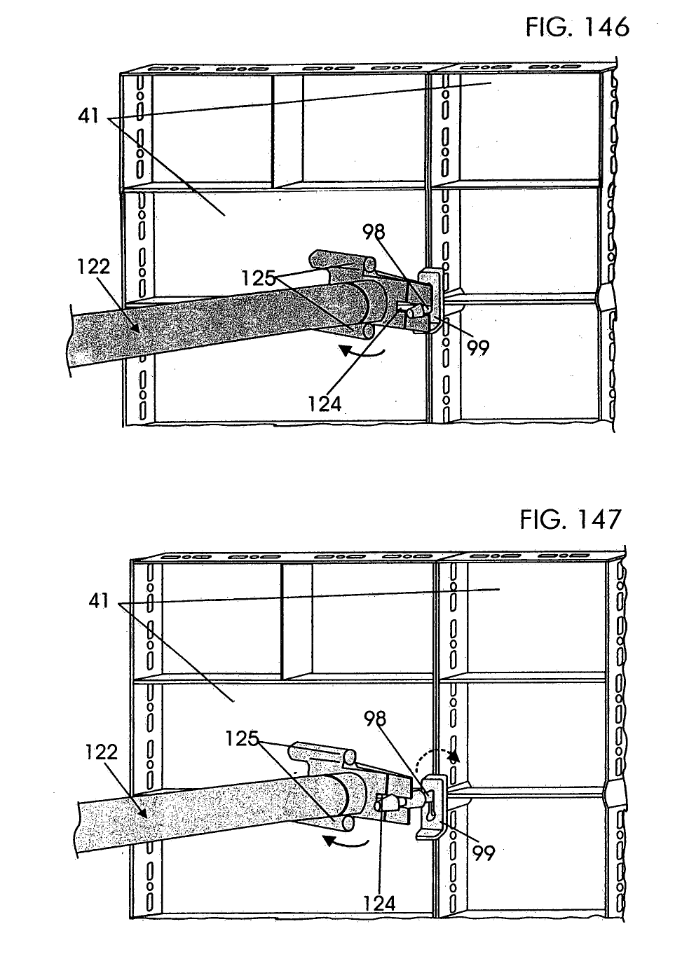

FIGS. 146 and 147 represent this mould lever realising the same function as in the previous sequence, using, for such purposes, the other end of the lever;

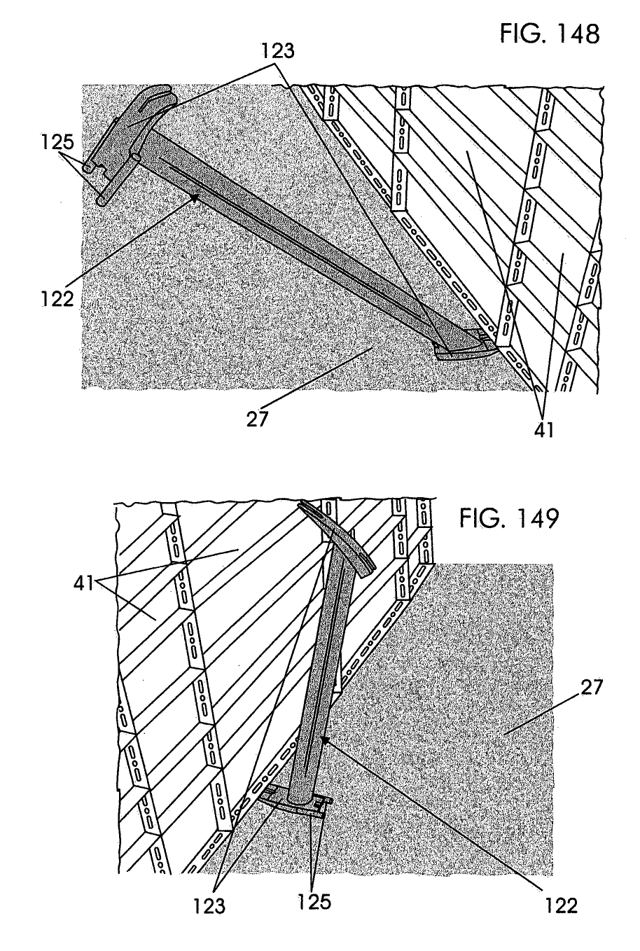

FIG. 148 shows, in perspective, the said mould lever lifting and dismantling the panels of the formwork;

FIG. 149 corresponds to the previous figure, using the other end of the said lever;

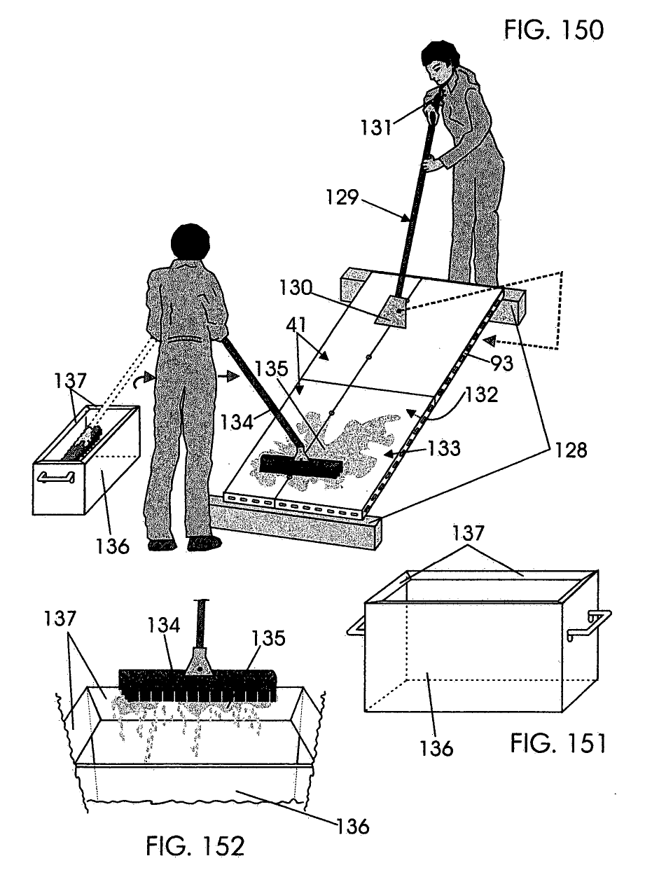

FIG. 150 shows the action of scraping, cleaning and applying mould removal liquid to used modular panels for subsequent re-use;

FIG. 151 shows a trough which has, perpendicular to its mouth, flanges that slope inwards;

FIG. 152 is a detail of the function of the said sloping flanges on the trough depicted in the previous figure, used for total utilisation of the mould removal liquid;

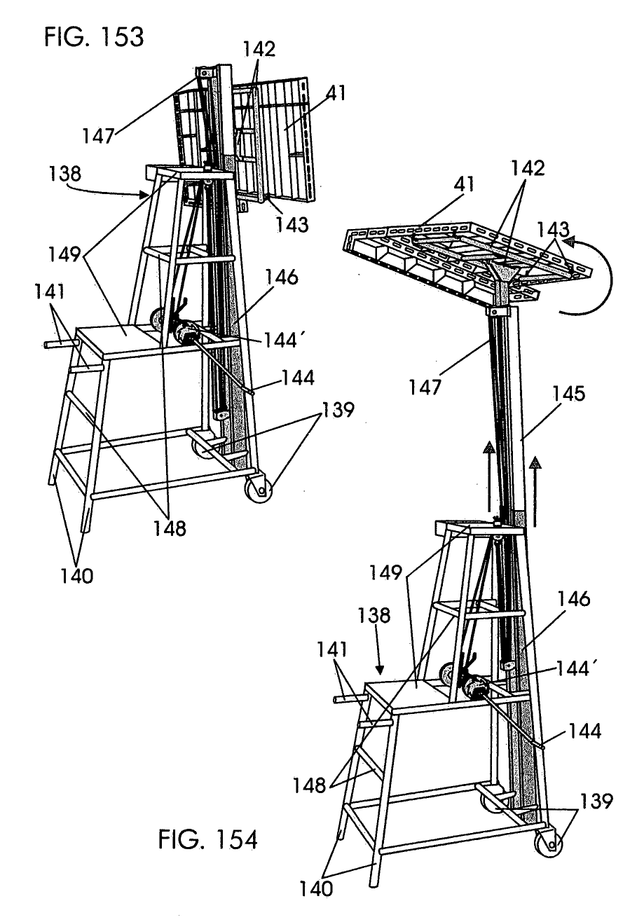

FIG. 153 is a view, in perspective, of the new telescopic lifting trolley, used for positioning and dismantling panels that form the ceiling/roof and upper sections of walls;

FIG. 154 shows, in perspective, the same lifting trolley with an initial telescopic section extended upwards and with the mechanism for securing the panels tilted and ready for positioning the same;

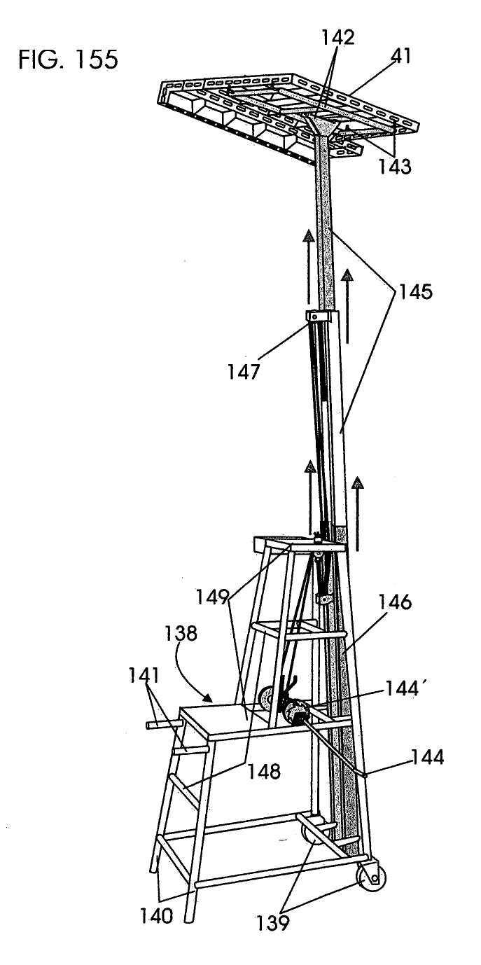

FIG. 155 shows, in perspective, the same lifting trolley with its three sections that make up the same fully extended and with the mechanism for securing the panels in the same position as in the previous figure;

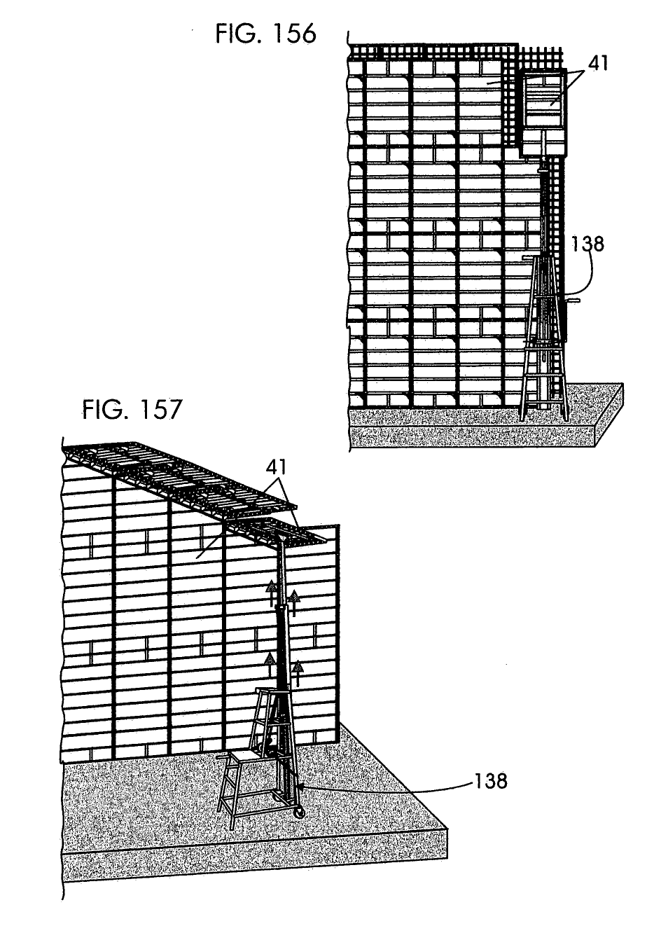

FIG. 156 shows the positioning of a modular panel on the upper part of a wall form, with the help of the said lifting trolley in FIG. 155;

FIG. 157 shows the positioning of a modular panel on the ceiling/roof of a form, with the help of the same lifting trolley operating in the position represented in FIG. 155;

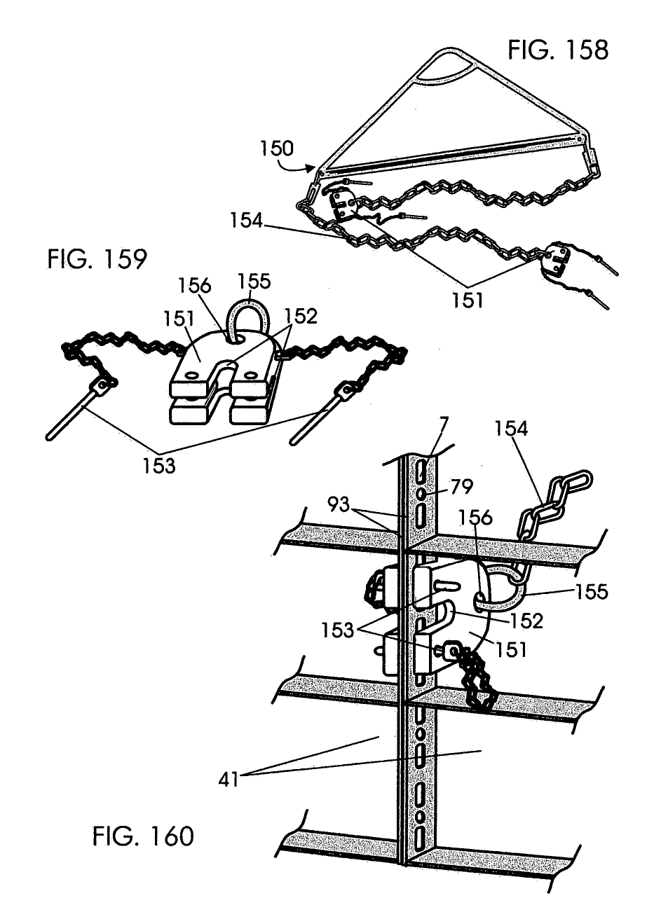

FIG. 158 is a perspective of a triangular support for a crane, for the movement and transferral of wall panel assemblies;

FIG. 159 is a detail, in perspective, and on a larger scale, of an element for hitching panels incorporated into the triangular support for a crane in the previous figure;

FIG. 160 represents, in perspective, gripping of the respective plates on two adjoining modular panels by means of the hitch element represented in the previous figure;

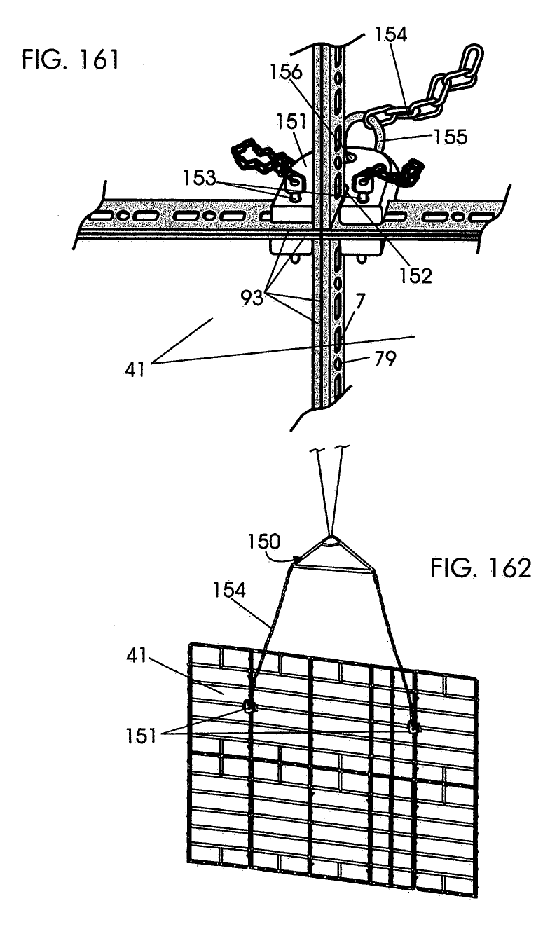

FIG. 161 shows joining of the plates in an assembly of four modular panels, using the hitch element represented in FIGS. 159 and 160;

FIG. 162 shows the role of the triangular support in FIG. 158 when lifting an assembly of modular panels joined together, using the hitch elements in FIG. 159;

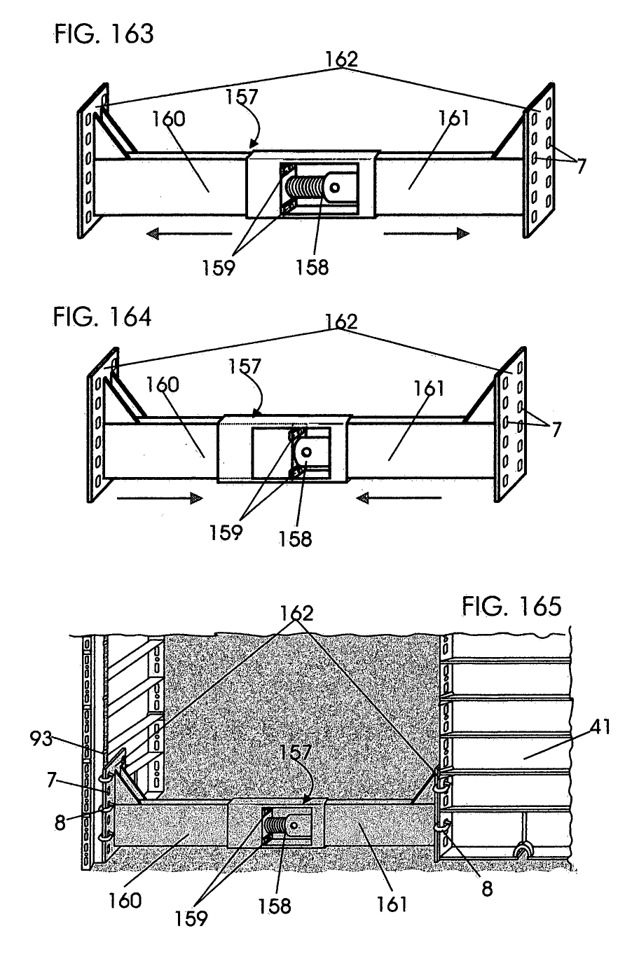

FIG. 163 is a view, in perspective, of a separator mechanism for door moulds, that can be adjusted by means of a spindle, and represented in a fully extended position;

FIG. 164 shows the separator in the previous figure in its fully contracted position;

FIG. 165 is a detail, in perspective, of the role of the separator in the configuration of a door;

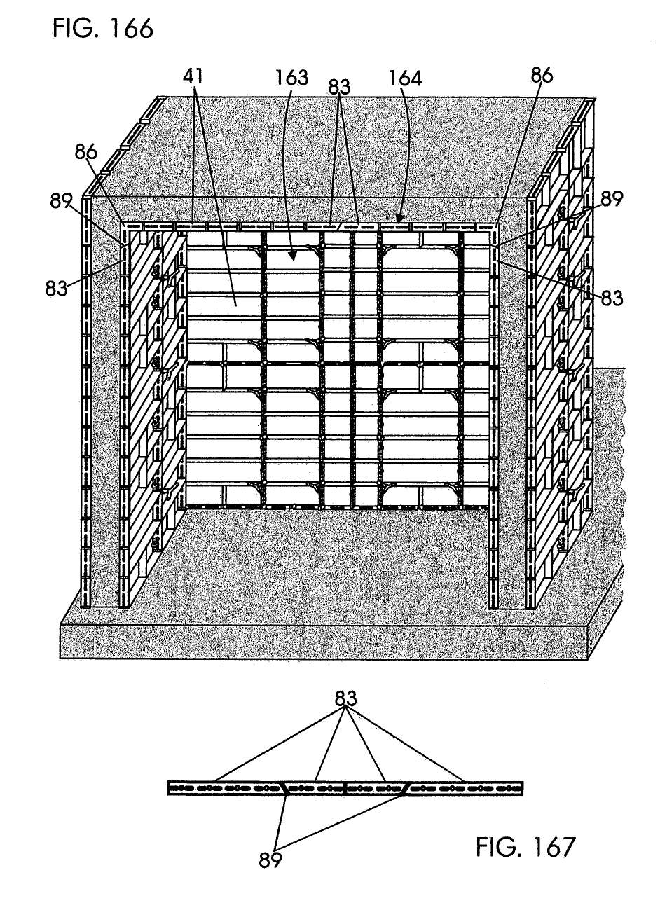

FIG. 166 is a view, in cross-section perspective, of a modular form comprising simple panels and mitred panels for ceilings/roofs and walls;

FIG. 167 is a schematic detail of the positioning of mitred roof panels, suitable for facilitating the subsequent dismantling of the mould in sections;

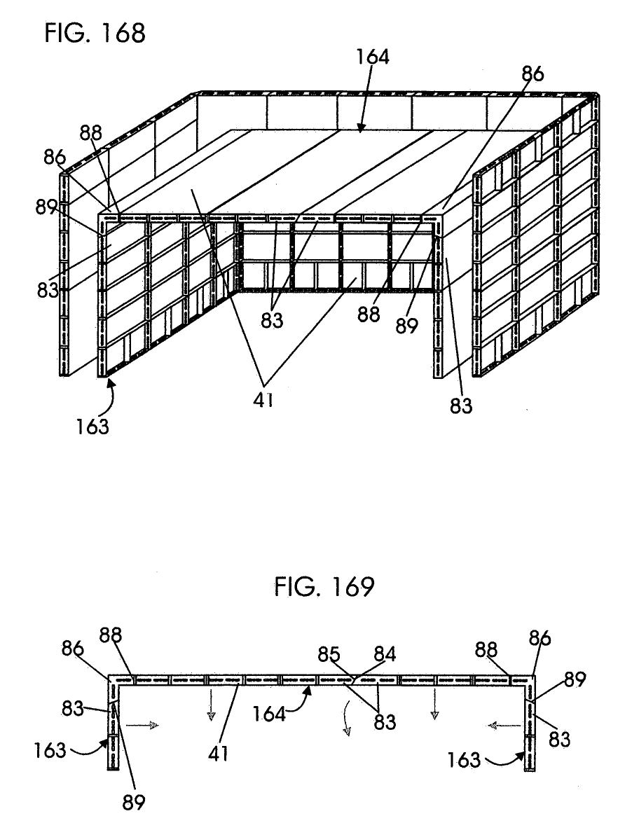

FIG. 168 represents, in perspective, the positioning of mitred ceiling/roof panels and internal angles at the corners to facilitate the subsequent dismantling of the mould panels once concreting has taken place;

FIG. 169 corresponds to a partial front view of the previous figure, indicating, by means of arrows, the order of removal of the various panels and modular parts for correct removal of the mould;

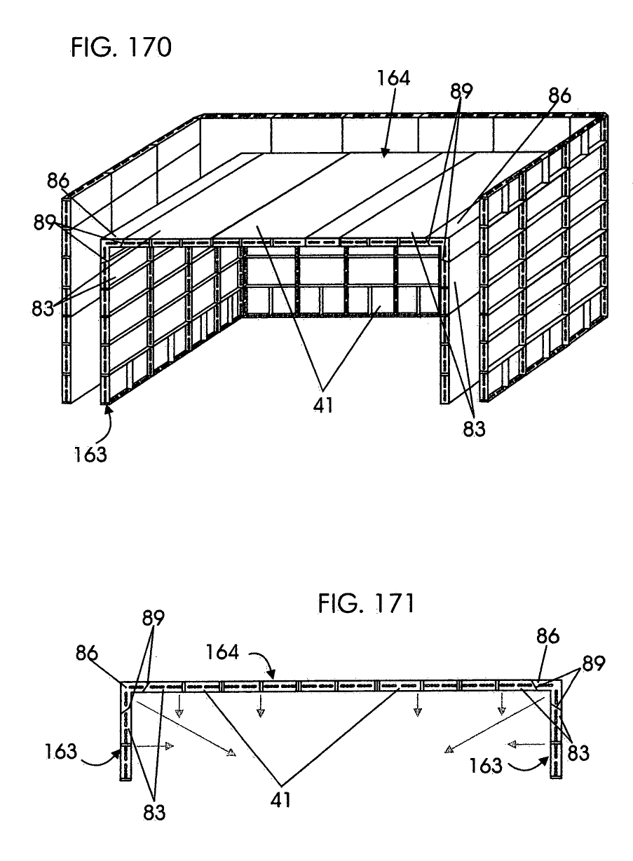

FIG. 170 is a similar view to that in FIG. 168, showing the internal angles with their two corners on a slant, used for facilitating removal of the mould when this does not have mitred panels in the ceiling/roof;

FIG. 171 corresponds to a partial front view of FIG. 170, likewise indicating, by means of arrows, the order of removal of the panels and modular parts for correct removal of the mould;

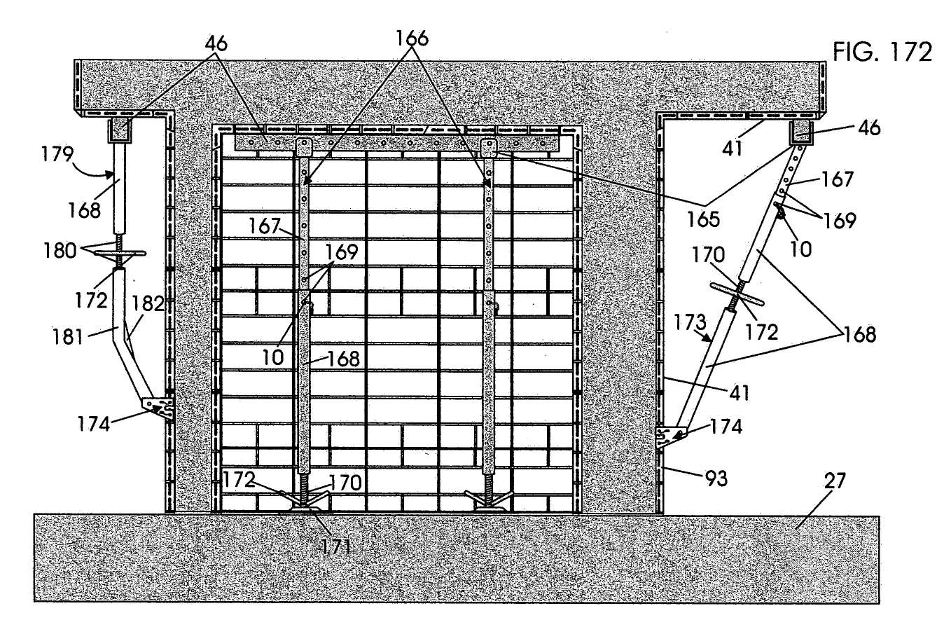

FIG. 172 is a cross-section view of a modular form for a dwelling with external overhangs, showing three types of supporting stanchions used in the construction system covered by the present invention;

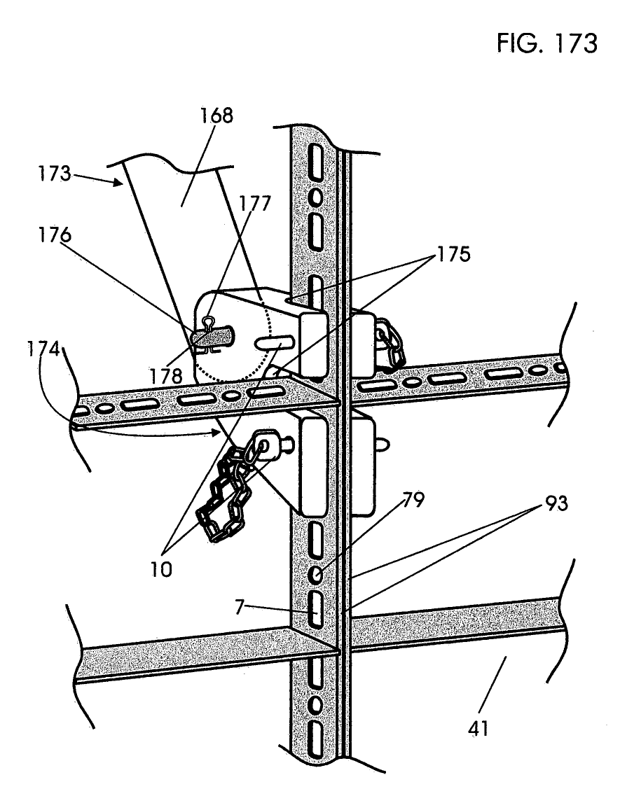

FIG. 173 shows an enlarged detail, in perspective, of the device for securing and supporting the overhang stanchions, which is attached to the plates on the adjoining wall panels of the mould;

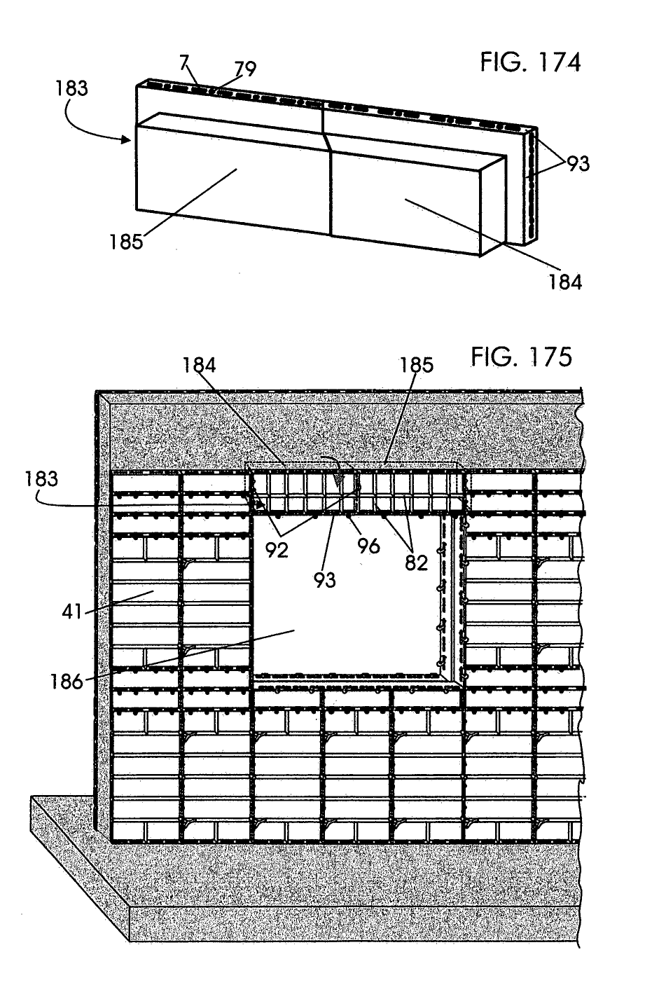

FIG. 174 is a view, in perspective, of a modular cover for forming the recess for a shutter drum;

FIG. 175 is a view, in perspective, from the internal facade of the dwelling, with the formwork partially removed, showing the modular cover for the shutter drum recess referred to in the previous figure;

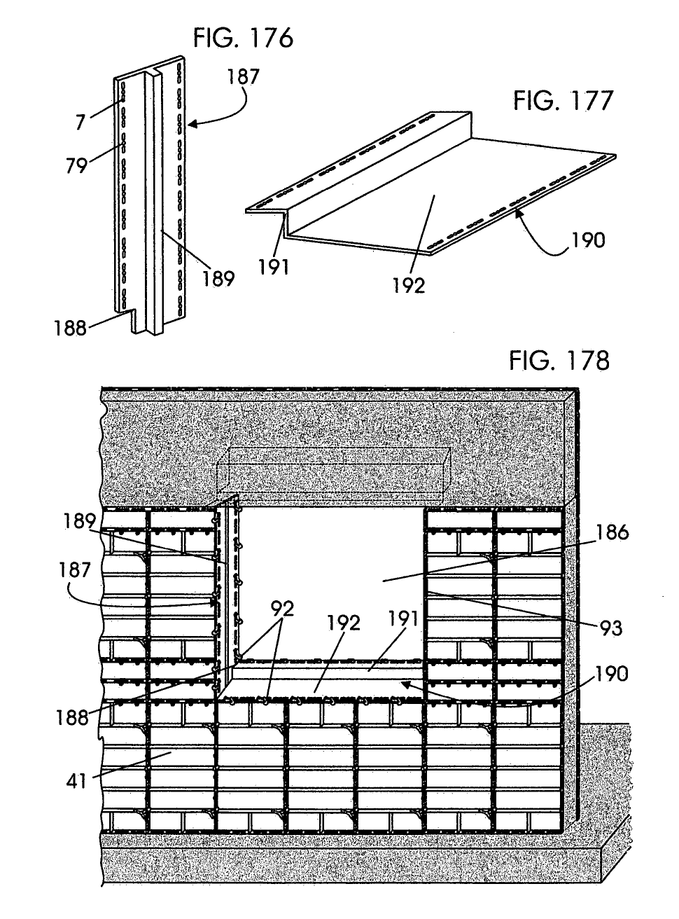

FIG. 176 is a perspective of a modular cover for a shutter guide provided for in the system;

FIG. 177 is a perspective view of a modular cover for a window sill, likewise provided for in the system;

FIG. 178 is a view, in perspective, from the external façade of the dwelling, with the formwork partially removed, showing the modular covers for the shutter guide and window sill, as per the previous two figures;

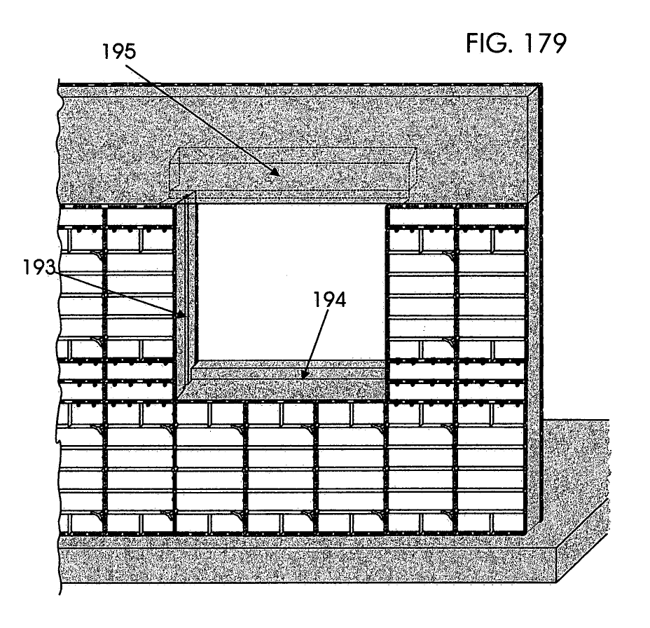

FIG. 179 is a view, in perspective, from the external façade of the dwelling, with the formwork partially removed, showing the recess for the shutter drum, the sill and the shutter guide integrated into the said façade following concreting and removal of the modular panels that have given form thereto;

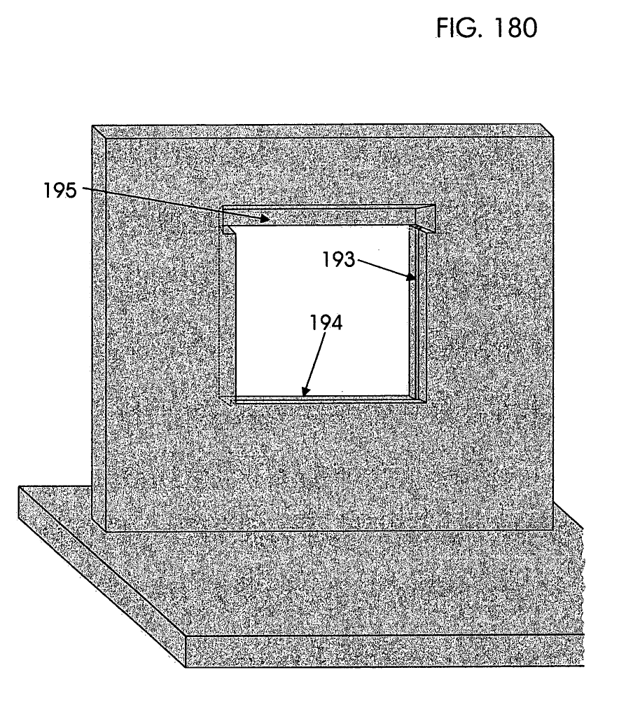

FIG. 180 is a view, in perspective, from the interior of the dwelling, of the result of the concreted wall with the window recess and other elements of the same considered in the previous figures;

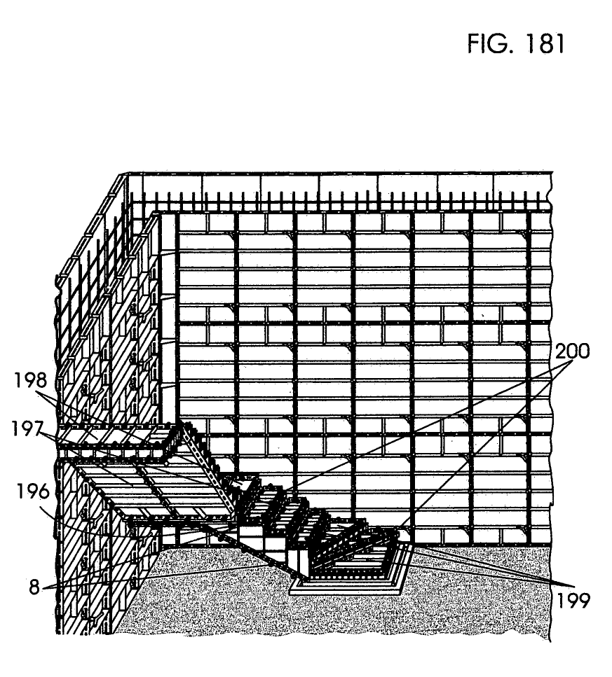

FIG. 181 represents, in perspective, a mould made up of modular panels, forming a monolithic stairway inside the dwelling;

FIG. 182 is a similar view to the previous one, showing, by means of a cutaway, the direct connection between the stairway and the wall, so that, following concreting realised on a single occasion, an integral monolithic structure is achieved;

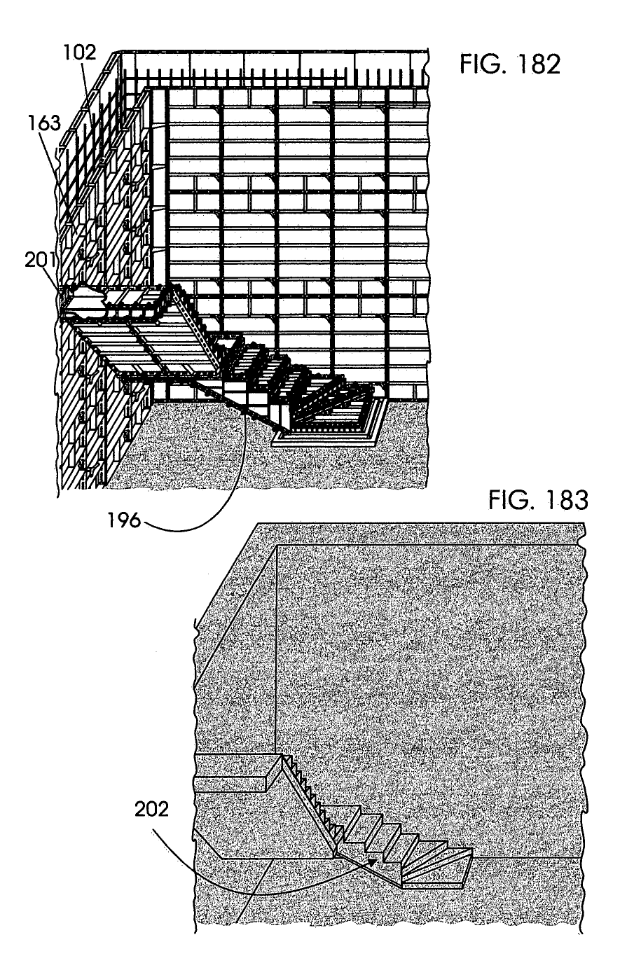

FIG. 183 shows the monolithic stairway in the previous figures duly concreted and with the formwork removed;

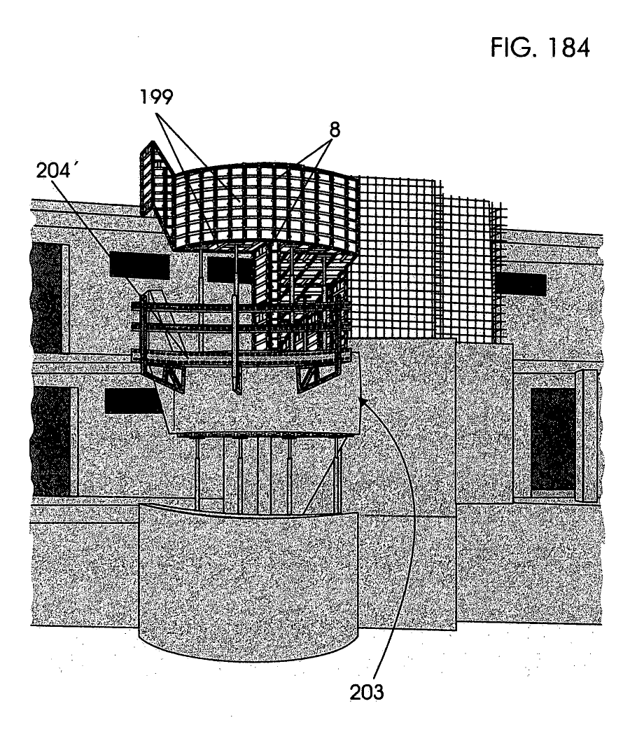

FIG. 184 is a view, in perspective, of an external monolithic staircase on a dwelling, with a second floor in the construction phase;

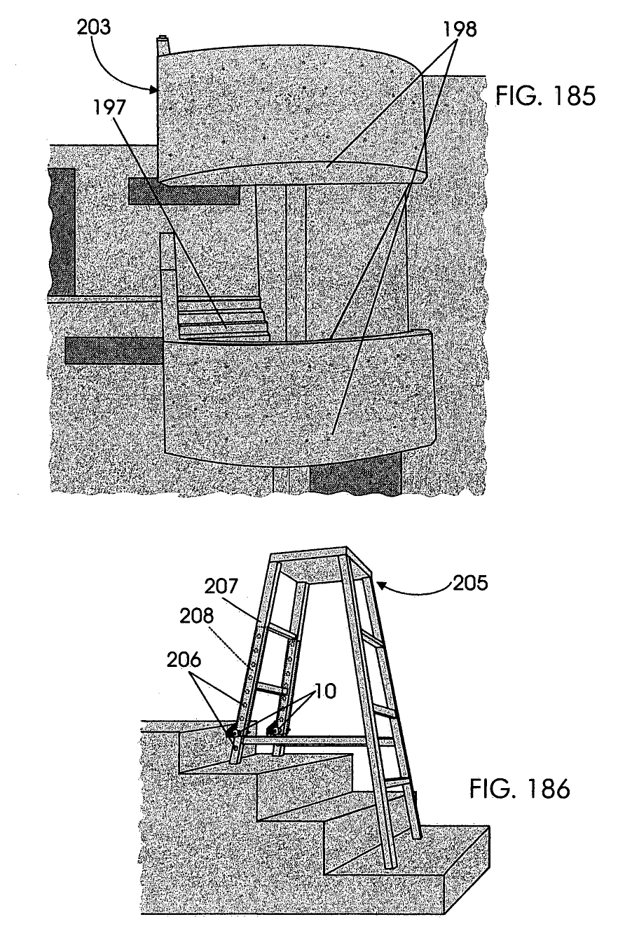

FIG. 185 shows a view, in perspective, of the second floor of the same monolithic staircase as before, duly concreted and, therefore, completed;

FIG. 186 is a set of steps that can be adjusted in terms of height, conceived for working on steps;

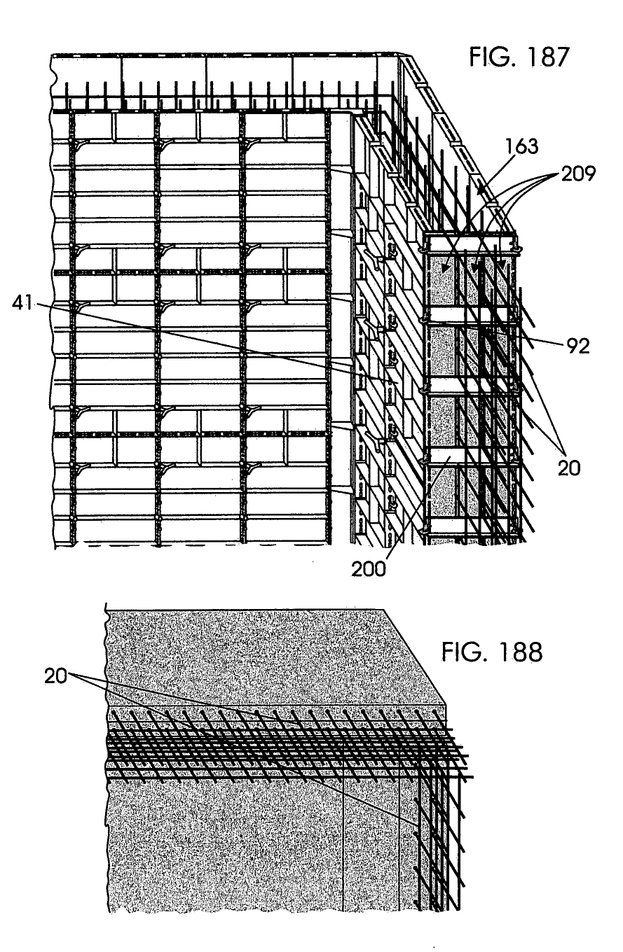

FIG. 187 is a view, in perspective, of an area of formwork for a wall, in which covers are used for the ends of the continuous peripheral walls to ensure continuity in concreting of the same;

FIG. 188 depicts, in perspective, a detail of the result of using the covers in the previous figure, on a ceiling/roof and a wall;

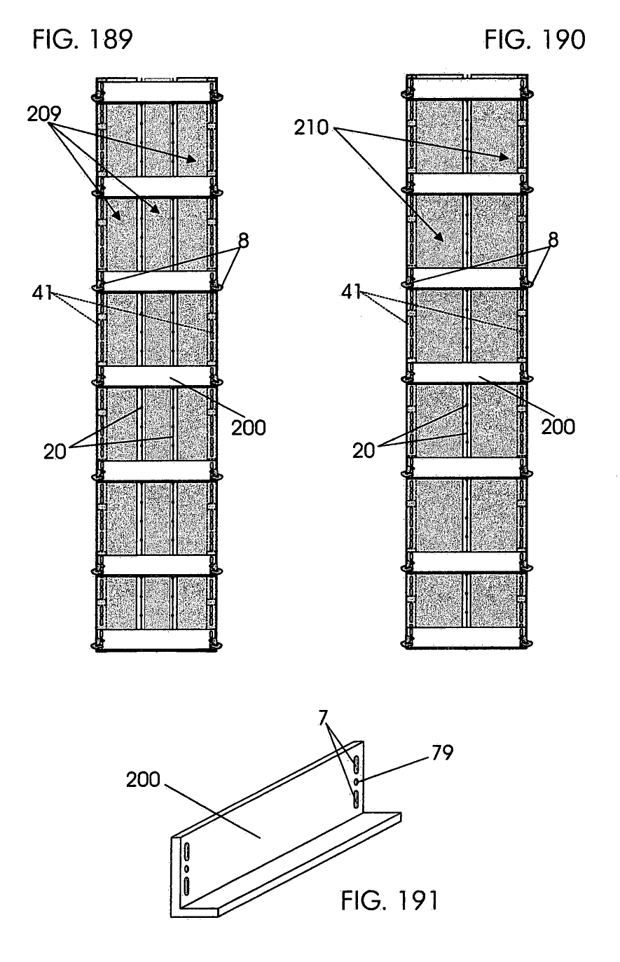

FIG. 189 shows a cross-section view of deployment of an assembly of three covers designed for peripheral walls, which allows double reinforcements to pass through, for continuity of the said walls;

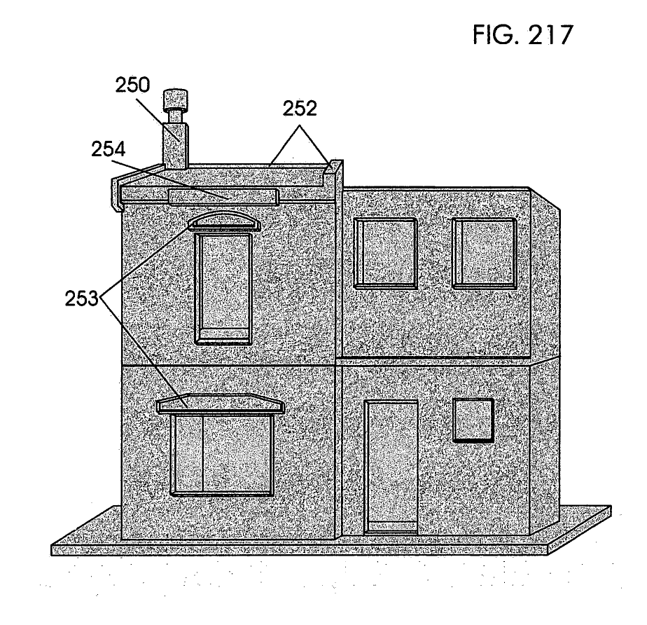

FIG. 217 is a general view, in perspective, of a fully concreted single-family dwelling on two floors, resulting in an integral monolithic structure with high-precision joints;

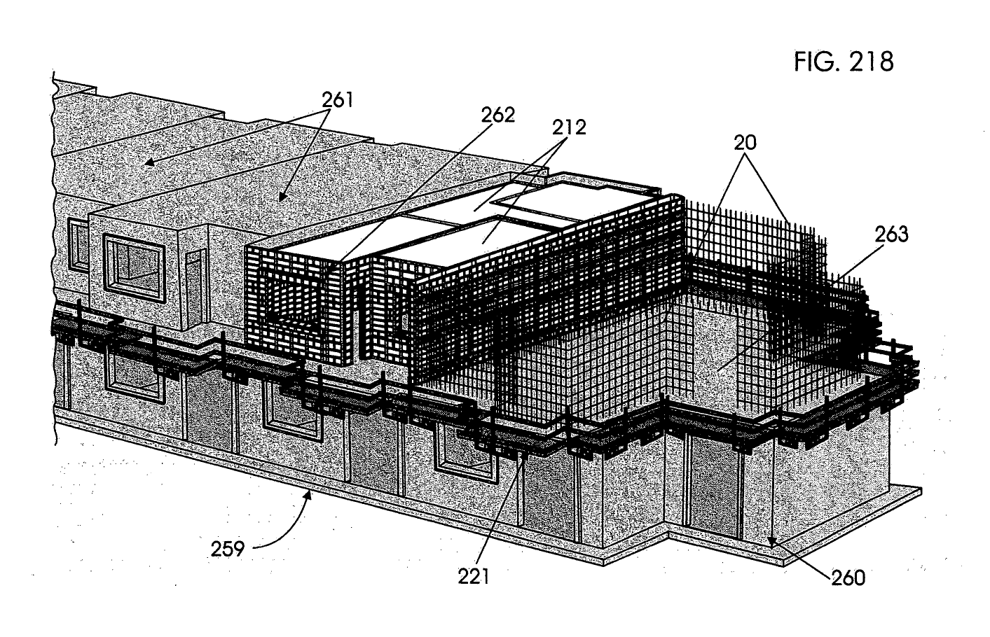

FIG. 218 shows a general view, in perspective, of a row of terraced dwellings, the upper floors of which are at different stages in the construction process: one in the initial phase, with reinforcements for peripheral walls, another in the intermediate phase, with modular formwork fully installed, and the most advanced, already concreted and with the formwork fully removed;

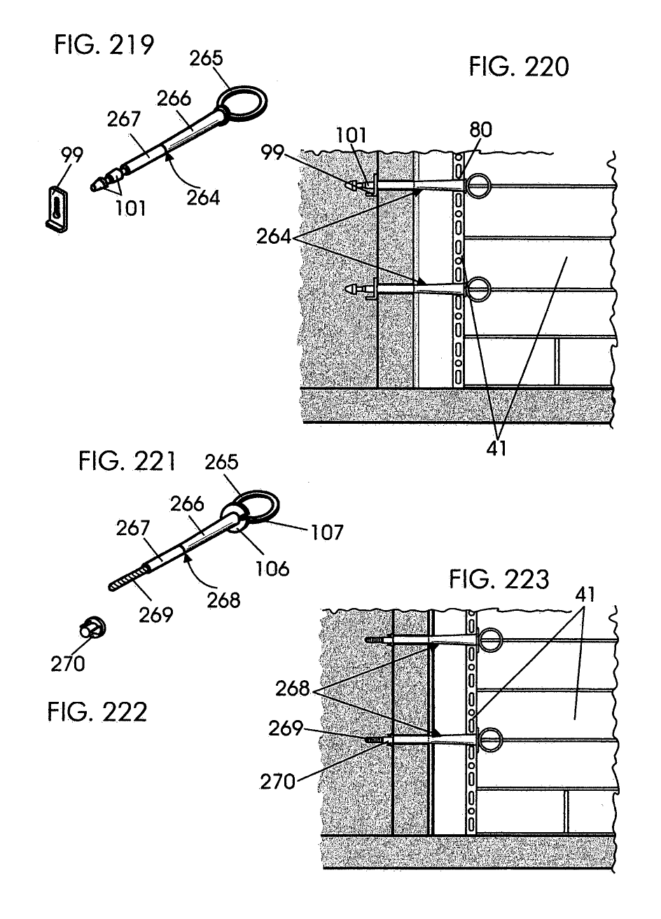

FIG. 219 shows, in perspective, a double wall separator with a partially tapered/cylindrical body and its locking clip;

FIG. 220 is a detail, in cross-section, of how the formwork for a wall is abutted against a wall that has already been concreted, using the double wall separator and clip represented in the previous figure;

FIG. 221 is a view, in perspective, of a very similar variant to the double wall separator shown in FIG. 219, with a threaded end;

FIG. 222 consists of a special nut for threading on to the end of the separator in the previous figure, for securing and locking the same;

FIG. 223 is a view, in cross-section, equivalent to FIG. 220, showing deployment of the double wall separator and its locking nut, as represented in the previous two figures;

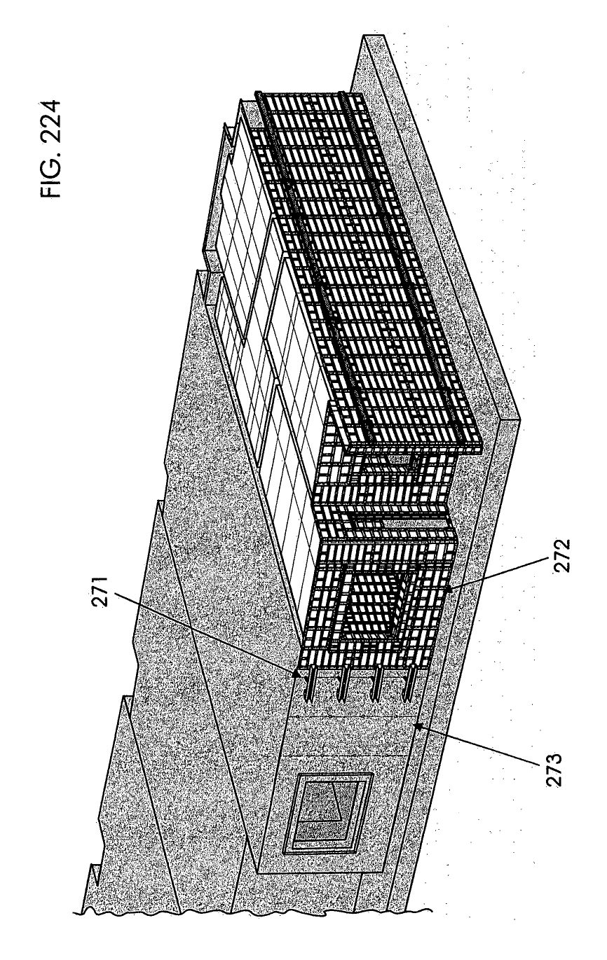

FIG. 224 is a general view, in perspective, representing overlap mechanisms for the external walls of adjoining dwellings;

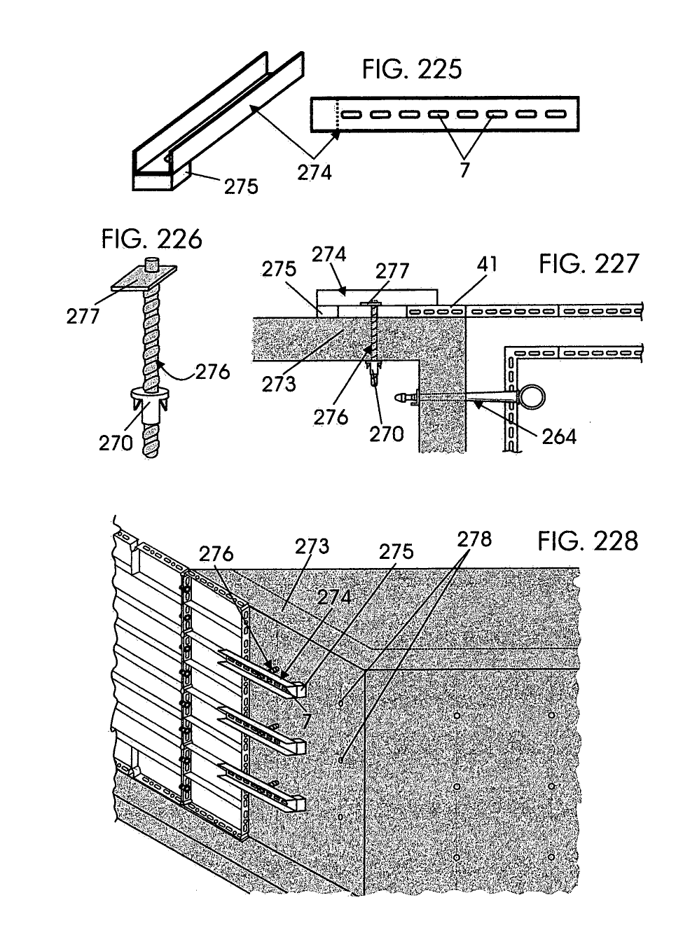

FIG. 225 shows, in perspective, and in plan view, the U-shaped part of the mechanism designed for overlapping an external peripheral formwork on a peripheral wall, likewise external, in two adjoining dwellings, as represented in the previous figure;

FIG. 226 is a perspective of a new overlap tie rod which joins the peripheral formwork to the adjoining external wall, as shown in FIG. 224;

FIG. 227 is a plan view of the overlap, both on an external wall, using the U-shaped part represented in FIG. 225 along with the overlap securing strip in FIG. 226, and the double wall that remains inside the two adjoining dwellings, using double wall separators of the type represented in FIG. 219;

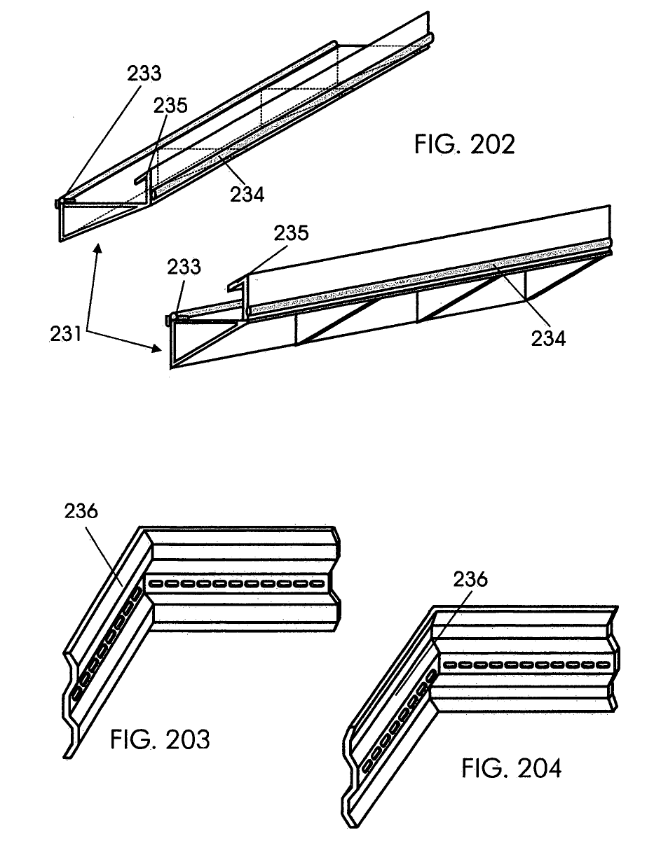

FIG. 202 contains two details, in perspective, showing two different views of the fold-down walkway member referred to in the previous figure;

FIGS. 203 and 204 represent two details, in perspective, of corner pieces, arranged in different configurations, joining the handrails on the safety walkways;

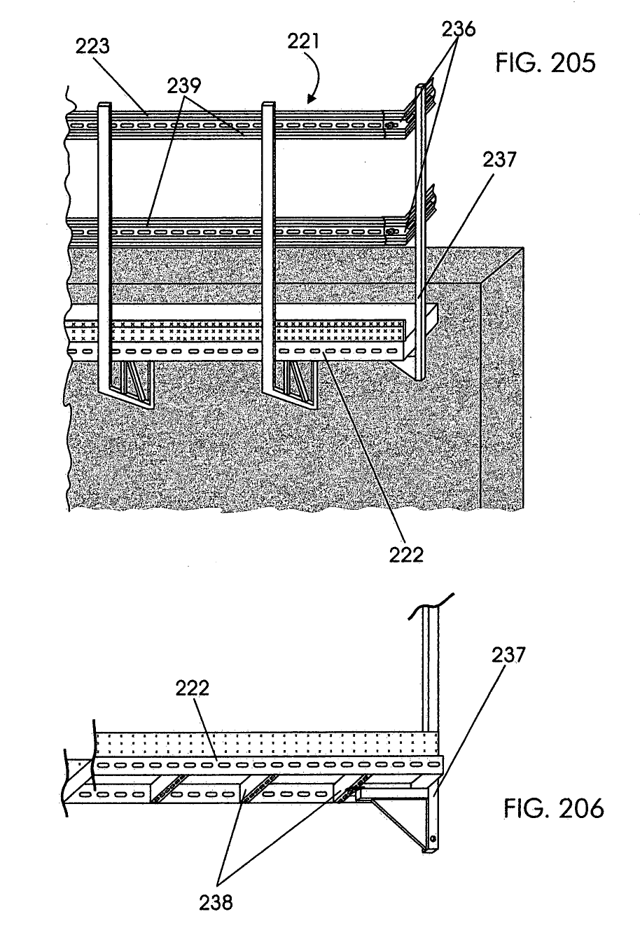

FIG. 205 is a detail, in perspective, of part of a safety walkway, showing a support part for handrails at the ends of the walkways;

FIG. 206 shows a detail, in perspective, from below, of the support part in the previous figure;

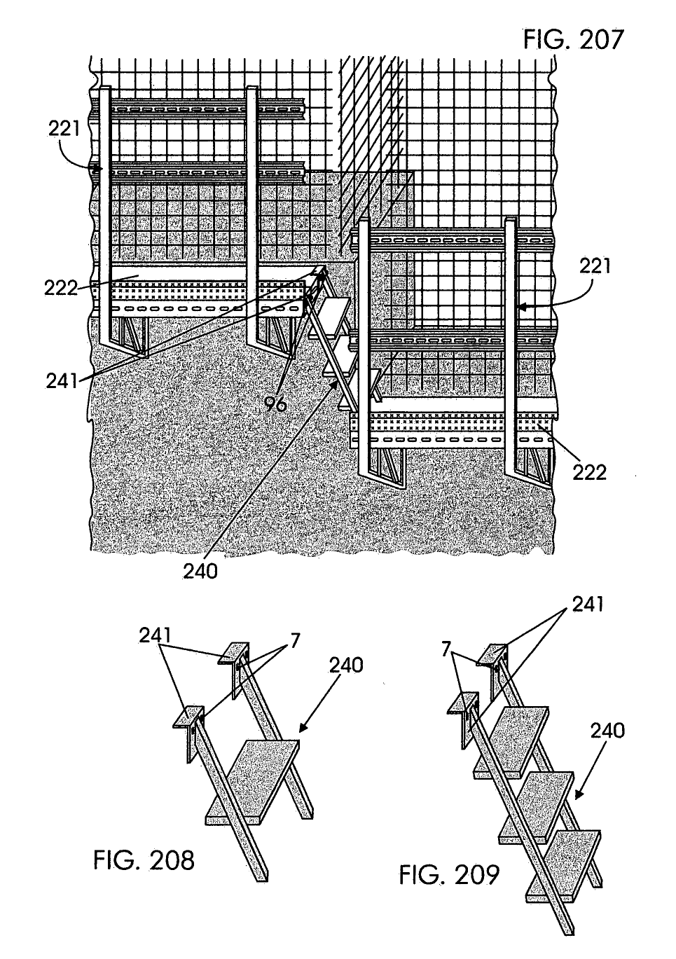

FIG. 207 depicts a view, in perspective, of the implementation of a stairway that can be attached to the safety walkways in order to make good differences in level;

FIG. 208 is a view, in perspective, of a step than can be attached between two safety walkways;

FIG. 209 is also a perspective of a stairway of the same type, but with three steps;

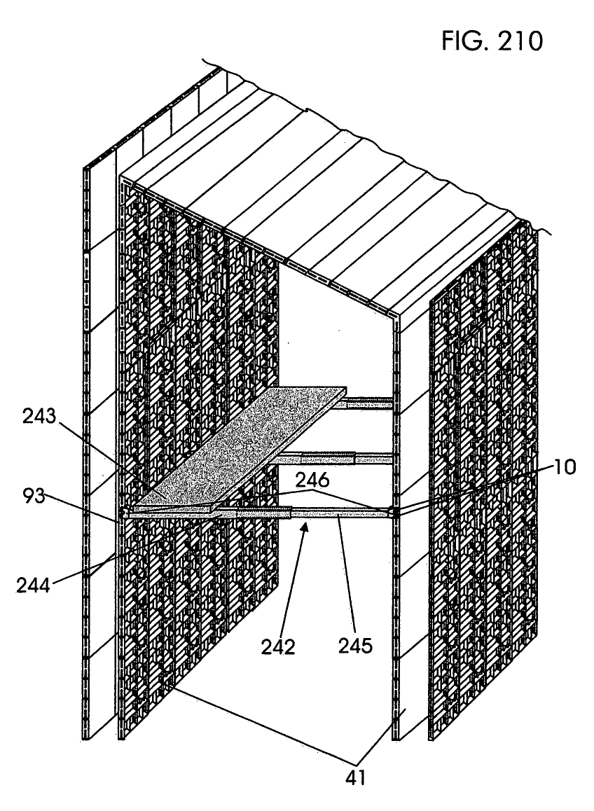

FIG. 210 shows a cross-section view, in perspective, of the deployment of extendible joists for staging that can be secured to the internal plates on the mould panels;

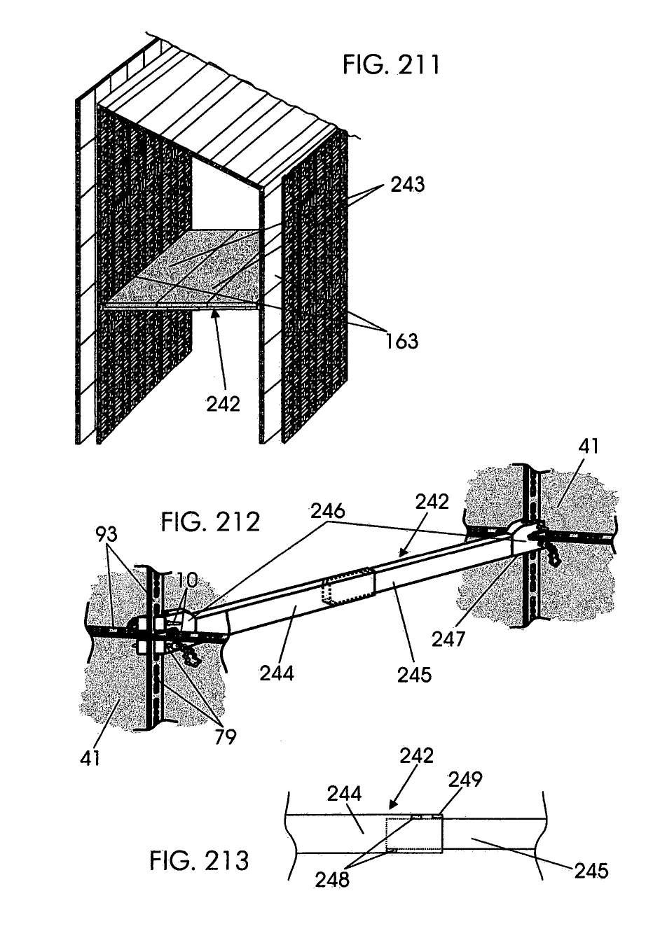

FIG. 211 shows a cross-section view, in perspective, of the complete installation of staging on top of extendible joists inside a mould for a dwelling;

FIG. 212 represents, in perspective, the devices for securing and supporting the extendible joist for staging in FIG. 210;

FIG. 213 is a detail of the structure of the telescopic element in the extendible joist for staging represented in the previous three figures;

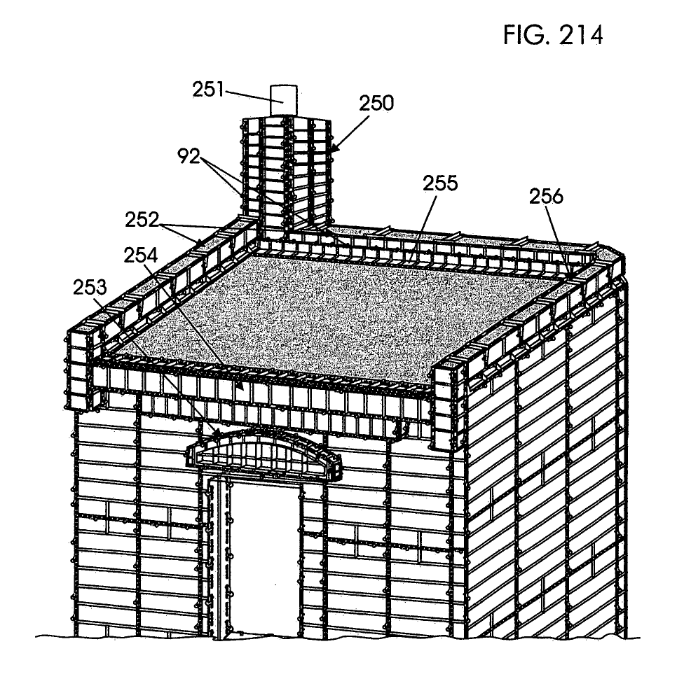

FIG. 214 is a view, in perspective, of a form for the roof of a single-family dwelling with a sloping roof, with the modular panels necessary for forming chimney stacks and parapet walls that are fully integrated into the modular structure of the dwelling;

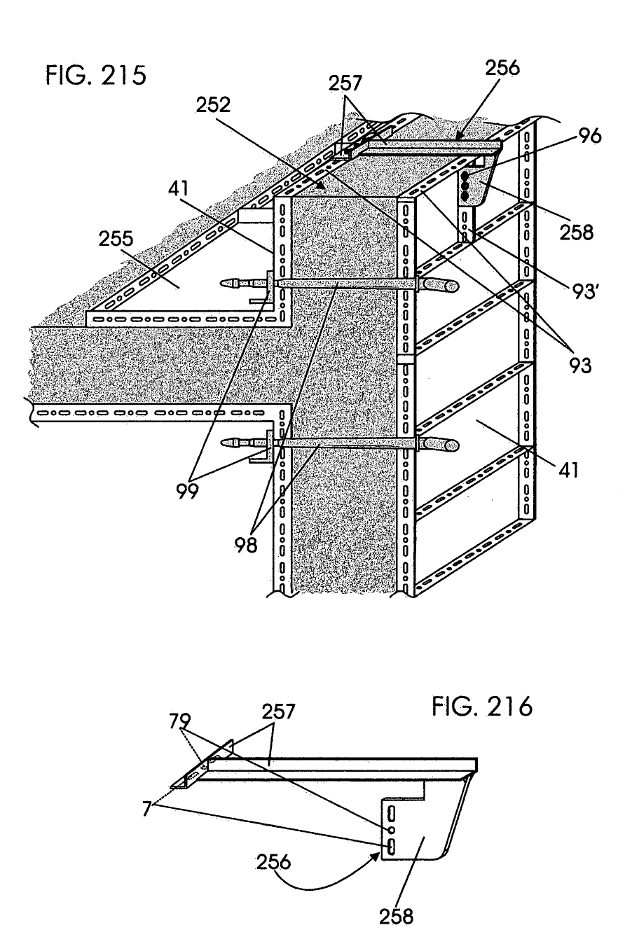

FIG. 215 shows, in cross-section perspective, a detail of the devices for securing the mould for parapet walls already shown in the previous figure;

FIG. 216 is a detail, in perspective, of a part with its L-shaped plates and securing device which separates and secures, at the distance specified, the modular panels that form the mould assembly for parapet walls, as seen in the previous figure;

FIG. 190 is the equivalent of the above, with an assembly of two covers designed for internal walls and partitions, which allows single reinforcements to pass through, for continuity of the said walls and partitions;

FIG. 191 is a perspective of a securing angle which is used with the covers for continuous internal and peripheral walls, as per the two previous figures;

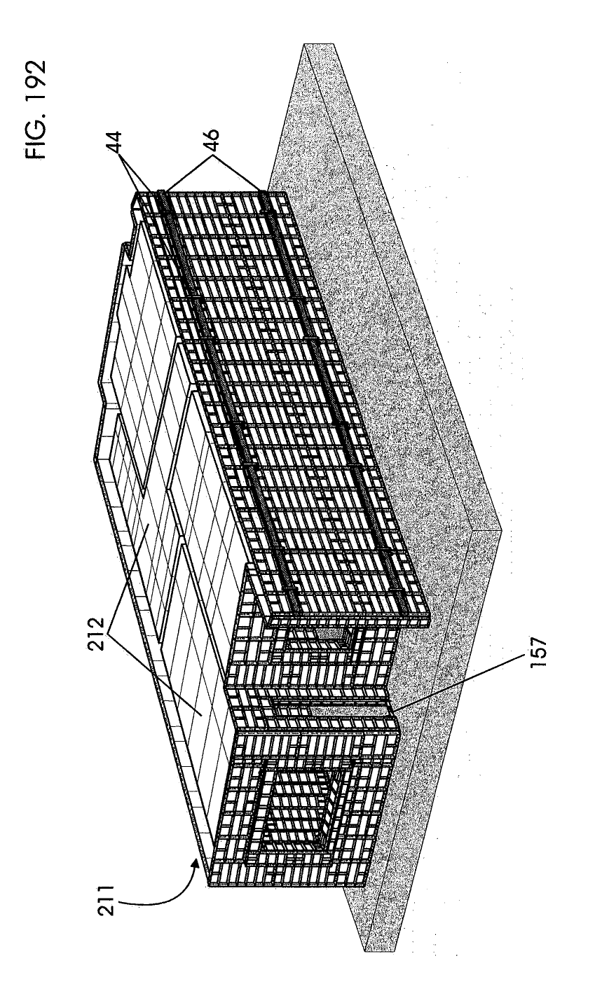

FIG. 192 is a general view, in perspective, of a complete mould installed, in this case, for the ground floor of a single-family dwelling, with the help of relevant alignment joists;

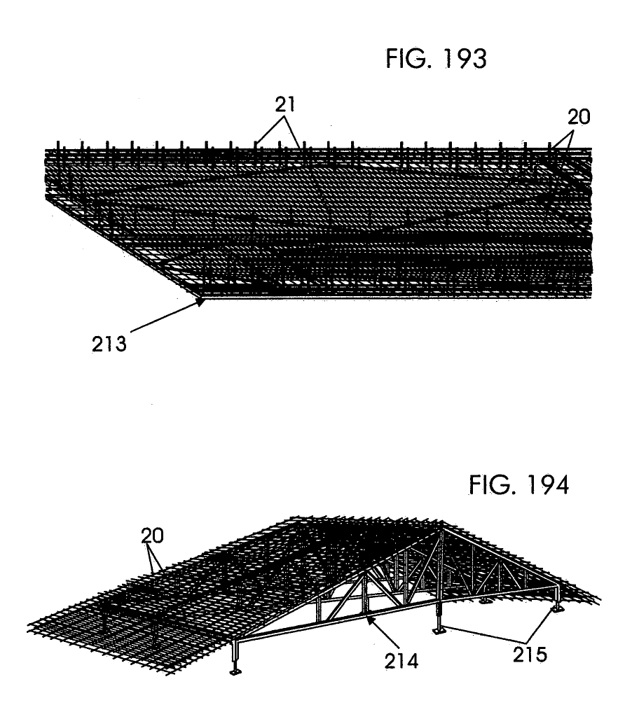

FIG. 193 shows a view, in perspective, of a standard template on which the reinforcements for intermediate slabs between two floors of a dwelling are formed and prepared;

FIG. 194 shows, again in perspective, a standard template for sloping roofs, on which the reinforcements that are to be positioned in the roof of the building are assembled and prepared;

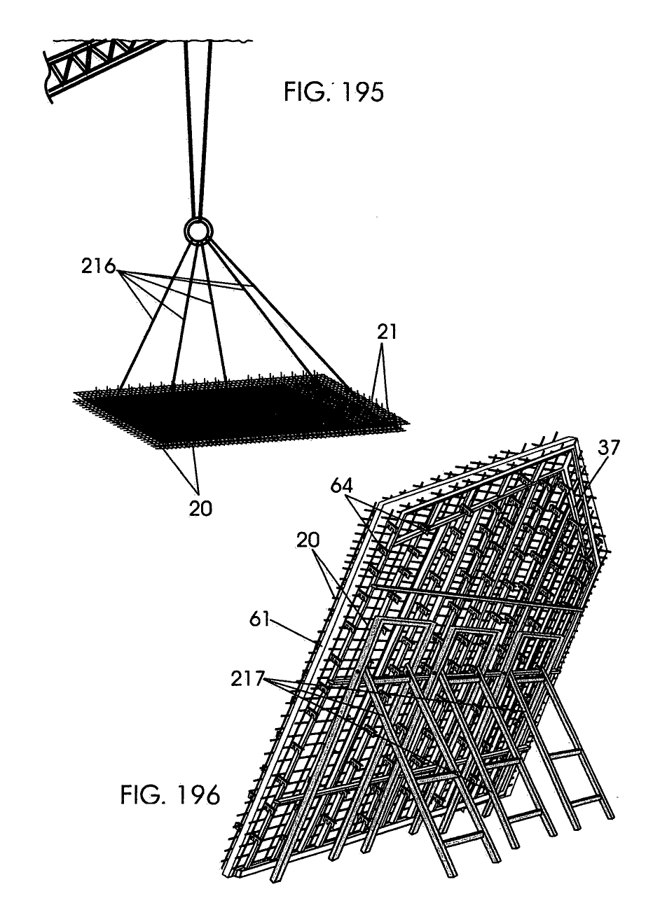

FIG. 195 is a view, in perspective, of the transferral by crane of the pre-assembled reinforcements for forming an intermediate slab between two floors of a dwelling;

FIG. 196 is a view, in perspective, of the system for assembly, on a trestle, of a complete wall template for the upper floors of a dwelling;

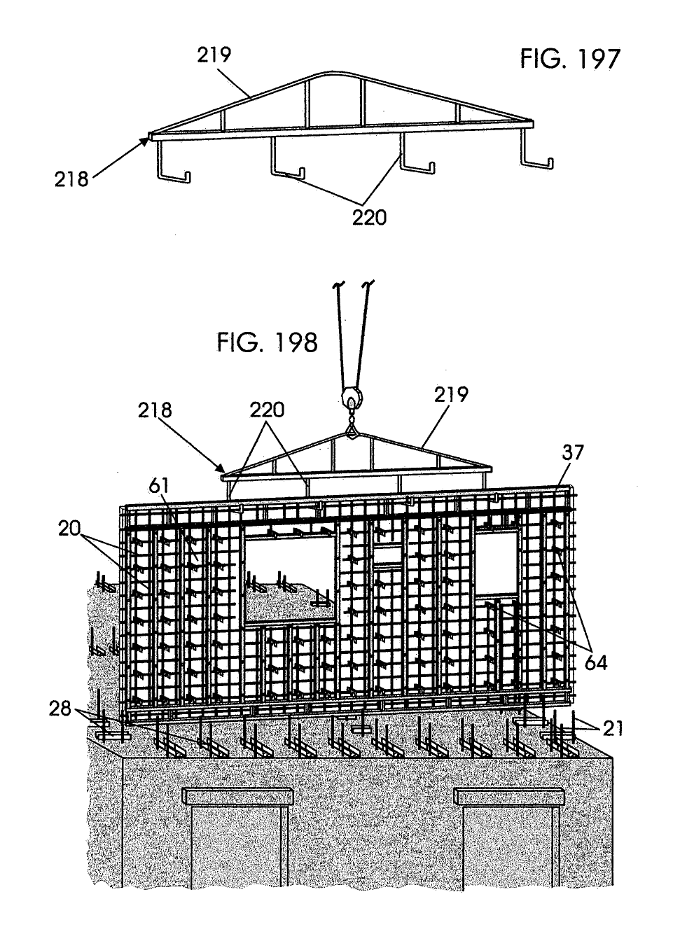

FIG. 197 is a view, in perspective, of a crane hitch conceived for transferral of the upper-floor wall template, fully assembled, to its corresponding position;

FIG. 198 is a view, in perspective, of the positioning of a wall template for an upper floor, using the crane hitch in the previous figure;

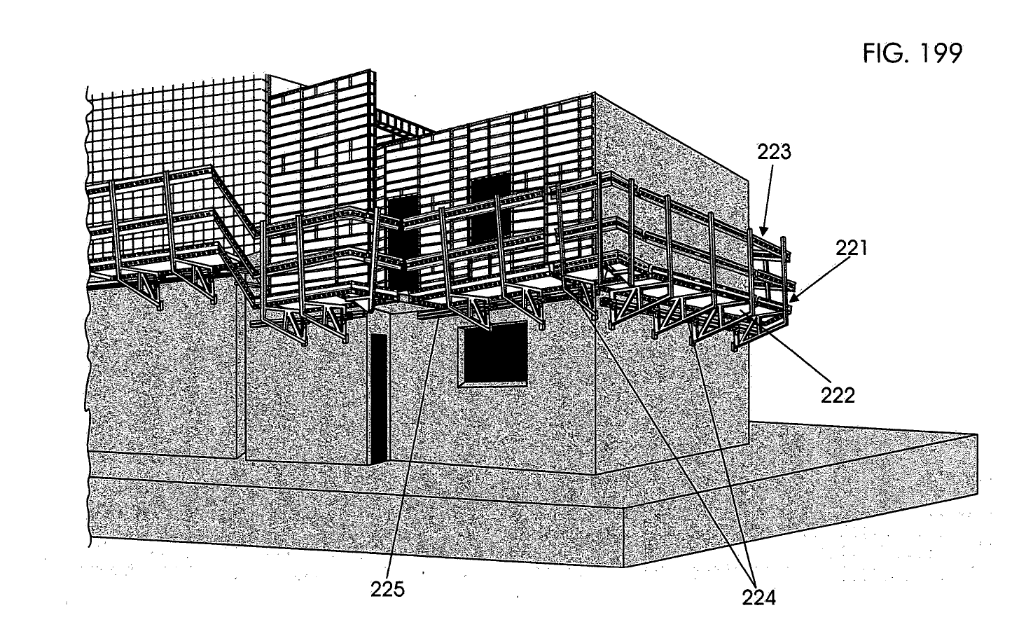

FIG. 199 shows a general view, in perspective, of a block of single-family dwellings on two floors, the upper floor having had its formwork partially removed, showing a new system of safety walkways;

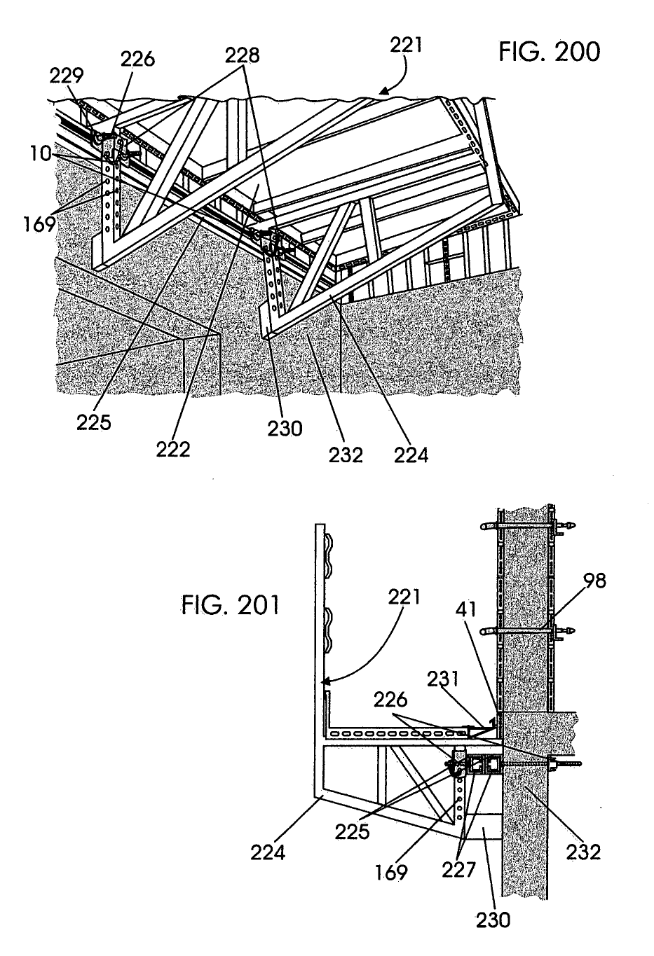

FIG. 200 is a detail, in perspective, of the method of securing the said safety walkways;

FIG. 201 shows a detail, in cross-section, of the attachment of the safety walkway to a wall and the fold-down member, the function of which consists of pressing the wall overlap panel against the pre-concreted wall;

FIG. 228 shows a detail, in perspective, of deployment of the external wall overlap mechanisms represented in the general perspective in FIG. 224 and the component elements of which, as used, appear in FIGS. 225 to 227;

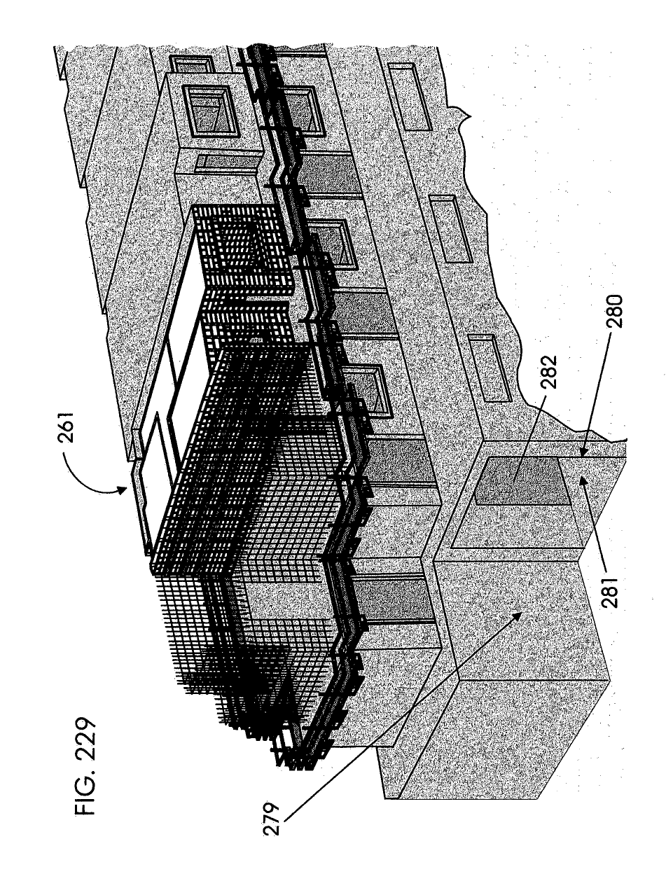

FIG. 229 is a view, in perspective, of a horizontal construction, over a garage, of a row of adjoining dwellings which are at different stages of the construction process;

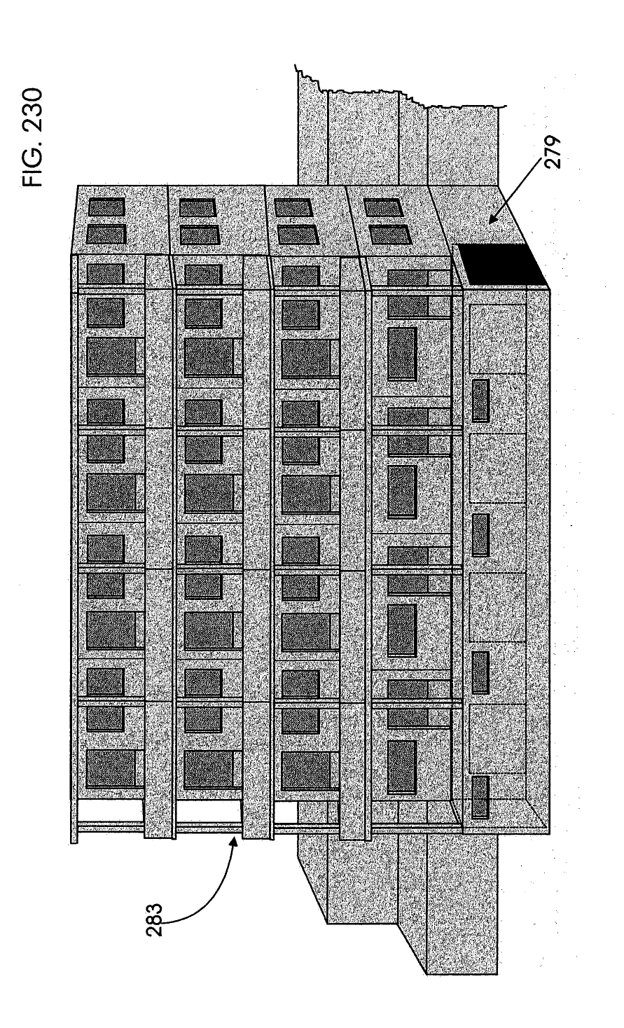

FIG. 230 is a general view, in perspective, of a vertical or high-rise construction of dwellings over a garage;

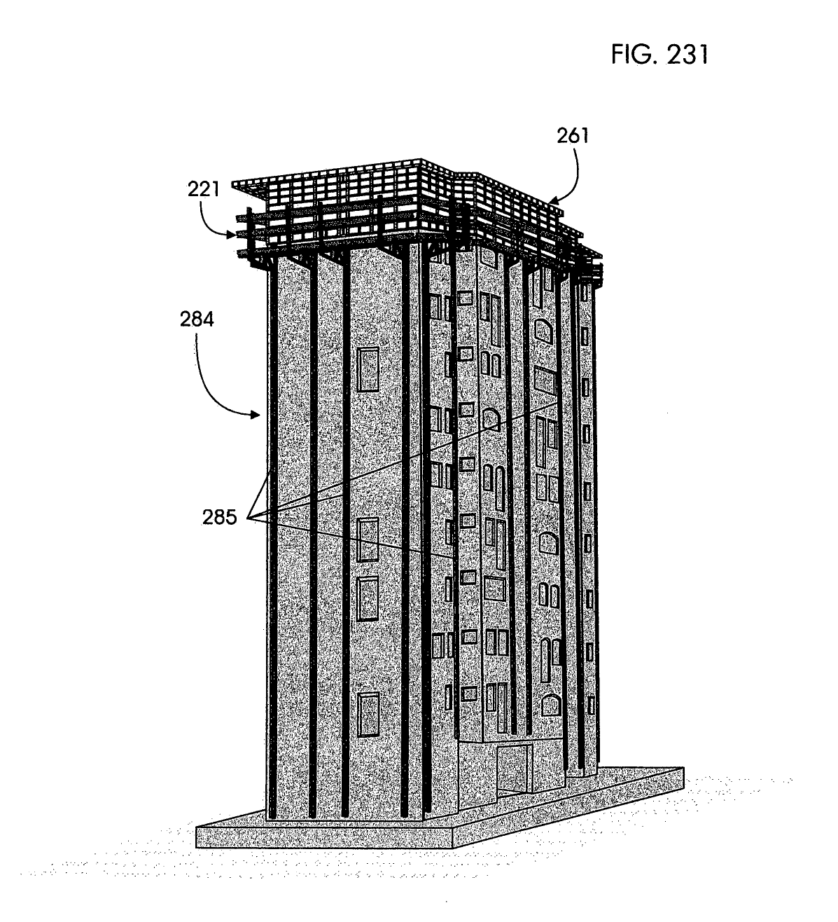

FIG. 231 is a general view, in perspective, of a block of flats constructed using the system covered by the invention, showing the top floor with the complete formwork not yet removed and the peripheral safety walkways duly installed;

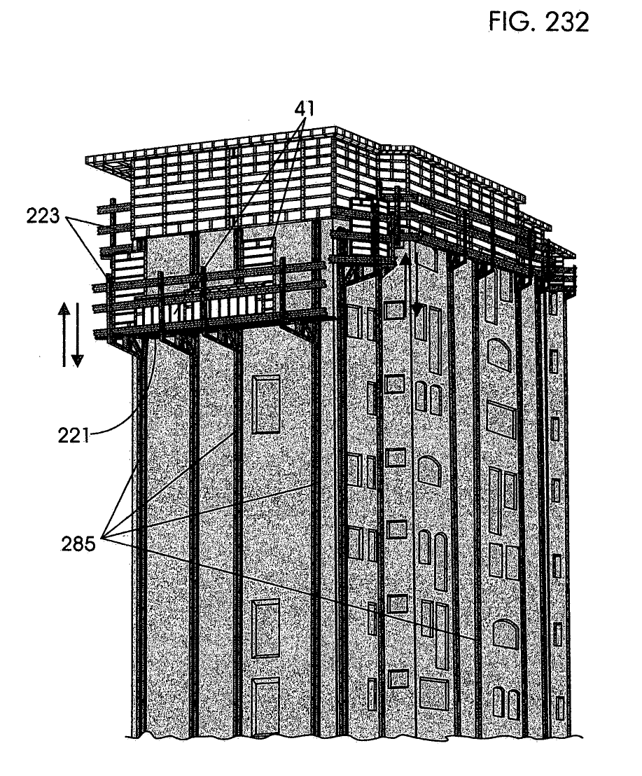

FIG. 232 shows a detail, in perspective, of the upper section of the building depicted in the previous figure, showing the formwork on the top part, as well as the rails or guides designed for vertical movement, at height, of the safety walkways which, in turn, allow for the lifting of modular panels and assemblies of the same for the external formwork;

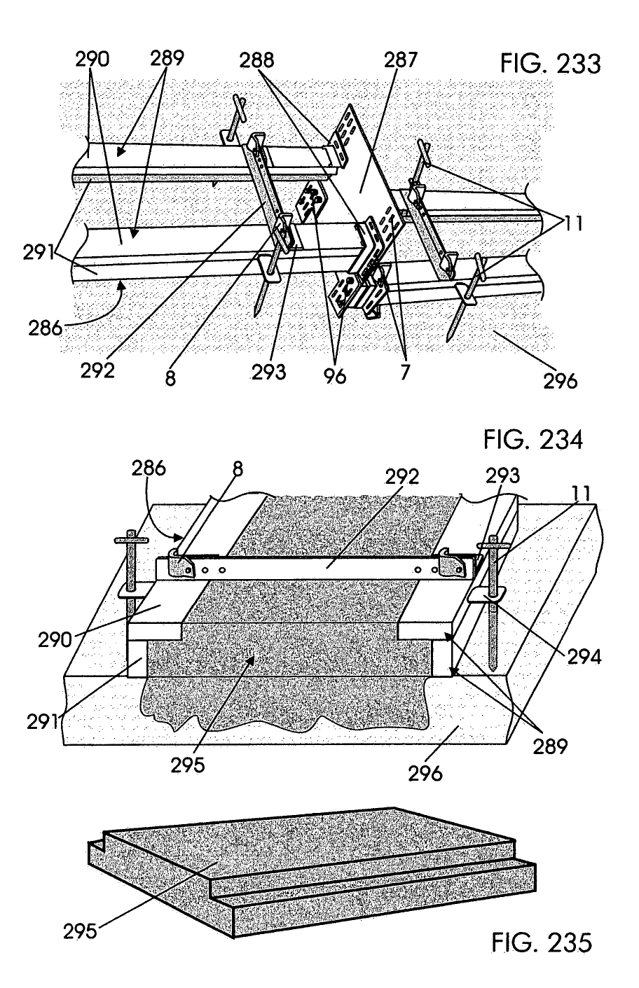

FIG. 233 represents, in perspective, a template for constructing a foundation raft for any boundary wall, garden wall or division, showing joining of its elements, which can be adjusted for variable heights of the land on which it is positioned;

FIG. 234 shows a cross-section front perspective of the double profile of the template in the previous figure, duly positioned on and anchored to the ground, and inside of which can be seen the foundation raft, already concreted, for the boundary wall, garden wall or division;

FIG. 235 is a detail, in perspective, of a completed raft with the characteristics that have been represented in the previous figure;

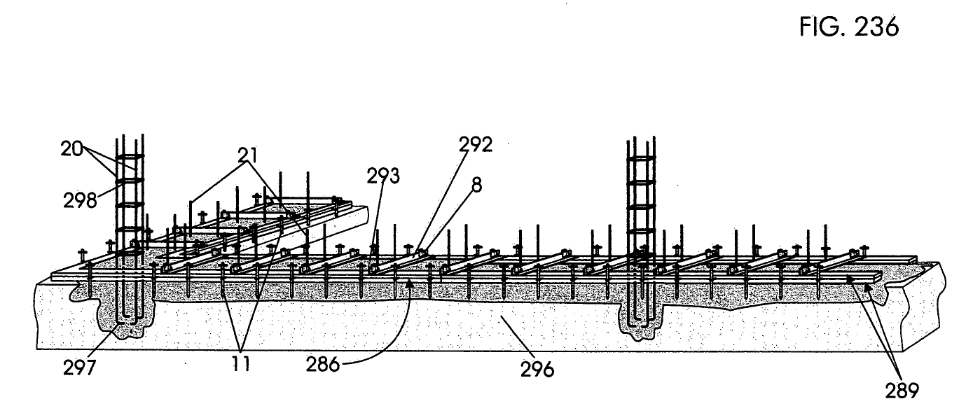

FIG. 236 is a view, in perspective, of a template as per the previous three figures, with all the elements for measurement, adjustment and positioning of standby rods and reinforcements at the points provided for and indicated in the template itself, with the aim of constructing a foundation raft for a boundary wall, garden wall or division;

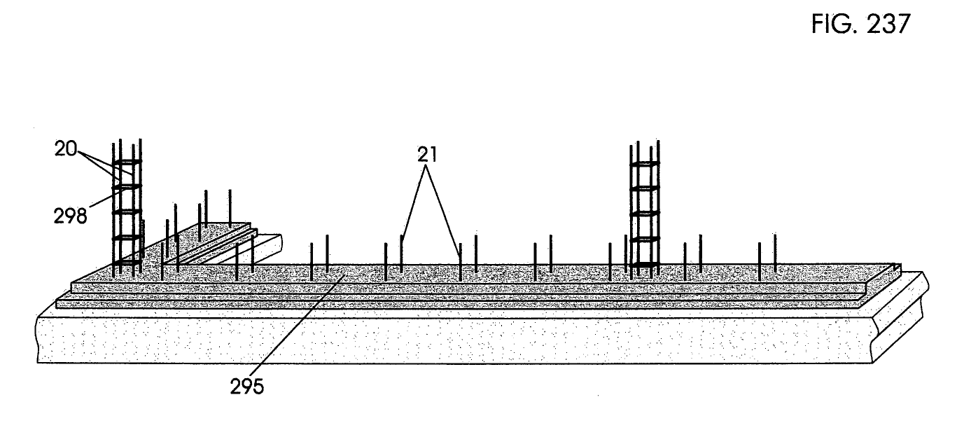

FIG. 237 shows the same general view, in perspective, as the previous figure, but following removal of the configuration template;

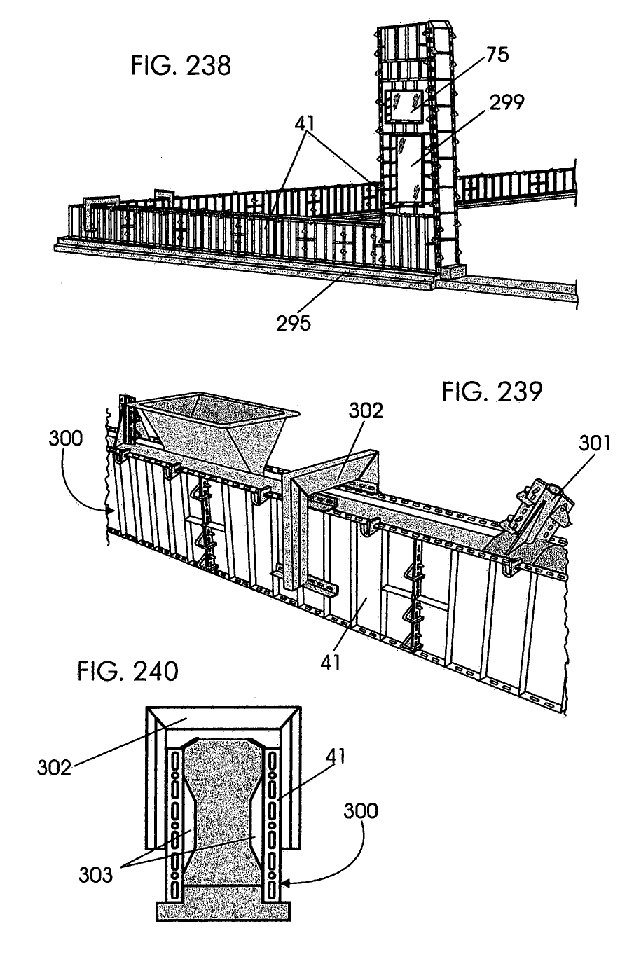

FIG. 238 is a view, in perspective, of the mould for a boundary wall with a column installed on top of the concreted foundation raft in the previous figure;

FIG. 239 shows a detail, in perspective, of the mould for a boundary wall with all the elements provided for in the same and with devices for separating and securing the said formwork;

FIG. 240 is a detail, in cross-section, of the modular formwork in the previous figure, showing the devices for separating and securing the mould;

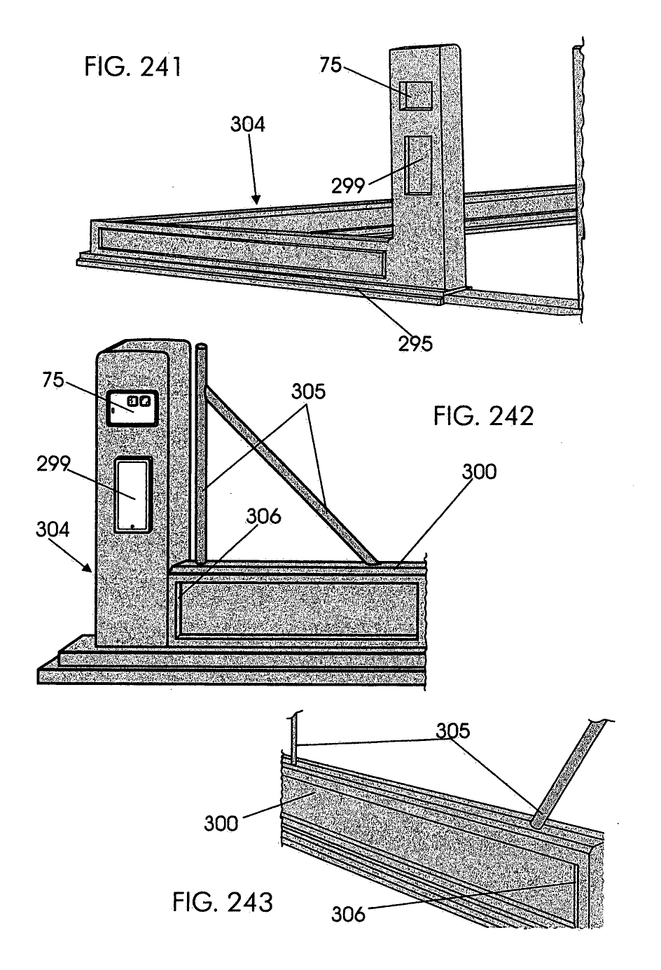

FIG. 241 shows a perspective of part of the boundary wall for the dwelling, consisting of a low wall and column, as represented in FIG. 238, duly concreted;

FIG. 242 shows a detail, in perspective, of a column in the boundary wall in the previous figure, with electrical boxes already installed in the spaces provided for in the mould;

FIG. 243 is a detail, in perspective, of the said low wall that forms part of the boundary wall in FIG. 241;

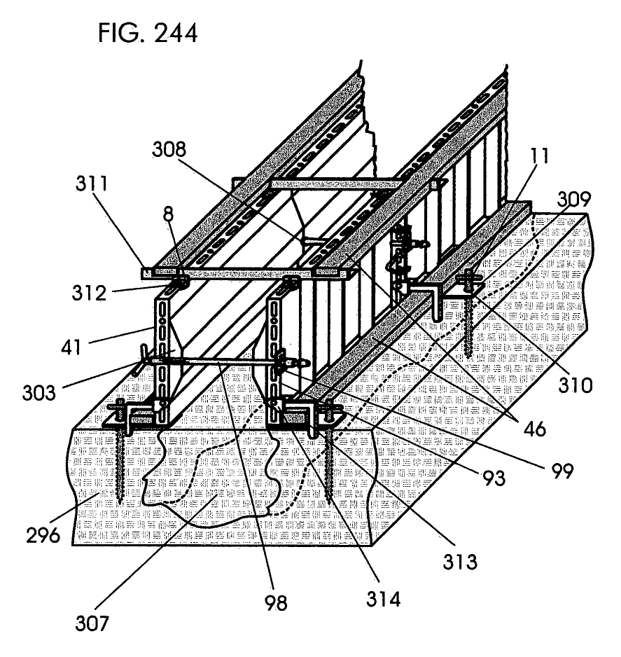

FIG. 244 represents a detail, in front cross-section perspective, of a variant of the mould for a boundary wall that is positioned on the actual ground, on top of which it is to be constructed, and not on top of a foundation raft, showing the said devices for securing and anchoring;

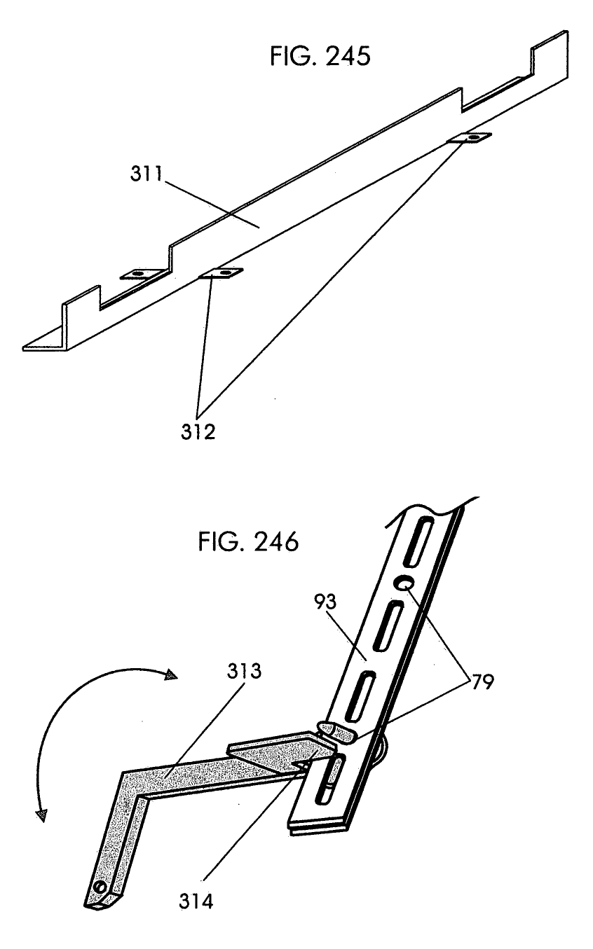

FIG. 245 shows, in perspective, an angular plate designed for securing the upper alignment joists on the mould for the boundary wall represented in the previous figure;

FIG. 246 is a detail, likewise in perspective, of how a bracket is attached for securing the lower alignment joists to the plates on the modular panels that form the said mould for the boundary wall of the type depicted in FIG. 244;

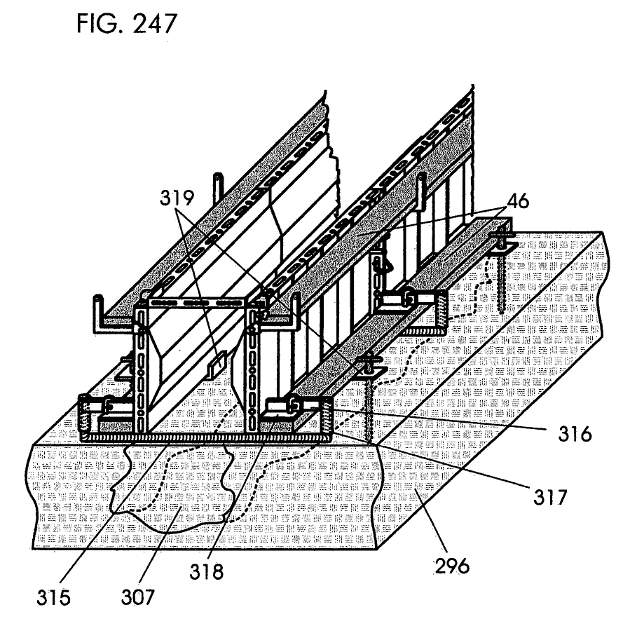

FIG. 247 shows a detail, in front cross-section perspective, of a variant of the mould for the boundary wall detailed in FIG. 244, with a more refined system for alignment, fastening, anchorage and securing;

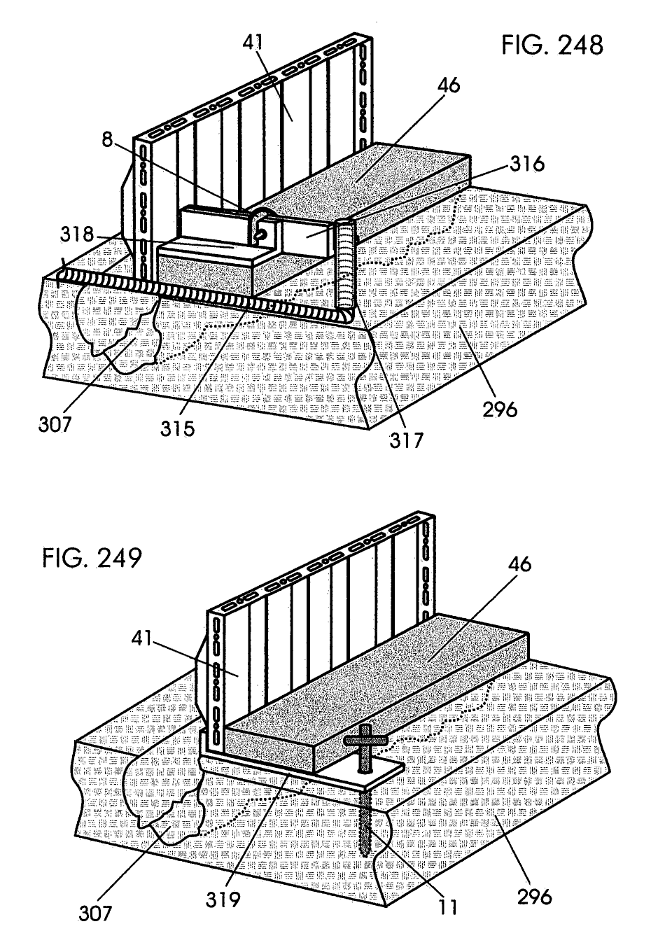

FIG. 248 shows an enlarged detail of the method of aligning the formwork for the boundary wall in the previous figure using a ridged rod secured to the joist at a variable angle;

FIG. 249 shows a detail, in perspective, of securing of the formwork for the boundary wall in FIG. 247, and anchorage of the same;

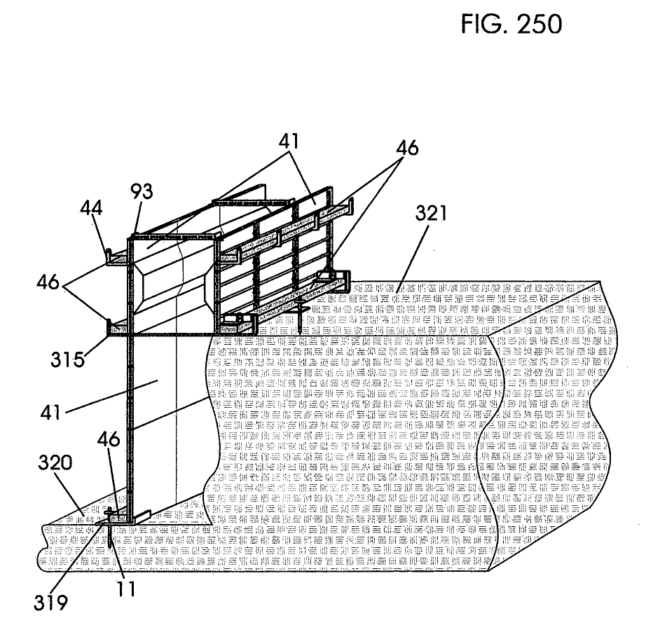

FIG. 250 shows a view, in cross-section perspective, of how the formwork for a boundary wall is assembled, secured and anchored, when there are differences in levels or terraces on which building work is to take place;

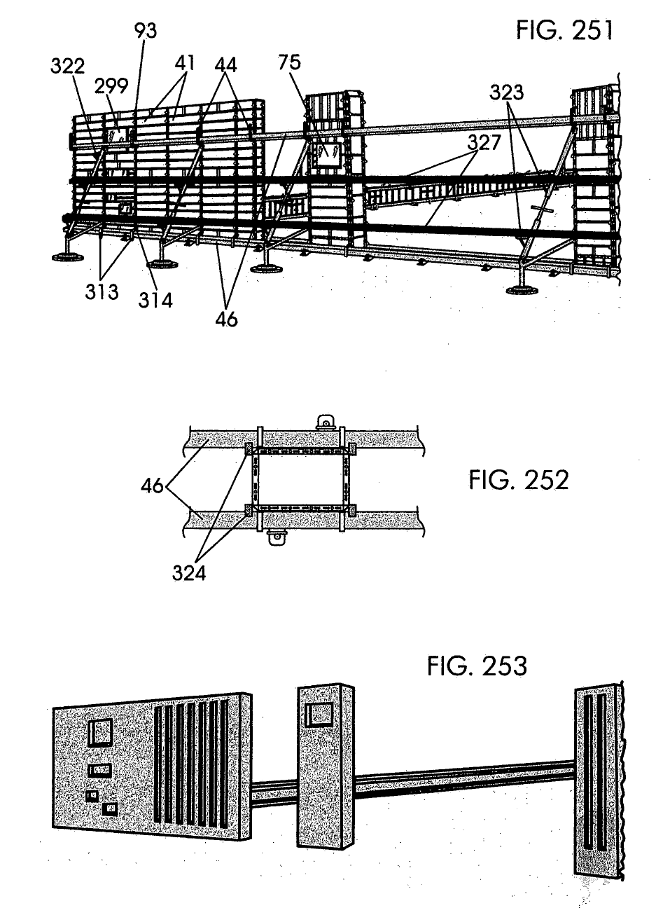

FIG. 251 is a view, in perspective, of another variant of the modular formwork for a boundary wall without a foundation raft, using stabilisers and alignment joints at different heights;

FIG. 252 is a detail, in plan view, of the positioning of centring stops for pillars and walls for boundary walls, that can be used for any of the variants in the present invention;

FIG. 253 is a view, in perspective, of the same boundary wall as represented in FIG. 251, duly concreted and following removal of the relevant mould that gave it its form;

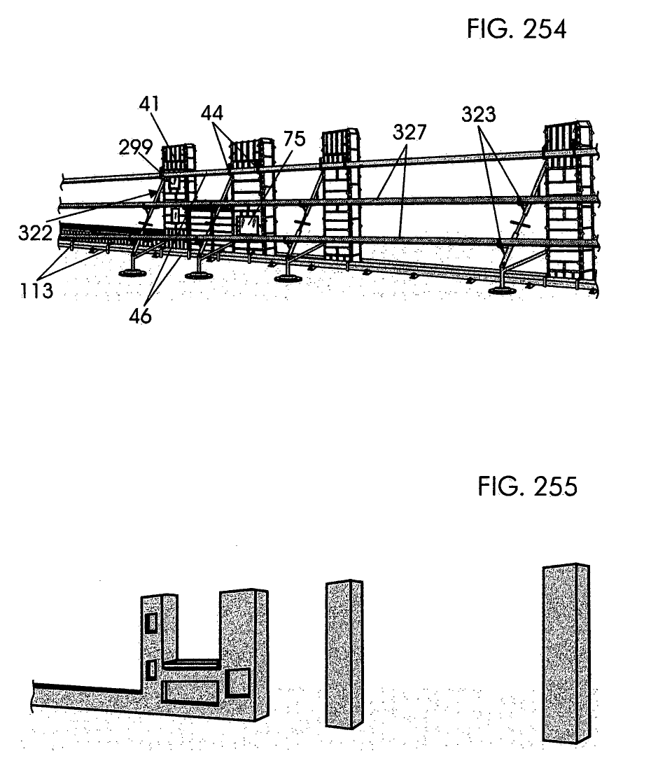

FIG. 254 is a view, in perspective, of another form for a boundary wall with identical characteristics to that depicted in FIG. 251, but of a different design, with a view to showing the many possibilities of this new construction system;

FIG. 255 is a view, in perspective, of the finished boundary wall, as per the design in the previous figure;

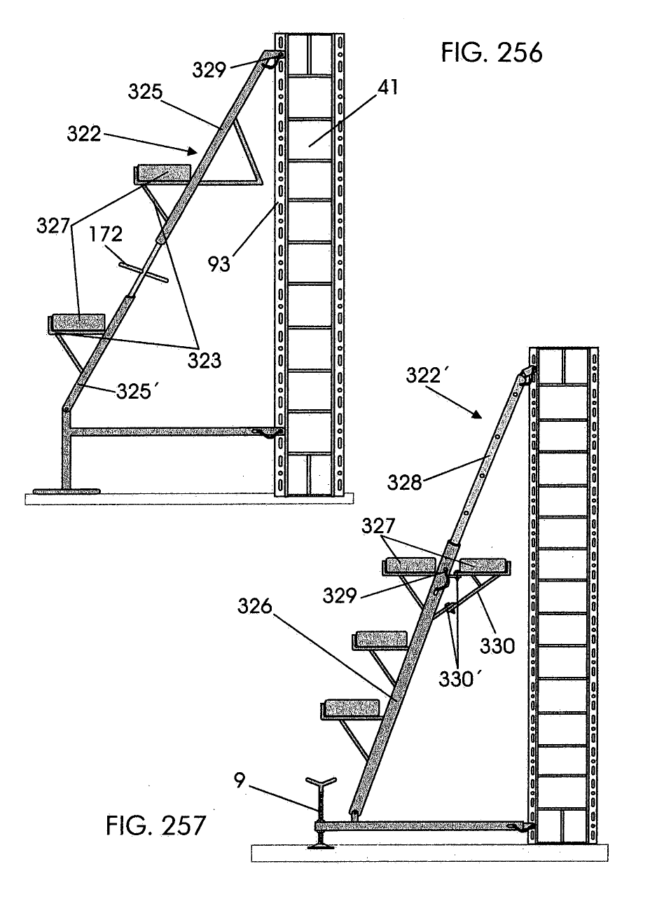

FIG. 256 is a lateral cross-section view of a simple stabiliser of the kind used in forms for boundary walls as per FIGS. 251 and 254;

FIG. 257 is similar to the previous figure, corresponding to another type of telescopic stabiliser likewise used on forms for boundary walls, as shown in FIGS. 251 and 254;

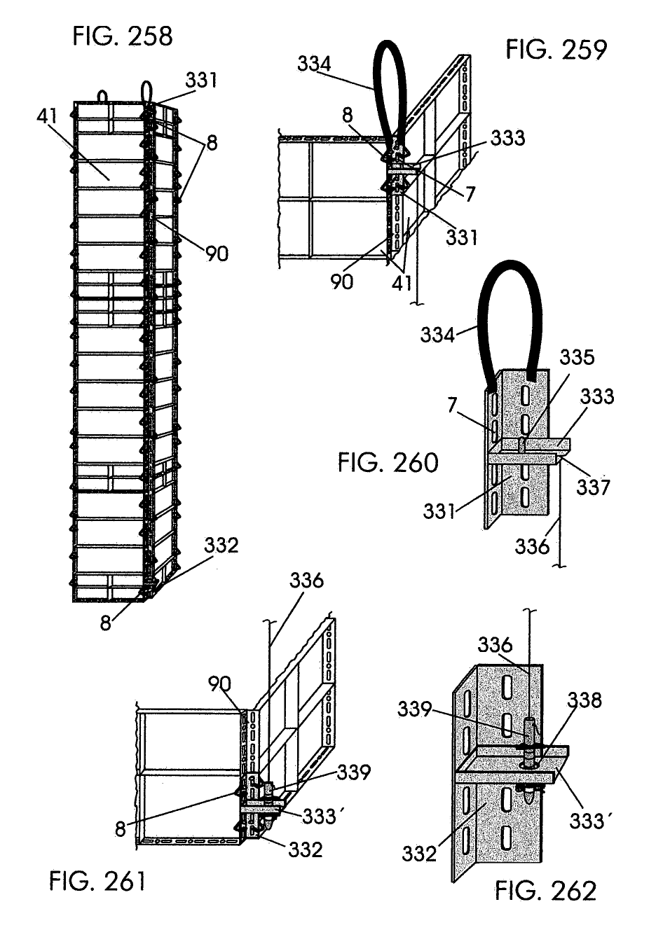

FIG. 258 shows, in perspective, a form for a pillar or column, duly installed, incorporating a new fixed plumb level mechanism;

FIG. 259 is a view, in perspective, of the plumb level mechanism in the previous figure installed on one of the upper corners of the formwork;

FIG. 260 shows an enlarged detail, in perspective, of the same upper plumb level mechanism as depicted in the previous two figures;

FIG. 261 is a view, in perspective, of the plumb level mechanism for pillars and columns, which is installed in the formwork, on one of the lower corners of the same;

FIG. 262 shows an enlarged detail, in perspective, of the same lower plumb level mechanism as depicted in the previous figure;

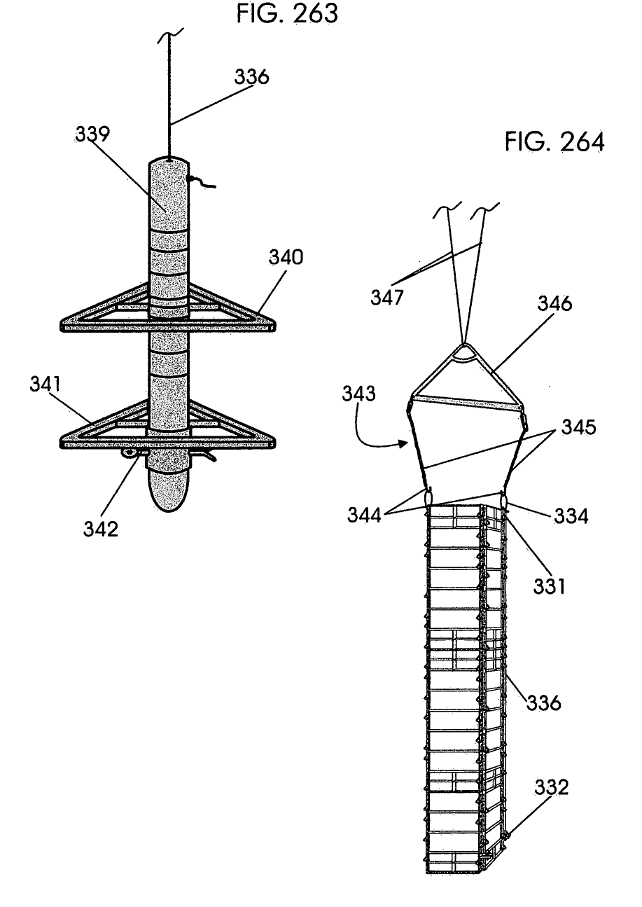

FIG. 263 is a detail, likewise enlarged, of the new precision plumb bob with centring rings and securing elements, as used in the plumb level mechanism for pillars and columns represented in the previous five figures;

FIG. 264 shows, in perspective, the transferral by crane of the formwork for a pillar or column fully assembled and plumbed, as represented in the stages in the previous five figures;

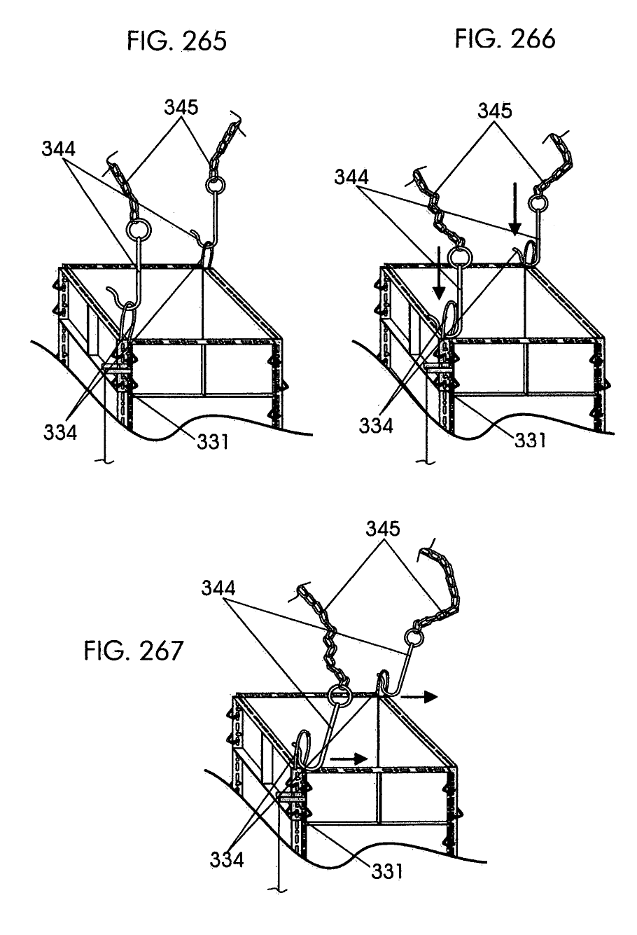

FIGS. 265, 266 and 267 show, in sequence, the method of hitching and unhitching the crane for transferral, as a block, of the formwork for a pillar of column that is perfectly plumbed and without its suffering any variation in verticality;

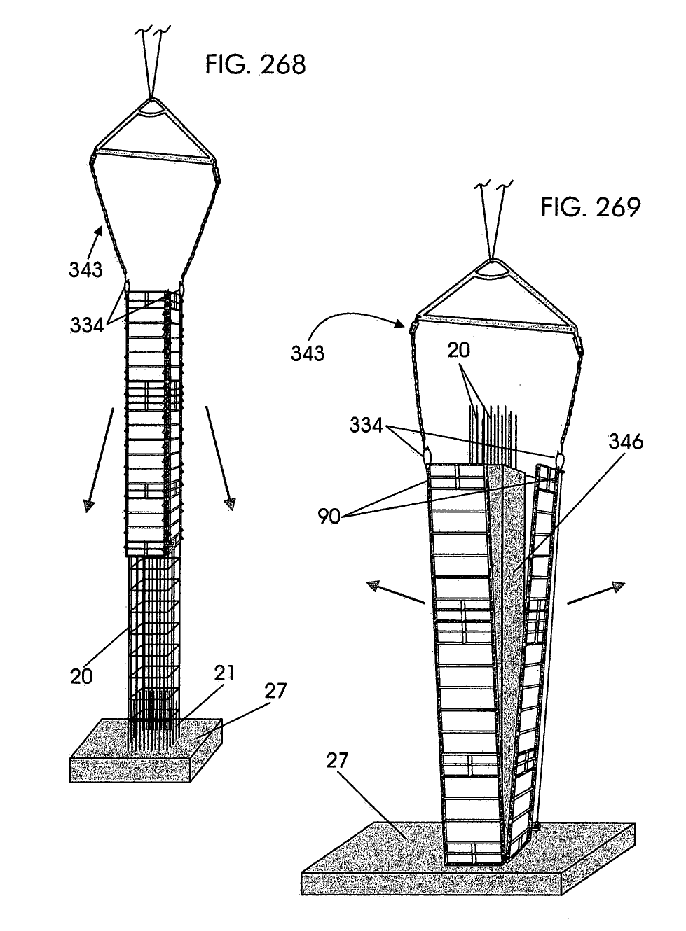

FIG. 268 shows, in perspective, as per the previous sequence, how a mould for a column or pillar, fully assembled and plumbed, is placed in its definitive position, using a crane, leaving the necessary reinforcements inside the said mould, secured with hoops; and

FIG. 269 shows, likewise in perspective, removal of the formwork from the same column or pillar once concreting has taken place, using the same crane hitch.

In accordance with the figures listed, the refinements and developments in the mechanisation of construction using the high-precision integral and modular formwork system for the creation of structures in reinforced concrete or any other kind of material with similar characteristics to this, and by making reference to the said figures, there is identification below, and strictly following the chronological operational order indicated in the said list, of all the elements covered by the refinements that will be claimed and new parts, tools and other items necessary for ensuring a fast fully industrialised construction system via mechanisation and rationalisation of the same.

Each of these new elements, parts and tools is identified with a reference number which details, insofar as is possible, the construction sequence arranged into different phases or stages, each of which puts forward a whole construction and mechanisation system that is the simplest, safest and most efficient possible, ensuring the implementation, with full guarantees, of the concept of industrialisation in construction. This is achieved, as explained in the present description, as a consequence of the fact that each and every one of the phases or stages that make up the construction sequence for the system is perfectly defined and determined, has its own elements and tools for implementation and, moreover, is provided with an effective auto-control and auto-correction system, which avoids all kinds of human error or discrepancy between what is envisaged and the results obtained.

The construction, using high-precision modular formwork, of any kind of structure in reinforced concrete, or some other material that solidifies, with suitable characteristics in terms of cost, resistance and nature of the same, carried out using the construction system perfected in terms of mechanisation, systematisation and rationalisation, as covered by the present invention, will generally be seated on a foundation raft, whether situated on top of the ground itself or constructed on pillars on sloping land, or on top of any other reinforced concrete structure, such as garages, for example. The precision of the foundation raft is always fundamental for perfect installation of the whole mould that will give form to the said structure, whether this be a single-family dwelling, a block of flats, or any type of construction, since this is an industrialised system where each phase in the sequence, carried out using mechanised methods, has direct repercussions on the construction sequence and, therefore, on the final outcome of the structure to be built.

The construction of a foundation raft constitutes the first phase in the construction sequence and, for this, two essential elements are used: the foundations formwork and the layout and positioning template.

FIG. 1 shows, in plan view, the foundations formwork (1), a new element of great practical use and high precision, made up of both simple standard modular parts (2), their faces forming a right-angle dihedral, and modular parts at the angles (3), clearly detailed in FIGS. 2 and 3, respectively. Both types of parts (2 and 3) have, in addition to the drilled profiles (6), structural angular reinforcements (4), which join the two faces of the dihedrals, likewise drilled with oblong orifices (7), as are the profiles (6), which provide them with great resistance against deformation faced with the pressures originating in the casting material that will form the foundation raft inside the same, as well as having, on the periphery of their upper plates (6′), protruding adjustment legs (5) for centring the layout and positioning template, as shown in FIG. 9 and which is detailed below.

These standard parts, depicted in FIGS. 2 and 3, are attached to one another, as can be seen in FIG. 5, by means of the external lateral plates (6) that also have peripheral oblong orifices (7) into which self-centring clamps (8) are inserted, which ensure a precise fit and the function and special design of which are already specified in the previous patent no. P9401135 granted in favour of the same applicant, and which is again detailed herein, in FIG. 4, since this is a very useful high-precision element in the process of mechanisation of the constructional refinements covered by the present invention. The foundations formwork may therefore, and as explained, form foundation rafts with an infinite number of peripheral forms, thicknesses and dimensions, depending on the needs of the structure to be constructed on the said raft, without there being any limitations of any kind for the same.

For stabilisation and anchorage of the complete formwork to the ground, use is made of a type of stabiliser (9) that can withstand the pressures that may be exerted by the casting material during formation of the foundation raft inside the formwork, as depicted in detail in FIG. 6, and which is attached to the structural angular reinforcement (4) drilled with oblong orifices (7) on standard parts (2 and 3) for the formwork for foundations by means of security pins (10), and an anchorage (11), shown in FIG. 7, which are used in the way shown in FIG. 8. All of these elements referred to up until this point mean that the foundations formwork is a strong self-aligning structure, that installation and dismantling thereof are simple and mechanised from start to finish and that it is endowed with an essential characteristic, high precision.

Following precise installation and perfect anchorage of the formwork for the foundation raft to the ground, the following essential element that is included in the system's mechanised construction sequence is the layout and positioning template (12), which will be positioned on top of the said formwork, as represented in FIG. 9, this being adjusted by means of the latter's adjustment legs (5), as has been indicated above. This is a measuring element that has been perfected in respect of the applicant's previous patent, and which affords the high-precision modular construction system greater agility and accuracy in terms of the demarcation and centring of the different elements in the foundation raft.

FIG. 10 depicts this same layout and positioning template (12) separated into various sections that make up the same, the number and form of which will depend on the dimensions and design of the structure to be built. This division of the template (12) into rigid sections, thanks to reinforced ties (13) for exact alignment of the different panels that make up the same, facilitates the transportation and manoeuvrability of the same, which, after being assembled, form a complete template, as shown in FIG. 11 and which may be placed in position and removed, as has been said, on top of the said formwork for the foundation raft as many times as may be necessary, in order to ensure that walls, partitions and general installations are in their precise positions, or correct the same, prior to proceeding with concreting of the raft. The joints between the different sections that make up the layout and positioning template (12) are also effected using the high-precision self-centring clamps, as represented in FIG. 4, both for the central parts of the sections, as indicated in FIGS. 12 to 14 in different views, and at the corners of the template sections, as depicted in FIGS. 15 to 17.

FIG. 18 shows how the layout and positioning template (12), after being placed in position on top of the foundation formwork for the raft (1), and being adjusted by means of the adjustment legs (5), indicates, in a precise manner, each and every one of the basic elements, so that the construction sequence progresses without there being any faults or maladjustments of any kind. This avoids any kind of manual alignment and therefore the consequent appearance of errors, since, this being a systematic and mechanised procedure, it avoids human errors while, at the same time, saving money and ensuring greater efficiency during this stage of the construction process. Thanks to this template (12), there is perfect indication of the position, dimension and thicknesses of peripheral walls (14) and internal partitions (15) within the single-family dwelling which we are taking as an illustration in this case, as well as the position of doors (16) and windows (17), and also piping outlets (18) and moulds for sanitation chambers (19) that will be connected to the piping outlets via the same and which will be integrated into the future foundation raft. This same formwork for the foundation raft also incorporates, as an authentic reinforcement mechanism, the reticular reinforcements (20) comprising metal rods on to which standby rods (21) are welded, as will be seen later on in FIG. 24 and the blocks of insulating material (22) for the raft. Following filling of the foundation formwork with the liquid concrete or some other material with similar characteristics, the said foundation raft will be cast within this mould, to form a compact, integral and monolithic block which will incorporate and house, with complete accuracy, all the necessary installations, and all measurements, dimensions and thicknesses of partitions and walls in the dwelling in question will be indicated to the millimetre.

FIG. 19 depicts, in greater detail, these connections for outlets from sanitation piping (18), as referred to above, via the said piping, to the moulds for the sanitation chambers (19) and the outlets for drains to positions outside the raft (23), which is detailed more clearly in FIG. 20, where it is possible to observe their gradient for the discharge flow of waste water. Using the said refinements, it is possible to achieve a whole sanitation system inside the foundation raft, which can be easily installed, following the indications and precision measurements afforded by the layout and positioning template (12).

FIG. 21 depicts the new mould conceived for producing a sanitation chamber (19), in which the frame for the cover (24) is attached to the same at the required height, thanks to protruding drilled plates (25) with oblong orifices (7), which allow for the securing of the said framework via an exact joint using self-centring clamps (8), as can be clearly seen in FIG. 22. The dimensions and forms of the mould for the chamber may vary in terms of the construction needs of the plans to be realised; however, and irrespective of the said variable aspects, it will always consist of another element that completes this whole mechanised industrialised construction process, and which allows the sanitation chamber to be incorporated into what will be the foundation raft, with its respective seat for the cover.

FIG. 23 shows, in great profusion, centring elements (26) for the template (12), both for the piping (18) and for the sanitation chambers, in addition to showing, in detail, elements that have already been mentioned, such as the reinforced ties (13) securing the template profiles, the internal reticular reinforcements (20) for the foundation raft and the double standby rods (21) for peripheral walls.

These standby rods (21) are welded to the reinforcements (20), as shown in FIG. 24, at the points indicated by the layout and positioning template (12) for the internal partitions and peripheral walls, and will form a joining element between the foundation raft and these walls and partitions to be built. Again, the overall importance of the layout and positioning template, as a basic measuring element, which allows for the realisation of all this work in a rapid, simple and economic manner that is proof against human error, due to the mechanisation afforded by this element in this construction phase, is patently evident.

FIG. 25 represents, in the form of a view in perspective, the nature of the foundation formwork (1), as referred to throughout the whole description, with all the elements that have been gradually incorporated by means of the exact references indicated by the layout and positioning template, which has now been removed, leaving all the elements that will make up the said foundation raft, such as the reticular reinforcements (20), standby rods (21) or footings for the reinforced joints between partitions and walls and the foundation raft, sanitation piping (18) or moulds for sanitation chambers (19), ready and perfectly positioned.

The subsequent and definitive step in the construction sequence for fabrication of the foundation raft itself (27) is the pouring, within the completed foundation formwork, of the casting material, as represented in FIG. 26. For this, liquid concretes with specific qualities are usually used, since they facilitate, enormously, automatic levelling of the foundation raft, allowing for the achievement of a completely flat and smooth raft, which may always be helped by means of levelling boards, not shown in the present invention patent, since they are well-known in the field of construction.

Obtaining a completely flat and smooth foundation raft is a fundamental matter in the industrialised construction process we are claiming in the present patent, since this is the basic element on which, subsequently, installation of the moulds for constructing the dwelling will take place, in the example we are currently concerned with.

Following concreting of the raft, and while the modular foundation formwork has not yet been removed, the layout and positioning template (12) will be re-positioned, this being centred by means of the upper peripheral adjustment legs (5) on the modular parts (2) (3) which make up the formwork (1), as illustrated in detail in FIG. 27. Using this, the relevant checks are carried out to ensure that all the elements that make up the foundation raft (27) are duly positioned in the places envisaged using the said template, without undergoing any modification or change during the process of concreting the said foundation raft. This is another step that forms part of the refinements and new developments in mechanisation of the high-precision modular construction system referred to in the present patent, and implies an essential corroboration before being able to continue with the industrialised construction using mechanical procedures without there being any subsequent setbacks. The layout and positioning template (12) is, therefore, and as has been indicated throughout this description, not only a high-precision measuring element, but a whole mechanised system that allows auto-control and auto-correction in this first phase of fabrication of the foundation raft, and which guarantees the base so that the rest of the construction can be executed correctly.

Moreover, another aspect of vital importance, that takes place during this phase of the process, is the positioning and securing of U-shaped stop parts (28) for centring the peripheral walls and internal partitions of the dwelling or any other type of construction idea, which will be placed in position and secured to the said foundation raft (27) at the points indicated by the said profiles in the layout and positioning template (12), as observed in detail in FIG. 28, in which a worker secures the said U-shaped stop parts (28) to the foundation raft (27) using a manual percussion unit (29). The essential role of these U-shaped centring parts (28) is their function in determining the thicknesses of and distances between walls and partitions, irrespective of the material they are made from and the measurements they have, since these aspects are random and can be adapted to suit each specific constructional circumstance. Moreover, for securing the same to the foundation raft, all kinds of specific nails can be used, depending on the method of nailing and the hardness and other characteristics of the concrete used for construction of the foundation raft. However, and as already stated above, the system, continuing with the notion of independence from any aspect inherent in traditional construction and searching, at all times, to ensure complete mechanisation of the construction process, makes provision for a method that is, at the same time, simple and safe, consisting of the deployment of a manual percussion unit (29) which, at low cost, facilitates the securing of these U-shaped stop parts in the positions specified by the template on top of the foundation raft.

Operation of the said percussion unit is detailed in the sequence indicated by FIGS. 29, 30, 31 and 32. The manual percussion unit (29), which is specifically designed for use as a tool inherent in the mechanised and industrialised construction system covered by the invention, is fitted with a special handle (30) for gripping and securing the same, without risk, during subsequent operations, and has, in its central body (31), a rebate (32) for supporting the same on top of the profiles in the layout and positioning template (12), as can be seen in FIG. 33. In effect, a steel nail (33), with a centring washer (34), is inserted into the central body of the said percussion unit, which will cause the internal mechanism within the same (35) to move towards the top of the unit, as indicated by the arrows in FIG. 29, to remain, as shown in FIG. 30, with the nail inside the percussion unit and the mechanism moved up to the top of the same. Then, as shown in FIG. 31, the manual percussion unit, in the same position as in the previous figure, is placed in position on top of the U-shaped stop part (28) situated on the foundation raft (27) alongside the corresponding dimensioning plate on the layout and positioning template (12), and is struck with a mallet (36) on the upper part of the percussion unit, causing the internal mechanism (35) to return to its initial position, thereby driving the nail (33) that is housed inside into the foundation raft (27) in a straight and clean manner, with the help of the special centring washer (34) that is attached to the said nail (33). Once the internal mechanism of the percussion unit (35) has returned to its initial position, from the effects of the blow from the mallet on the upper part of the unit, the steel nail is inserted into the foundation raft, securing the U-shaped stop part to the latter, as depicted in FIG. 32. This securing operation will be repeated in each orifice that has been made in the said U-shaped parts.

Following on from the process of securing the said U-shaped stop parts, and after checking the correct location of all elements that make up the foundation raft, the layout and positioning template (12) will be definitively removed, along with the foundation formwork (1) that has formed the raft, with the simple removal of the self-centring clamps (8) that join together the modular parts (2 and 3) that make up the same. In this way, the foundation raft (27) is completed, as depicted in FIG. 34, and ready for proceeding with the following phase in the process, consisting of installing the wall template (37) and all its elements, which are detailed and explained below, and which will serve as the standard reference and measurement template for subsequent installation of the modular panels that will make up the mould assembly for the dwelling or some other construction. Two details of the excellent result of construction of the foundation raft can be seen in FIGS. 35 and 36, which show, by way of an example, respectively, a doorstep into the dwelling (38) formed using a specific frame (39), depicted above in FIG. 35, and a sanitation chamber (40), showing its entrance and seat for the cover, both obtained simultaneously in the foundation raft following concreting of the formwork, as depicted in the general perspective in FIG. 34.

Before explaining the basic refinements and the new assembly mechanisms conceived for wall templates, there is a description of a new system for producing foundation rafts for building on land with differences in levels.

Where there are pronounced differences in levels in the land on which building work is to be carried out, the high-precision industrialised and mechanised modular construction method covered by the present invention provides for a system of terraces which allows for making good the said differences in height quickly, simply and with the utmost precision. FIG. 37 shows, by way of an example, and in no way limitative, with regards to dimensions, thicknesses, forms or construction ideas, the formwork and fastenings system for being able to build on such differences in levels.

The system conceived for this type of terrace work, as illustrated in the said FIG. 37, consists, basically, of the positioning of modular panels (41), resting on the said ground where the difference in level exists, which are secured by means of special plates (42) to double securing angles (43), into the peripheral oblong orifices (7) of which are fitted simple brackets (44), with a built-in self-centring clamp, or others that are structurally reinforced (45), for securing the relevant alignment joists (46) on the upper part of the formwork (cf. FIGS. 39, 44 and 45). On the lower part of the same formwork, identical joists (46) are positioned on angle pieces with a support foot (47) secured, by means of self-centring screws (53), likewise to the double angles positioned all around the formwork. These lower alignment joists (46) are secured to the said foundation raft seated on the bottom part of the uneven land by means of a special screw with a dowel (48), which may later be removed following concreting of the raft (27) on the upper part of the terracing, and are adjusted by means of a round stop (49) embedded in the concrete of the raft. The double angles (43) indicated above serve, in turn, to ensure that the formwork stabilisers (9′), which are larger than the standard ones (9), secure the modular panels in the terrace formwork precisely and safely to the foundation raft in the area immediately below. Using this new system, the formwork is perfectly aligned and, after proceeding with concreting, produces a raft that is stable, flat, smooth and error-proof, thanks to this mechanised procedure.

All these new elements, as depicted in FIG. 37, within the formwork assembly for terraces with variable heights, are depicted in detail in the following figures, with a view to showing the operability and purpose of the same. This is a series of precision parts and elements, specially designed for mechanisation of the process of constructing foundation rafts on terraces quickly and economically and with full guarantees regarding safety and high precision.

In this way, FIGS. 38 and 39 depict the double securing angle (43) attached to the modular panel (41) which forms part of the said formwork for terraces. This angle (43) is attached to the said panel (41) by means of special reinforced plates (42), one of which is represented in FIG. 40, such angle being drilled on the periphery so that it can be attached with precision to any peripheral plate or panel reinforcement (41) with the help of a self-centring clamp (8), as represented in detail in FIG. 41.

FIG. 42 shows another of the parts that make up this special mechanised system for terraces. It consists of a support foot (47) drilled with oblong orifices (7) to facilitate attachment to the double angle (43) by means of the relevant self-centring screws (53), as shown in FIG. 43. One of the plates on this foot (470 is wider than the vertical drilled one and is placed in a horizontal position for supporting the lower alignment joist for the formwork which, in turn, is secured using special screws with a dowel (48), and is adjusted by means of round stops (49) which secure it and adjust it, at the correct distance in each case, so that alignment of the formwork is perfect on the lower part of the same, as could be seen in FIG. 37. Alignment of the top part of the formwork is achieved through the use of joists (46) which, in this case, rest on top of brackets (44) with a built-in self-centring clamp (8), as represented in FIG. 44, secured to the said double angle (43) via the peripheral oblong orifices (7) in the same, as indicated and depicted in FIG. 37, or else on structurally reinforced brackets (45), depicted in FIG. 45, secured to the double angle likewise via the oblong orifices (7) drilled in the same.

FIG. 46 shows the final result of the foundation raft obtained using this new formwork system for terraces with variable heights. This figure shows a raft that is perfectly flat, smooth and seated on the ground without there being any error or maladjustment in the same. This raft will include all the sanitary installations, millimetric indications for peripheral walls and partitions, the location of doors, windows and other elements necessary, depending on the type of construction that is subsequently to be built on the same, and always indicated by means of the layout and positioning template explained above in detail, for which reason at this point there is only an explanation of the new elements of the mechanised procedure for the construction of foundation rafts on terraces or differences in levels.

FIG. 47 depicts an alternative method for the construction of foundation rafts on terraces with specific not very pronounced heights. The basis is the same concept and a similar construction principle, the difference being certain elements which, in this case, facilitate installation of the formwork, as well as the final result of the raft, always following the principle of mechanisation of the process in the search for greater efficiency and better results. Therefore, on top of the standard foundation formwork (1), duly stabilised on the lowest part of the uneven land, modular panels (41) are positioned adjoining one another, joined together by means of self-centring screws (53) to a reinforcement angle (50) which acts as a joining element between the said panels (41) and the standard foundation formwork (1). These modular panels are, in turn, secured to the standard foundation formwork (1) situated on the upper part of the land, using, for such purposes, an external securing angle (51) and self-centring clamps (8). For anchorage of the complete formwork assembly, use is made of anchorages (11′), which are larger than the standard ones (11), which are secured and centred by means of a securing plate (52), represented in enlarged form in FIG. 49, which is provided with oblong orifices (7) for securing the same to the corresponding panel (41) by means of self-centring screws (53), and a centring orifice (54) for the anchorage (11′) to fit into. Installation of this plate (52) is depicted in detail in FIG. 48 and its purpose can be appreciated in the assembly in FIG. 47.

Once the foundation raft has been constructed, either on flat ground or else on terraces, using the new mechanised processes that are proof against human error proposed in the present patent as effective methods for the mechanisation, rationalisation and logical organisation of the construction sequence, the following phase in the construction system consists of assembly of the wall template. This template constitutes a key new development for the precise positioning of internal reticular reinforcements for the peripheral walls and internal partitions, as well as for making provision for electrical installations, doors and windows, including the position of internal stairways and other essential aspects that will be carried out in a simple, mechanically structured way, without the possibility of errors of any kind.

The wall template, as explained below, is based on the same principle as the layout and positioning template, affording operational differences and special features that are the product of its vertical position on top of the foundation raft, determining all the essential aspects of the walls and partitions in the dwelling or any other constructional concept that one wishes to implement. In the same way, the wall template is divided into different sections and it is also used as a precise element for measurement, which it indicates and makes provision for, to the millimetre, in respect of each and every one of the internal and external elements that will be included in the walls and partitions of the construction. Thanks to this device, it is possible to achieve great savings in time, lower costs and, in short, an industrialised construction, as a result, specifically, of foresight, planning and rational organisation of all operational aspects essential for the realisation of any constructional concept.

FIG. 50 illustrates the aforementioned new wall template (37), made up of various tubular elements, preferably of square section, transversally drilled with various circular orifices (7′) positioned at equal distances in respect of one another, which is located on top of the foundation raft (27) that has already been completed. This template is positioned on top of the said foundation raft, by fitting it to the U-shaped stop parts (28) that have previously been secured to the said raft, as indicated in FIG. 34, and which now serve for both aligning with total precision what will be the peripheral walls and partitions of the construction, and defining the exact thicknesses and positions of the same. Moreover, the said wall template, by means of its tubular elements, preferably of square section, determines the spaces envisaged for electrical boxes (55), outlets from drains and piping (56), as well as spaces for doors (57) and windows (58), delimiting and centring the same in the exact position which will correspond, with total precision, with the centring elements provided for in the mould panels that will subsequently be installed, and specifying to what point the wall reinforcements are to be positioned, so that the concrete covering for the same has the centimetres of thickness defined in current standards for any time or place, in addition to making provision, in the actual body of the wall template, for the position of the dwelling's internal stairway (59). The various tubular elements in the template, transversally drilled with circular orifices (7′), and manufactured from a lightweight material to facilitate, even further, their handling by workers, are also fitted with safety coupling elements (60) for the simple and safe attachment of their sections, through the use, once again, of self-centring clamps (8), as observed in this same FIG. 50 and in even greater detail in FIG. 51, which also shows the position of the assembled template fitted against the U-shaped stop parts (28) secured to the said raft (27) by means of steel nails (33). This method of attaching the tubular sections of the wall template in order to make up a single template suited to the needs of each construction allows for installation of the same in a practical, simple, fast and highly precise manner. That means that this phase of the construction process is carried out in an automatic, completely mechanised manner, without the need for manual measurements or continuous improvisations in order to remedy any errors that may arise, owing to the fact that, with this wall template, provision is made for all the necessary elements, without any possibility of error, for the subsequent installation of the mould and concreting of the same in successive phases in the construction sequence explained in the present invention.

Following assembly and positioning of the wall template (37) on top of the foundation raft (27), this being aligned by the bottom part of the U-shaped stop parts (28) to facilitate, subsequently, its rapid removal, a rationally organised procedure will be followed for assembly of the internal reticular reinforcements (20) for the peripheral walls and internal partitions of the dwelling, followed by peripheral insulation of the walls (61), all of this respecting the spaces set aside for doors, windows, outputs from electrical boxes and outlets from piping and drains. The end result of this assembly, guided at all times by the wall template (37), can be seen in general terms in FIG. 52, although, below, there is a step-by-step description of the construction sequence in this phase of the process and as an essential contribution to the field of industrialised modular construction, the main objective of the invention.

Thus, FIG. 53 shows a first step in installation of the wall elements such as the reticular reinforcements (20), which are positioned in such a way that neither vertically, nor horizontally, do they coincide with the transversal orifices (7′) in the elements in the wall template (37), since these orifices, which are preferably circular, serve to indicate the points where, subsequently, and following installation of the peripheral insulation for the walls (61) inserted with the reinforcement assembly so that it fits inside the same, the tapered wall separators will be inserted, which will determine the distance between the modular panels on either side which will, in turn, form the peripheral wall of the dwelling, as will be seen later on. Moreover, the reticular reinforcements, which will not, in any case, cross the spaces set aside for doors (57) and windows (58), will be reinforced at their corners by means of securing bars (62); nor will they cross the spaces marked out on the wall template for electrical boxes (55) and drains or piping outlets (56), as can be seen in general terms in FIG. 53 and in more detail in FIG. 54.

FIG. 55 shows the position of the wall template (37) and single reinforcements (20) in the area corresponding to the dwelling's internal partitions, which can be clearly distinguished from the double assembly of the peripheral reinforcements (20) corresponding to the external peripheral walls of the dwelling. The relevant insulation (61) is placed in position between the peripheral reinforcements.

FIG. 56 shows another step in the phase of installing the wall elements following indications on the template. The wall template (37) is positioned on top of the foundation raft (27), with the double peripheral reticular reinforcements (20) reinforced with securing bars (62) at the corners of windows and doors, and the wall insulation (61) inside the said reinforcements, with the relevant holes (63) made, the whole structure being secured and centred, to form a block, thanks to some permanent separators (64) which are explained later on. These holes in the wall insulation are made manually using a pointed boring tool (65), depicted in FIG. 57, and the procedure to be followed is simple, while being, at the same time, necessary and effective, since its practical function is essential for the subsequent phase in the construction sequence, which is to say, assembly of the mould. One or more workers will make the holes (63) in the insulation material (61) in the peripheral walls, using the boring tool (65), by inserting it into the transversal orifices (7′) in the wall template (37), as shown in FIG. 58, such orifices indicating, precisely, the exact points at which the holes are to be made. In this way, it is possible to determine, in the insulation (61), the orifices (63) through which the wall separators used for assembly of the panels that make up the mould are to pass, since the said orifices (7′) marked on the template (37) are positioned parallel and equidistant in respect of those in the modular panels. This initial task of marking out facilitates and guarantees that the separators that will determine the distances between the faces of the two wall panels on either side may be placed in position without any problem, without any errors or setbacks, since they will not come up against the reticular reinforcements (20) that form and reinforce the inside of the peripheral wall. In this way, it is possible to avoid human error resulting from miscalculation, since it can be ascertained, at each stage, that everything is correctly positioned. If, on the other hand, it should be ascertained that the manual boring tool (65), when boring through the insulation, comes up against the reticular reinforcements at any point, this fault could be remedied by bending or cutting, in the last case, the relevant reinforcements so that the rest of the process can continue without any setbacks. Consequently, everything is perfectly calculated and calibrated, and any minor maladjustments that may occur during the construction phases, may be resolved as and when they occur.

FIGS. 59 to 61 show, in addition to the position of the said reticular reinforcements (20) and the peripheral wall insulation (61), a new element, already represented in FIGS. 56 and 58, which consists of a permanent separator tie (64) which is used in varying numbers, for securing and keeping the said reticular reinforcements (20) centred, along with the aforesaid insulating material (61), in the peripheral walls.

FIG. 62 depicts the said metal separator tie (64) which has an L-shaped section, with equidistant recesses in one of its faces, like a comb, which allows for easy positioning and is enormously useful for the construction system covered by the present invention.

As can be clearly seen in FIG. 63, the separator tie (64), thanks to the way in which it can be curved around, using the appropriate pincers, manages to grip the horizontal and vertical reticular reinforcements (20), along with the insulation (61) inside the wall, thus preventing them from being moved off-centre or displaced, and secures them in a permanent manner during the whole subsequent process of assembly of the mould, remaining within the wall itself once concreting has taken place. It is precisely this curvature that is given to the said separator tie (64) that allows the same to touch only a minimal point on the mould for concreting the wall, and this means that, with the passage of time, rust marks produced by contact of the metallic separator with the air do not appear in the concrete wall, since, due to such curvature, the contact surface is minimal and the possible future signs of oxide unappreciable. Moreover, it should be pointed out that this part (64) is a highly resistant element which helps to withstand the pressure constraints exerted by the concrete against the mould during the concreting process and which allows the thicknesses of the walls created inside the mould, both of these being separated by the insulation, to be added together, making them more rigid and converting them into walls capable of withstanding loads.

FIG. 64 shows a variant of the permanent separator tie, with identical functions, but of a different design. It consists of a separator made up of two metal parts or plates (66), each of them ending in a point, and, in this case, with four semicircular recesses (67) which, when matched up, allow the horizontal reinforcements to pass through. Such parts or plates that make up the same are assembled using the relevant flanges (68) which are inserted via longitudinal slots (69) provided in the said plates and which, subsequently, are bent sideways, leaving both plates secured to one another, as can be seen in FIG. 65. FIG. 66 shows the said separator tie in place and performing its function. Its alternative use, instead of the previous separator, will depend on each specific case, as appropriate.

In the same way, FIG. 67 shows another variant of a permanent separator tie in the shape of a hairpin (70), made from a single piece, likewise metallic, with a circular cross-section, bent back on itself, which has four semi-circular recesses (71) in either arm of its structure, which, when bent over, match up, to form a complete circle, allowing the horizontal wall reinforcements to pass through the inside of each circle. The closure mechanism for this hairpin separator (70) consists of an open washer (72) which is closed by exerting pressure using suitable pincers (73), as can be seen in FIG. 68, the separator (70) thus being secured, as depicted in FIG. 69. Its purpose is identical to that of the two separator ties described above.

In FIG. 70, with the template now removed and with the reinforcements (20) and the insulation (61) perfectly positioned and centred, the electrical installation (74) is installed, the electrical boxes (75) then being positioned with a certain margin of flexibility to allow them to be centred, subsequently, at the points provided for in the said mould panels, when this is placed in position. It also shows how the water installation (76) is placed in position in what will be the peripheral walls of the dwelling, the piping being secured to the reinforcements in a suitable way to ensure that they do not impede the flow of concrete during the subsequent process of concreting the mould. The piping outlets (77) are left open on the outside, so that they can later be secured and perfectly positioned in the equidistant centring spaces with identical dimensions afforded by the said wall template, as provided for in the template for such purposes, so that all the installations envisaged remain in their exact position and at the required height. This same action is realised with any other type of installation that is defined beforehand in plans, such as those relating to telephony, fibre optics, or the like. It therefore demonstrates the progress that this implies in the field of construction and, more so, in modular construction, since it has direct repercussions on the time and effort spent, as well as on costs, reducing these enormously in all three cases and allowing for providing the system covered by the present invention, once again, with an organised, mechanised, rationalised and industrialised sequence.

The electrical installations (74) and those for water (76) can also be installed in internal partitions (78), where the reinforcements are simple and without insulation, as represented in FIG. 71.

FIG. 72 shows, schematically and as a whole, how the general installations look on the ground floor of the dwelling. The water installations and the electrical installations will be prepared individually for each dwelling prior to being transferred to site, so that, for installation, only the necessary connections and joints are realised, speeding up the task of installation, so that it can be carried out by a single worker in just a few hours, with total guarantees in terms of safety and with an excellent quality result. Thus, the process of placing in position, fitting and securing the general installations is completely mechanised, being converted into a task that is rationalised, organised and planned beforehand, in the relevant technical drawings for the plans to be implemented, searching, at all times, for industrialisation of the construction system put forward as a new development in the present invention patent.

Following the positioning, installation and securing of the said necessary installations to the reinforcements in the peripheral and internal walls of the dwelling, one proceeds to the following phase in the construction process: assembly of the mould, which gives form to the complete structure of the dwelling or any other type of construction that is to be built. This important phase in the construction sequence, presented in strict chronological order in the present description, has been substantially expanded and improved in respect of the previous patent for the same applicant. For this, a series of parts, tools and elements have been conceived, which afford a high level of mechanisation and technicality in the construction system covered by the invention.

The key parts for the preparation of a complete, integral and monolithic mould, which will serve to obtain the construction planned, are the system's specific modular panels. Their manufacture, in a wide range of sizes, forms and dimensions, allows for total versatility in the structures and architectural designs that one wishes to construct. Below, there is an explanation of a series of adjustable modular panels and parts of different dimensions which may, without doubt, be complemented by others of suitable dimensions and forms, specially designed and manufactured for meeting specific construction needs in certain projects. All of these panels, in general terms, afford the same principles and functions as explained in the previous patent No. P9401135 granted in respect of the same applicant, but include structural modifications and new modular parts which complement and increase the possibilities of the mould within the high-precision modular system described.

FIGS. 73 to 78 represent different types of modular panels (41) viewed from the rear and used in the new construction system covered by the invention, which make assembly of a modular structure with multiple possibilities feasible.

FIG. 73 depicts a rectangular modular panel with a flat outer surface and bent inwards at the periphery to form plates on its four respective sides, such plates being provided not only with oblong orifices (7), but with the new circular centring orifices or holes (79), realised with mathematical precision and positioned strategically all along the said plates. The basic function of the existence of these new circular orifices (79) is to facilitate alignment of the panels with one another, so that they are perfectly flush, thus making up for any difference in level in the land or any other circumstance that may lead to maladjustment, however small this may be, between the panels that make up the modular structure. With the said circular orifices (79), the centring function, which is essential in the high-precision system described, is perfectly resolved, thus avoiding differences in level on a millimetric scale. This results in a structure of the utmost precision, together with considerable sturdiness, thanks to the reinforcement battens (82) that the panels have on their internal face.

This basic panel shows a series of semi-circular recesses (80) distributed along its peripheral plates, so that, when panels are positioned against one another in the mould structure, to form a continuous unit, they form a circular orifice through which a new tapered wall separator can be positioned and firmly secured, as will be described later on. At the four corners that form the periphery of each basic panel, there are, again as a new development, recesses in the form of a quarter circle (81), which allow for the formation of a complete circle when four panels are placed in position adjoining and flush with one another.

FIG. 74 depicts a variant of the previous panel, which, in addition to improving its precision, due to its new structure, as explained above, shows a basic difference, consisting of making provision, on the inner surface, for reinforcement battens (82) drilled with oblong orifices (7). This results in a panel that is lighter, more manageable, more practical and more functional, essential aspects when one takes into account the fact that much of the handling will be realised directly by the erectors, who have to install and dismantle the same, move them, transfer them, etc. These holes do not affect the panel's sturdiness, since the holes are realised in the core of the respective batten in such a way that the sturdiness and durability of the panel are not affected. The reinforcement that these drilled battens represent is, consequently, essentially the same as that of solid battens, but, in turn, allows for achieving a lighter panel in terms of weight, an aspect of vital importance for assembly and handling of the same, and great sturdiness and durability, so that it can be re-used on hundreds of occasions without the panel suffering any deformation during the processes of assembly, concreting or dismantling.

FIG. 75 shows a panel with identical characteristics and advantages to that in FIG. 73, but with a minor difference in that it does not have the semi-circular recesses on the upper and lower peripheral plates of the panel. Its straight design, without recesses on the said plates, is an alternative that may be used depending on the construction idea to be implemented and when, for any functional or practical reason, this may require the same.

FIG. 76 is another direct variant of the panel depicted in FIG. 75, but, on this occasion, it combines the advantages already mentioned in FIG. 74 afforded by the fact that its reinforcement battens (82) are drilled with oblong orifices (7), such as its lightness in terms of weight, and the sturdiness and durability of the said modular panel.

FIGS. 77 and 78 are two variants of the panels in FIGS. 75 and 76 respectively, the only difference being their dimensions, since these panels are narrower, preferably having standardised measurements of 30 cm, compared with the 50 cm of the panels referred to above. These panels, and others that are manufactured with the necessary measurements for each specific case, will be used to complement the standardised modular panels described above, since their joint usage allows for the assembly of complete moulds of any form, dimensions and architecture for which provision has been made in the technical office.

FIG. 79 shows a new mitred modular panel (83), with a lateral plate bent inwards at an acute angle (84), whose main difference with the mitred panel specified in the previous patent granted in respect of the same applicant consists of the existence of the round centring orifices (79) distributed along the part's lateral plates, to facilitate an exact fit and its being perfectly flush with the other modular parts. Moreover, its lateral plate at an angle of 90° has, as do the other panels, semi-circular recesses (80) and quarter-circle recesses (81) at the corners of the said plate, for insertion of the tapered wall separators that will be described later on. This mitre, the angle of which may be produced with the slope required in each case, facilitates enormously the commencement of dismantling of the mould panels once concreting has taken place, and will be used for both walls and ceilings/roofs, as will be indicated in the phase corresponding to assembly and dismantling of the mould.

FIG. 80 is a variant of the mitred panel (83) represented in the previous figure, but with the outstanding characteristic of its greater lightness in terms of weight, thanks to the drilling of oblong orifices (7) in its reinforcement battens (82), as has been seen in other modular panels depicted in FIGS. 74, 76 and 78. The effect sought with these new mitred panels is identical to that specified for such panels: to lighten their weight in order to facilitate their handling and assembly by the corresponding workers, without eliminating an important degree of sturdiness that the said battens afford the panel, so that it does not yield during concreting and casting of the mould, due to the pressure exerted by the combination of concrete and steel used in the monolithic fabrication of the dwelling, commercial premises, boundary wall, or the like.

FIGS. 81 and 82 depict mitred panels (83) that are complementary to those in FIGS. 79 and 80 respectively, affording identical characteristics to these, with one lateral plate at right angles and the other having an external inclination at an obtuse angle (85) for fitting against the mitred panels that complement the same and which are depicted in FIGS. 79 and 80.

For producing forms on corners, the internal angles detailed in FIGS. 83 to 89 are used. The main new development in respect of those specified in the applicant's previous patent consists of the combined fixed structure of their lateral plates, which may be manufactured in any measurement, these being adapted to suit the specific needs of each construction. By way of an illustration, details are given below of some standardised models of internal angles for moulds.

FIG. 83 represents an internal angle (86) with internal angular reinforcements (87) that are lighter than the angles described in the applicant's previous patent, and with 90° joining plates (88), drilled with oblong orifices (7) and round centring holes (79), as well as having semi-circular recesses (80) and quarter-circle recesses (81) on the corners of the said right-angle plates. All of this in positions and with dimensions that are identical to those in the peripheral plates of the panels (41) and other modular parts indicated, so that the fit between parts is achieved without any play or error, with a high degree of precision and in a simple and mechanical way. FIG. 84 depicts the said angle in plan view, showing the right-angle plates (88) positioned on the upper and lower ends.

FIGS. 85 and 86 depict, in perspective and in plan view, respectively, another reinforced internal angle (86) similar to that in FIGS. 83 and 84, of this kind. The said angle (86) affords two main differences in respect of the angle depicted in the previous two figures, consisting of the presentation of different inclinations (89) at a variable angle on each of its two lateral plates, likewise drilled with oblong orifices (7) and round centring orifices (79), for a good fit between complementary modular parts, and the elimination, in this case, of the semi-circular recesses and quarter-circle recesses in both lateral plates, as not being necessary in practice, due to the role that this angle (86) has in the dismantling of walls and ceiling/roof sections of the mould, which will be described later on in its corresponding phase.

FIGS. 87 and 88 show, in perspective and in plan view, respectively, another type of internal square (86) resulting from the combination of the two previous squares, since it has one lateral plate for fitting at right-angles (88), with oblong orifices (7) and round centring ones (79) drilled in the same, and the other lateral plate inclined (89), drilled in identical manner to the previous one, but without the semi-circular or quarter-circle recesses that this has, since fitting of this element, with its complementary modular parts, does not require orifices for wall separators formed by the said recesses, as explained later on.

FIG. 89 is an external angle (90) with a variable angle, with oblong orifices (7) and round centring orifices (79) drilled in its two plates, affording, as a new development, triangular reinforcements (91) preferably at regular distances along the whole part, which makes it more resistant and longer lasting, so that it can be used on hundreds of occasions without suffering any deformation or any other maladjustment that will affect the industrialised construction that is being produced with this new system covered by the present invention. Its function is to join, on the outer part of the mould, the panels at the corners of the formwork, securing the same with great precision.

In addition to the refinements in the different panels for modular construction using the high-precision system covered by the present invention, different possibilities are jointly developed for the simple, mechanised and practical attachment of the said modular panels and parts that make up the mould as a whole. It is a matter of a series of clamps, clips and self-centring screws, all high-precision, which are used alternatively, depending on the functional needs of each construction to be realised.

Joining the modular panels is very simple and practical, since these are simply fitted together by securing the peripheral plates on some to those on others, using the equidistant holes in both. However, in the present patent, there is greater concentration on the achievement of high-precision joints without the possibility of errors in adjustment and levelling of the said mould panels, in order to produce a precise, simple and mechanised sequence. This key feature is based on two essential aspects: the new designs of self-centring clamps that are more functional and practical for every case, and the existence of the round centring holes, with a play of two hundredths in respect of the clamps, drilled all along the plates on the modular panels.

FIGS. 90 to 92 represent, in three views, one type of curved self-centring clamp (92) that forms a single part, which, when inserted as a joining element into the round centring holes (79) in the peripheral plates (93) of the mould panels (41), as shown in FIGS. 93 and 94, makes them flush and aligns them, due to the fact that such orifices (79) are strategically positioned at equal distances on each and every one of the profiles in the system's modular panels and parts, there also being the same number thereof in each plate length, together with the oblong orifices (7). Once the first self-centring clamp (92) has been placed in position in this way, joining two panels (41) via the round centring orifices (79) provided in their plates (93), the said adjoining panels (41) in the mould remain, as can be see in FIG. 94, perfectly aligned and flush and their fit ensures total precision for proceeding with assembly of the mould and ensures that the result of the construction, walls, partitions, ceilings/roofs and joints between the same, will, following concreting, afford a clean, smooth and perfect aspect in terms of structure, since they will not produce any join line that can break the uniformity of the surface. The remaining self-centring clamps (92) for joining the said panels (41) may be placed in position at random, as considered appropriate in each case, using the round centring orifices (79) or the oblong orifices (7) in the peripheral plates (93) on the panels (41), as indicated in FIG. 94, since the positioning of the first clamp in the round centring orifice (79) is what indicates and defines, from the first moment, the exact and perfect levelling of the adjoining panels fastened to one another thereby.

FIGS. 95 to 97 depict, likewise in three views, another type of self-centring clamp (94) with a sliding closure for joining the modular panels in an identical way to that explained above, as can also be seen in FIGS. 98 and 99. The positioning of the said self-centring clamp (94), through adjustment of its sliding element, joining two plates on the modular panels (41) via the round orifices (79) provided in the said plates (93), guarantees the exact alignment and flushing of the same, it being possible to continue, likewise, with the random positioning of the remaining self-centring clamps (94) of the same type, both in the oblong orifices (7) and in the remaining round centring orifices (79) provided all along the said plates.

FIGS. 100 to 102 show, again in three views, a third type of self-centring clamp (95) in the form of a clip and with flat tightening surfaces, for joining modular panels (41) and parts via their adjoining plates (93), and the fitting of which is observed in FIGS. 103 and 104. Such clamps (95) are also placed in position in the same way as the two clamps described above, a first self-centring clamp (95) joining the two plates (93) on two adjoining panels (41) via their identical and equidistant round centring orifices (79), and the remaining clamps at random in the round orifices (79) or oblong orifices (7), as can be seen in FIG. 105.

FIG. 106 depicts a new high-precision joining element that is different from the self-centring clamps described above. Indeed, this is a self-centring screw (96) used for securing the system's standard panels or other modular parts with high precision, to form assemblies with larger dimensions that can be permanently handled as homogeneous blocks during the construction process, facilitating their installation and removal and contributing to perfect assembly of the whole mould, in a simple, fast, mechanised and error-proof manner. The said screw has a locking system that uses a nut (97) which allows for perfect centring and a high-precision fit between the plates on the system's modular panels, with tolerances of less than two-hundredths of a millimetre, which is the difference in size between the self-centring screw (96) and the round centring orifice (79) into which it is inserted.

FIGS. 107 and 108 show the method of positioning this self-centring screw (96), together with its adjustment nut (97), in these round centring orifices (79), so that levelling of the panels (41) to be assembled as a whole affords great precision, an aspect of great importance for continuing with the sequential chain of the construction process carried out using this new modular construction system.

Continuing with assembly of the mould, there is an explanation, below, of the two different models of tapered wall separators conceived for this construction system, which, when positioned in the corresponding points in the said mould, determine and define the distances between the equidistant panels on either side that will make up the walls, and will also indicate the thicknesses of the same.

The first model of tapered wall separator (98) is depicted in FIG. 109, together with its corresponding clip or locking retainer (99) in FIG. 110. The assembly formed by the said separator (98) and its locking clip (99) was described in the previous invention patent granted in respect of the same applicant, but in the present invention, it has a different design, which makes it a more practical and functional element. The said tapered separator (98) consists of a stem with a slight taper preceded by a double handle (100), which makes it more manageable for insertion and removal from the wall panels, and also has a double tapered head (101), in the second throat of which the attached locking clip (99) will be secured, during the process of assembly of the mould, in the position indicated in FIGS. 111 and 112. In these figures, it can be seen that the tapered wall separator (98) passes through the mould, being inserted into the circular orifices formed by the semi-circular recesses (80) and quarter-circle recesses (81) provided for such purposes and resulting from assembly of the structure's modular panels (41). In this way, the tapered wall separators (98) will allow for keeping the parallel panels that form the walls on either side equidistant from one another, at a pre-determined, fixed and unvarying distance, so that the structure cast inside the mould will be of millimetric precision and ensuring that the panels will not suffer any movement or maladjustment due to the pressures of the casting material during its solidification process inside the mould. These separators, as can be observed in FIG. 111, will not come up against the reticular reinforcement bars (20) positioned inside the mould (102) for walls, since their strategic positioning and securing, determined at the time and as explained above by the wall template (37) (not visible in the figures), leaves these spaces free for the insertion and securing of the said tapered wall separators (98).

FIG. 113 shows a second model of tapered wall separator (103), conceived for the system covered by the present invention. The said separator (103) comprises a tapered stem (104) which ends in a threaded point (105) at one end, having, at the other end, a circular head (106) fitted with an adjustment stop (107) for the panel (41), to the head of which a double handle with asymmetrical ends (108) is secured, for simple handling and insertion of the said separator (103) in its correct position in the mould. Once the separator (103) has been placed in position, as shown in FIGS. 115 and 116, it is secured by means of its corresponding threaded washer (109), as represented in FIG. 114.

This second type of separator (103), as shown in FIGS. 115 and 116, is placed in position in the same way as that explained above (98) and represented in FIG. 109, and its function is identical. However, its threaded point (105) and its retaining locking washer (109) facilitate its insertion into the mould even further and consequently speed up the construction process, since they allow for the traction of parallel and equidistant modular panels that form the wall to the exact point for fitting and securing of the same, using the thread on the washer, even when, for any reason, the said panels are at a greater distance than envisaged and in some way make it difficult to use the type of fastening facilitated by the first model of tapered wall separator (98), by means of the clip or simple locking retainer (99).

In this way, and as explained up until this point in the orderly, mechanised, rationalised, and, in short, industrialised construction sequence of the refinements to the system covered by the present invention, each and every one of the construction phases is of great importance on its own and, especially, in respect of the rest of the construction sequence, since the work, divided up into simple, mechanised, systematic and rationalised parts, calls for overall coordination between the different aspects of construction, so that the result is as envisaged and is achieved with total efficiency.

In the mould assembly phase, the importance of the positioning, securing and fitting of the various modular panels and parts is of prime importance, and therefore the parts and elements used for joining the same, as designed in the system for specifically fulfilling these tasks, are presented and described in detail. With all of these parts, a complete mould is assembled, made up of modular panels that are reinforced on their external faces and completely smooth on their internal faces, parallel with those on the other side and separated and pre-secured, in such a way that, inside the same, they form spaces of specific measurements, thicknesses, forms and other characteristics, duly reinforced and insulated, as applicable, which will subsequently be filled with a casting material that will form a high-precision integral and monolithic structure of total structural and architectural quality. For this, the refinements in the system covered by the present invention constitute a whole series of specific and exclusive tools and implements for the same, which facilitate and speed up the assembly process and subsequent dismantling of the mould, contributing enormously to the industrialisation of the system, which is complemented by its own devices which mechanise each and every one of the sequential phases of construction.

The main tools conceived for manipulation of the modular panels are the three depicted in FIGS. 117 to 119.

FIG. 117 shows one of these tools: the centring hook (110), consisting of an elongated bar which has a flat end (111) with grooves (112), and the other end rounded and ending in a point (113), the said ends being designed for performing specific functions which will be explained later on.

FIG. 118 shows, in two positions, another of these tools: a multi-use lever (114). This multi-use lever, consisting of a bar of sufficient length, has two completely different and complex ends, which make this multi-purpose facility possible for the process of assembling and dismantling the mould panels, as explained below. One of its ends has a structure formed mainly of a lateral round pivot (115), a small step or difference in level for support (116), a recess with a sloping wall (117) inside the same and round stops at the rear (118). The other end is formed by an expansion provided with a straight recess (119) that is wider than the one described above, and by two rear pivots (120), and, close to this expansion, a rear lug (121) which will constitute a support point at the time of deployment.

FIG. 119 shows yet another tool, consisting of a bar of suitable length which acts as a mould lever (122), with one of its ends mitred (123) and with a central recess (124), whereas the other end also ends in another mitre (123), similar to the previous one, but facing in the opposite direction and which, in addition to the central recess (124), has two round pivots (125) positioned as protrusions on the sides of the same.

These last three tools explained, perfectly conceived and designed, afford, in themselves, a multi-purpose facility that converts them into versatile implements that can be deployed for different situations, as explained below.

FIG. 120 shows a first function of the centring hook (110) using its flat end (111), which is used for vertically levelling, heightwise, two adjoining modular panels (41) in the formwork mould assembly, acting, as can be clearly seen, on the orifices in the panel plates.

As represented in the sequence made up of FIGS. 121 to 123, through the vertical manual movement of this flat end (111), and due to the existence of the grooves (112) which act as a non-slip element, this tool (110), when acting upon the orifices in the plates on the two adjoining panels (41), allows these to move vertically a sufficient distance to ensure that the respective oblong orifices (7) and round centring orifices (79) in the lateral peripheral plates (93) on the said panels are perfectly matched and aligned. In this way, positioning of the self-centring clamps (92), in any of their variants, is realised easily and allows for perfect alignment as well as joining the panels (41) which make up the whole mould with such a high degree of precision that it guarantees a subsequent concreting that is clean and without maladjustments.

FIG. 124 shows a second way of using the same centring hook (110), but on this occasion, using its rounded end that ends in a point (113), which serves to horizontally level adjoining modular panels (41) in the formwork mould assembly. Use of this end (113) on the orifices in the plates, in the case of horizontal manual alignment of the panels (41), is due to the fact that it is more practical and better suited for spaces where manipulation of the panels is more difficult due to the shorter distance between the peripheral plates (93) and the reinforcement battens (82) on the panel (41).

As shown in the sequence consisting of FIGS. 125 to 127, the said horizontal manual movement of this end (113) allows two adjoining panels to be moved horizontally until their oblong (7) and round (79) orifices or holes are perfectly matched and aligned and, subsequently, a self-centring clamp (95), in any of its variants, can be placed in position, joining two of the round centring orifices (79) with a view to the alignment, adjustment and securing of the modular panels (41) being exact and to allow for continuing with the rest of the mould assembly and other successive phases, without any faults of any kind.

FIGS. 128 to 130 detail, in sequence form, one of the multiple functions of the multi-use lever (114), previously presented in FIG. 118. The first use of the said multi-use lever (114) consists of joining two lateral peripheral plates (93) on horizontally adjoining modular panels (41) in the mould assembly, which, for various reasons, may have been left slightly separated and therefore do not allow for the direct positioning of a self-centring clamp (92), in any of its variants. Its use as an alternative to the centring hook will depend on the greater or lesser effort to be exerted in order to adjust and align the said panels, the multi-use lever (114) being a more robust, sturdy and, consequently, more suitable tool for this task in certain cases. As shown by the said sequence of drawings, when one of the double rear pivots (120) on one of the ends of the lever (114) is inserted into one of the oblong orifices (7) in the lateral plate (93) on the panel (41) in question, and then pulled, applying pressure on the plate on the adjoining panel with the support lug (121) on the rear of the lever, this causes the said panel to yield in terms of its position and move closer to and abut against the adjoining panel, both plates (93) fitting together in such a way that it is then possible to insert the self-centring clamp (92), in any of its variants, leaving the panels perfectly secured, aligned and millimetrically adjusted within the mould assembly. This is a function to correct any error or maladjustment that may occur during the process of assembling the mould and which may delay or in some way jeopardise the construction sequence chain that is organised in a rational, mechanised and systematised manner.

FIG. 131 again shows the multi-use lever (114) carrying out the same function as has just been explained, but on this occasion joining two vertically adjoining panels (41) via their lower and upper plates, respectively. The operation that the multi-use lever has to realise is identical and its purpose is, again, to align, make flush millimetrically and secure both modular panels (41) in a precise way, when this requires exerting a greater effort, which cannot be achieved with the centring hook.

FIGS. 132 and 133 show another of the uses of the aforesaid multi-use lever (114), which consists of the possibility of pulling on the tapered wall separator (98), which is inserted into the orifice formed by the semi-circular recesses (80), with a view to being able to insert, at this point, the relevant locking clip (99) in the correct position, that is to say, behind the second tapered head (101) on the separator (98), when, for various reasons, this action is made difficult by the fact that the said separator does not protrude sufficiently from the modular panels (41). The said operation has been drawn in detail in the sequence made up of FIGS. 134 to 136, with a view to explaining, with greater clarity, this function of the multi-use lever. In the said sequence, it can be observed how the locking clip (99) is fitted on the first neck of the separator (98), between the two tapered heads (101) on the same, and then the wide recess (119) on the multi-use lever (114) is placed in position on this first neck, to pull on the said separator. In order to exert the necessary pressure, use will be made of the solid rear lug (121) on the lever which, resting on the edges of the adjoining plates (93) on the panels in question, will act as a point of support for the lever and will facilitate the task in order to pull the separator out a sufficient amount so that the corresponding clip (99) can be transferred to its definitive position, which is to say, the second neck on the tapered wall separator (98), and can be locked and define, precisely, the distance envisaged between the modular panels on either side, so as to determine the thickness of the wall that will later be cast inside the same (102).

FIG. 137 indicates how the multi-use lever (114) can also be used as a tool for positioning and removing the standard self-centring clamps (8) used for joining the panels (41) that make up the mould assembly. For this, the wide recess (119) in the lever is placed in position over the profile of the clamp, and, with a small upward and downward manual movement, and with a certain twist, the clamp will come out from its position, leaving the panels in question unattached. This same movement, but realised in the opposite direction, will position the clamp (8) in place in the preceding mould assembly process, joining two panels (41) via their adjoining plates (93) by means of the oblong (7) or round centring orifices (79) provided for such purposes.

FIGS. 138 to 140 represent, graphically, a sequence in the last relevant function of the multi-use lever (114), consisting of unlocking and separating the adjoining plates (93) on two modular panels (41) in the mould assembly, once the self-centring clamps used for joining them together have been removed, and following concreting of the mould and the subsequent setting thereof. For this, and in the position indicated schematically in FIG. 141, the lever is placed in position by inserting the lateral round pivot (115) into one of the orifices (7) in the plate (93) on the panel (41), the other plate on the adjoining panel being supported by the small step (116) that the lever has on this same end. Once in this position, and as detailed in the said sequence illustrated by FIGS. 138 to 140, the lever is manually moved downwards, causing the panel (41) held in place by the plate (93), thanks to the pivot (115), to move forwards as a result of the effort, until it comes up against the sloping wall (117) that the lever (114) has at the centre of its recess (119), and which can be seen more clearly in FIG. 118. Then, the other panel (41), which was attached to the same, moves in the opposite direction, that is to say, backwards, until it comes up against the round stop (118) on the rear part of that end of the lever. Thus, unlocking of the panels is achieved, and they can be removed from the high-precision formwork assembly without suffering any deformation and without damaging the structure that has set inside the same.

There follows a description of use of another of the tools designed for facilitating assembly and dismantling of the mould in a mechanised manner and making provision for concrete solutions for specific problems, so that the rhythm of the construction sequence is not interrupted and the whole process can be realised in an organised, coordinated, rationalised, mechanised and industrialised way. This tool, likewise versatile, is the mould lever (122) as represented in FIG. 119, which performs different functions of great importance.

Indeed, FIG. 142 depicts one of the uses of the mould lever (122), which consists of facilitating the joining of two adjoining modular panels (41) in the mould assembly which, for different reasons, may have remained too far apart and, therefore, at a greater distance than envisaged, preventing the insertion of a self-centring clamp, in any of its variants, that will secure the same with great precision within the mould assembly. This action, which can also be realised with the multi-use lever, is carried out using the mould lever (122) when it is necessary to exert even greater effort at the time of joining the panels, since the structure and dimensions of the said mould lever (122) allows for this. For such purposes, after positioning and supporting one of the protruding lateral round pivots (125) on one of the mitred heads (123) on the mould lever (122) on the bottom right-angle corner (126), formed by the peripheral plate (93) on the panel (41) and its reinforcement batten (82), the other lateral round pivot (125) on the same end of the lever is attached to the upper corner (127) of the adjoining panel, which also forms a right angle in the same way. Thus, simply by manually turning the lever (122) upwards, as shown in the drawing, it is possible to exert the necessary effort for the panels to move and be sufficiently close to one another for them to be joined together using the relevant self-centring clamps, in any of their alternatives, in such a way that they are perfectly aligned, flush and secured with total precision.

FIG. 143 shows how the mould lever (122) also allows the movement, abutment and levelling of a set of panels (41) which, for different reasons, have been left separated from one another at a greater distance than envisaged, thus making it difficult to bring the same up against one other, in order, subsequently, to insert the self-centring clamps that will secure them in the mould assembly. To remedy this minor maladjustment, use is made of the same mould lever (122), using the same end as referred to in the preceding figure and placed in position in an identical way, so that the support points for the protruding lateral pivots (125) are the four adjoining corners on the panels to be joined together, and, by manually turning the lever downwards, as shown in the drawing, the necessary effort is exerted to ensure that the four panels (41) to be levelled yield in their positions in the different directions marked by the arrows on the same drawing and are left sufficiently close to one another to be able to secure the same using the corresponding clamps.

FIGS. 144 and 145 show another way of using the mould lever (122), consisting of manually pulling on the tapered wall separator (98) in order to be able to position the relevant locking clip (99), determining the exact distance between modular panels (41) on opposite sides which form the walls or partitions, when, for different reasons, this action is made difficult, owing to the fact that the separator does not protrude sufficiently from the modular panels. This action can also be realised using the multi-use lever (114), as has been indicated above in FIGS. 132 to 136, but the difference that exists between the two tools, at the time of realising the said task, lies in the fact that the multi-use lever (114) exerts much less effort than the mould lever (122), due to its different dimensions and design characteristics. Therefore, the mould lever (122) will be used, for preference, in cases where it is necessary to exert a greater effort in order to pull on the tapered wall separator (98) with a view to locking the same by means of its corresponding clip (99), thus determining the exact distance between the parallel modular panels (41) on either side, that make up the mould or form the cavity inside which the walls or partitions are to be cast.

Moreover, and as graphically represented in FIGS. 146 and 147, this lever (122) is also used for this same function, using the end that has two protruding lateral pivots (125). The said end is used, for preference, in confined spaces affording little possibility of manoeuvring, due to the greater suitability of the position of the lever for gripping and pulling on the wall separator, which is placed in its central recess (124), so that the locking clip (99) can then be placed in its corresponding position.

As a last noteworthy use of the said lever mould (122), there is that of serving, precisely, as a lever for raising the modular panels (41) and facilitating their removal when the situation so requires. With the mould lever (122), this action can be carried out using either of the two mitred ends (123). FIG. 148 shows how the mould lever (122) realises the said function using the simple head end, which is the one most widely used for this. Once the said head is supported on the foundation raft (27), the base for the construction, the flatter part of the same is inserted under the panel or assembly of panels (41), once the self-centring clamps used for joining the same have been removed, following setting of the concrete within the mould, and an effort is manually exerted downwards on the other end of the lever, so that the panel is lifted up and can be removed without any further difficulty. In FIG. 149, the mould lever (122) performs the same function, but using the other end, which is to say, the end with protruding lateral round pivots (125), used in confined spaces and where there is little possibility of manoeuvring, such as, for example, when, in front of the wall made up of modular panels (41) on which the lever is to be used, there is another wall at so close a distance that it is impossible to place the lever (122) in the other position.

In addition to these three tools explained above, the centring hook (110), multi-use lever (114) and the mould lever (122), which are used specifically for assembly and dismantling of the panels that make up the mould, a complementary range of implements and elements have been designed, likewise, for contributing rationally to the mechanised construction sequence involving the refinements to the construction system covered by the invention. These are tools and mechanisms that facilitate the transferral, securing and assembly and dismantling of the mould, as well as the continued re-use of the modular panels that make up the same and other adjustment parts used in the system.

Thus, FIG. 150 shows workers scraping and cleaning the modular panels (41) that have recently been used on site. For this, they use the implements that have been conceived and which speed up the procedure, contributing enormously to proper maintenance of the mould panels for their re-use on hundreds of occasions and always under optimum conditions of use. The modular panel (41) or assembly of the same is supported on two common joists (128) and is scraped using the long-handled manual scraper (129), which may be used either using the flat blade end (130) or else its tapered end that ends in a point (131), which is more suitable for removing hard and very dry residue from both the front (133) and rear (132) face of the panel (41). In this way, remains of concrete or any material that may have been left attached to both faces of the panel, as well as the peripheral plates (93) of the same, are removed. To remove the said residue, and for correct cleaning of the panels, a mould or form removal liquid (135) is applied using a wide brush (134), in a fine, evenly spread coat, which will enormously facilitate this task, so that it can be carried out without effort and quickly. This form removal liquid (135) will be contained in a trough (136), which has an opening with suitable characteristics for this task. Indeed, the said opening has peripheral flanges (137) which slope inwards into the said trough, as can be seen in FIGS. 151 and 152, which allow the form removal liquid (135) that runs off the brush (134) to drain back into the trough (136), the said product thus being utilised to the full, and saving time in the process, since the intervals between filling the same will be longer. This is an additional point for industrialisation of the same, since this phase too, however simple it may appear, has direct repercussions on the general construction sequence, which has all its phases arranged logically and rationally, with a view to achieving, in general, the utmost efficiency.

For speeding up the sequence of assembly, dismantling and general handling of the modular panels, especially in high sections of walls and in ceilings/roofs, FIGS. 153 to 155 represent a very practical and easy-to-use device which facilitates the said tasks, guaranteeing the safety of workers and efficiency of the work. Such device consists of a lifting trolley or hoisting trolley (138), of amended design and with improved and simplified handling. For easy transportation on site to the point where it is required for performing its function of positioning and removing the modular panels (41) or assembly thereof, in the upper sections of walls or in ceilings/roofs, the lifting trolley (136) is fitted with wheels (139) at the front and two support legs (140) at the rear, and will be moved by gripping it by means of two rear handles (141) provided for such purposes. The said lifting trolley (138) may be used for both positioning the modular panels (41) that make up the vertical section of the walls, as shown in FIG. 156, and for assembling ceiling/roof panels, whether horizontal or sloping, as is the case shown in FIG. 157, since, for such purposes, it has a tilting support (142), in the form of a mesh frame, on to which the panels (41) are secured in a completely safe manner using hitches (143) specifically designed for such purposes, it being possible for such panels to adopt any angle of inclination, always depending on the needs of each case.

The said lifting trolley (138) is variable in height, this being regulated by means of a lateral crank (144) which causes the two telescopic elements (145) housed inside the fixed element (146) (situated on the bottom part) to extend, by means of a pulley mechanism (144′), with two safety cables (147). This trolley facilitates access to the higher parts of the construction in order to carry out the task of positioning and removing modular panels, thereby contributing to assembly and dismantling of the mould and constituting a fully mechanised activity, without setbacks which could delay the rhythm of the construction sequence. Another advantage of the lifting trolley (138) is its great stability, since its structure incorporates battens (148) which serve as steps, and two platforms (149) which, in addition to reinforcing the said structure, are used as an alternative set of steps so that the worker can climb up and manipulate a modular panel (41) or assembly of the same, securing this to others, by means of the relevant self-centring clamps, within the high-precision mould assembly that is being installed, or else proceeding to remove the same.

FIG. 153 represents a lifting trolley (138) of the type described, in its initial or retracted position. The extendible telescopic elements (145) are contained in the fixed element (146), whereas the tilting support (142) with hitches (143) for the panels (41) is in the vertical position, ready for positioning the panel or assembly of relevant panels that will subsequently be lifted.

FIG. 154 depicts the lifting trolley (138) with one of the telescopic elements (145) extended upwards above the fixed element (146), thanks to the aforementioned system of pulleys (144′). In this way, a midway height is achieved, where the worker, climbing to the first platform (149), will manually tilt the support (142) on to which the panel (41) or assembly of the same is attached, positioning the same and securing it in the definitive position the same will have in the mould assembly that is being assembled, so that, subsequently, as depicted in FIG. 155, the second element can continue to be extended, by means of activating the lateral crank (144), until the desired height is reached.

The said lifting trolley is therefore a very complete device that speeds up the process of assembling and dismantling the mould in high areas and ceiling/roofs of the same, with a view to providing the system, once again, with that industrial nature that stems from each and every one of the elements created, as well as the different phases, which afford this sense of totally new mechanisation, rationalisation and organisation in the new high-precision construction system covered by this invention. FIGS. 156 and 157 show operations involving the lifting trolley, as indicated above.

Another ancillary element conceived for the said system covered by the invention consists of a triangular support (150) for crane use, as represented in FIG. 158, which is designed to allow and facilitate the movement and transferral of a large-sized assembly of modular panels (41) or external parts of the mould, which have been secured beforehand with total precision, with a view to transferring these or placing them in the corresponding position.

FIG. 159 shows, in detail, a hitching device (151), which forms part of the said triangular support (150), and which is made up of two identical U-shaped parts attached to one another at one point, leaving the four ends of the U-shaped parts separated, so that they create a double space between the same, both at the front and at the side of the part, forming a double recess (152), these spaces allowing for the insertion and securing of the peripheral plates (93) on the adjoining modular panels (41) with complete ease, as explained below.

The method of securing the panels is simple and allows, as shown in FIGS. 160 and 161, respectively, for realisation in two different positions, depending on the needs of each case and depending on how the said hitch (151) is installed. On the one hand, it allows for simply gripping panels (41), by means of the peripheral plates on two adjoining panels of the assembly, using, for such purposes, one of the recesses (152) in the said hitch (151), and, on the other, it allows for gripping an assembly of panels (41) with greater safety, by gripping these at the four adjoining corners formed by the peripheral plates (93) on the said panels (41), using, for such purposes, the double recess (152) in the form of a cross that the hitch has for such purposes. These hitching devices (151), which have the said double recess (152), are held in place by means of security pins (153), which pass through the corresponding round centring orifices (79) in the peripheral plates (93) of the panels (41) that form part of the mould assembly that is to be moved, and, in turn, are joined by means of a ring (155), inserted into a large orifice (156) formed in the hitch itself (151), to the respective chains (154) which are suspended from the triangular support (150) which hangs from the crane (not shown) which is what, logically, provides the movement for transferral. The said orifice (156) that the aforementioned hitch (151) has is of a large diameter, with a view to leaving sufficient play so that the ring (155) and the chains (154) can have the necessary mobility for being able to attach the hitch itself (151) in either of its two positions, without any difficulty.

FIG. 160 shows one of the positions of the said hitching device (151), which is placed in position joining two lateral plates (93) on adjoining panels (41) which form part of the panel assembly to be transferred as a block by means of the relevant crane. It is possible to observe the use of one of the recesses (152) for simple gripping of the assembly of panels by gripping two plates (93) on adjoining panels (41), as has been explained.

FIG. 161 shows that, by turning the said hitch (151), it is possible to grip, with total safety, an assembly of adjoining panels (41), by gripping the four adjoining corners formed by the corresponding peripheral plates (93) on the same. This change in position is possible thanks to the hitch configuration explained which, with its double recess (152), forming a cross, allows, with a simple turn through 90° facilitated by the central ring, versatility in the use thereof. Once positioned in either of these two positions, as applicable, it is secured by means of the security pins (153), as has been explained above and as can be observed in the said FIGS. 160 and 161.

FIG. 162 shows, graphically, the way in which the triangular support (150), with two hitches (151) is used for transferring a large area of modular panels (41) assembled in respect of one another, speeding up the sequence of assembling walls and thus achieving a greater yield in construction.

Another new element conceived for this invention is that depicted in FIGS. 163 to 165, consisting of a separator mechanism (157) for doors or spaces. This element is used for defining and ensuring that the spaces or gaps at the bottom of the doors within the mould have identical measurements to the spaces at the top of the same, and that there is no maladjustment or error which could, directly and subsequently, have repercussions on the rest of the construction sequence in its different phases, all based on the rational organisation, mechanisation and industrialisation of the construction sequence, as well as the refinements described in the system covered by the invention. The separator for doors or spaces (157) has a central spindle (158) fitted with two adjustment stops (159), which allows for establishing the intermediate measurement in question in each case, for the doors, by extending or contracting its moving telescopic element (160) inside or outside the fixed element (161) in the same, by manipulating, for such purposes, the said spindle (158), which allows for setting and maintaining, with total precision, the exact distance between the panels which will determine the space for the door, all of this without having to use any ancillary measurement element and in a mechanised and safe way.

As shown in FIG. 165, this separator (157) is secured to the mould by means of self-centring clamps (8), in any of their variants, using the oblong orifices (7) provided in its respective rectangular and flat end plates for securing purposes (162), which are attached to the corresponding orifices in the peripheral plates (93) on either side of the mould panels (41) that form the space for the said doors. This type of space separator (157) affords great rigidity against twisting, so that the pressures of the casting material subsequently poured into the inside of the mould do not deform them or displace them, and so the panels are maintained in perfect conditions with regards to alignment and their being flush with one another. Moreover, with the separator (157) described, it is not necessary to realise any kind of measurement in the said spaces, since the separators themselves (157) make provision for the different dimensions of the doors, avoiding any human error or off-centring of the wall panels adjoining the same.

For assembly and dismantling of the mould without effort, the present invention moreover develops a whole series of elements and specific parts that will mean that operation of the mould in terms of assembly and dismantling of the formwork for the same is planned from start to finish and makes provision for all the basic details so that the assembly and dismantling process, as well as the final result of the construction, are as planned and can be achieved in the shortest possible time and with full guarantees with regards to safety, durability, adaptation to suit standards in force on site and with the greatest efficiency possible.

Essential elements for better utilisation and performance of the mould as a whole are the mitred panels, already described above in FIGS. 79 to 82, and their complementary internal angles referred to in FIGS. 83 to 88, all of these being parts that facilitate and speed up the process of assembling and dismantling the modular formwork, guaranteeing the maximum yield in the process and results that meet expectations, since, thanks to these mitred panels and angles, the structure cast inside the mould will not suffer any damage at the time of its removal.

FIG. 166 clearly represents, in a cross-section perspective view, the position of the mitred panels (83) in both the walls (163), the method of installation for which, in a specific example, is detailed schematically, moreover, in FIG. 167, and in the ceiling/roof areas (164), and the position of the internal angles (86), with one of the plates inclined for attaching to other mitred modular panels (83) which have one of their plates inclined (89) at a complementary angle to that of the inclined plate on the said internal angle (86). The mitred panels (83) and the internal angles (86), with one of their plates inclined to form a mitre in this case, are essential for ensuring that removal of the mould formwork can be realised easily, mechanically and without problems, as explained below. Once the mould has been concreted and all the attachment and separation elements, such as self-centring clamps or tapered wall separators, for example, have been removed, removal of the formwork from the same can be realised effectively and without effort, thanks to the use of the said mitred parts. The mitred panels (83) are always removed first, since, thanks to their angled joints at different degrees of inclination with the internal angles (86), they totally eliminate the tension and pressure existing between the modular panels (41) that make up the mould assembly, caused by casting of the concrete or analogous material inside the same. Therefore, removal of these mitred panels (83) from both ceilings/roofs and walls and, consequently, of the other modular panels (41) and mould securing parts, may be realised manually without effort and without the use of levers or other implements that slow the form removal process down and may, at the same time, damage the said panels, limiting their lifetime and usefulness, and producing deformations in them that would cause them to lose their basic quality, which is one of high precision.

FIG. 168 is a cross-section perspective view of the upper part of the mould represented above in FIG. 166, prior to concreting. It shows the specific position of the said mitred panels (83), and the location of the internal angles (86), on the internal corners where the walls (163) meet the ceiling/roof (164), with one of their right-angled lateral plates (88) for attaching to other modular panels (41), and the other plate (89), with a mitred angle at specific degrees of inclination, so that they facilitate and allow for the subsequent dismantling of the mould without the modular panels that make up the same being forced or damaged, and without the concreted structure itself suffering any damage during removal of the said mould. Using this internal angle (86) of the type indicated on each of the corners where the wall (163) meets the ceiling/roof (164), and two complementary mitred panels (83) in the central area of the ceiling/roof (164), removal of the mould, once it has been concreted, is carried out without any kind of problem, since each of the parts and panels is extracted with great ease, always following a logical order for their removal, as indicated schematically in FIG. 169.

Indeed, FIG. 169 shows, schematically, the orderly way of removing the mitred panels (83), the internal angles (86) with one of their attachment plates (89) inclined at a complementary angle to that of the plate on the mitred panel (83) to which they are attached, and the other modular panels (41) that make up the whole mould represented. First of all, and without distinction, the right and left mitred panels (83) belonging to the formwork for the wall (163), which are situated adjoining the internal angles (86) on the corners, used for joining the walls (163) and the ceiling/roof (164), are removed. The said mitred panels (83) will come away from the mould assembly without any problems, thanks to the inclinations on one of their plate (89) being at a complementary angle to the inclined plates on the adjoining internal angles (86). Removal of the said mitred panels (83), once the mould has been concreted in integral and monolithic manner, allows for continuing with removal of the formwork, without major problems, for the rest of the adjoining modular panels (41) belonging to the vertical section of the wall (163). Secondly, the adjoining and complementary mitred panels (83) located in the central part of the roof (164) must be removed; these will also come away easily, despite the pressures suffered during the process of casting the structure inside the mould, thanks to the inclination, in a matching, complementary direction, of their adjoining plates for securing at an acute (84) and obtuse (85) angle, respectively. Removal of the said mitred ceiling/roof panels is going to allow for proceeding with removal of the formwork for the rest of the modular panels (41) in the ceiling/roof part (164) of the mould, adjoining the said mitred panels (83), as well as removal of the formwork for the said internal angles (86) described, dismantling or removal of the complete mould formwork thus being realised in an organised, simple and fast way, without damaging or impairing the said mould panels or the structure cast inside the same.

FIG. 170 represents a cross-section perspective view of the upper part of a mould before proceeding with concreting. In the said figure, it is possible to appreciate a different form from that represented in FIG. 168 of combining the different mitred modular parts belonging to the system covered by the invention to form a complete mould which, following concreting and despite the pressures and stress borne during the casting process, may be dismantled piece-by-piece following a specific order for removal of the panels that make up the same, without these suffering any deformation and without damaging the actual structure cast inside the same. For this, use is made of a combination of internal angles (86), positioned at the corners where the walls (163) meet the ceiling/roof (164), which have their two lateral plates (89) inclined at complementary angles to those on the plates on the mitred ceiling/roof and wall panels (83) adjoining the same.

FIG. 171 indicates, schematically, the order for removal of the panels and modular parts so that removal of the mould formwork can be realised with full guarantees for both the panels and modular parts themselves and for the structure cast inside the said mould. First of all, and without distinction, removal takes place of the right and left mitred wall panels (83) adjoining each of the internal angles (86) with their two inclined plates (89) in the form of a double mitre, located at the corners where the walls (163) meet the ceiling/roof (164), thus allowing the removal of the remaining wall panels (41) adjoining these. Work continues with the removal of the mitred panels (83) in the ceiling/roof (164) adjoining each of the double-mitred internal angles (86) located on the internal corners of the mould. Both the mitred wall panels (83) and those in the ceiling/roof are easily extracted thanks to the angular inclinations of their plates that abut against the double mitre of the internal angle (86) at each corner, on either side of the same (ceiling/roof and wall). Subsequently, the said internal angles (86) are removed, as these are now free at both ends, and present no difficulties with removal. Then, work continues with the remaining modular panels (41) for the ceiling/roof (164). In this case, there are no central mitred panels in the roof, as referred to in FIGS. 168 and 169, since they are not necessary, because the double mitre on the internal angles (86) allows for perfect removal of each of the panels, by following, effectively and at all times, the order indicated. Thus, dismantling is realised easily and comfortably, without at any time forcing the mould or damaging the structure that has already been cast inside the same.

FIG. 172 shows the mechanisms that are conceived for supporting the modular panels (41) used for constructing the ceiling/roof of the mould, both inside the construction and on external overhangs. There are three types of stanchions with their own characteristics, conceived for facilitating and improving those used up until now in the sphere of construction with simple formwork, so that they have direct and positive repercussions on all the refinements that are described in the present invention. These stanchions support, in all cases, alignment joists (46), which rest on the upper U-shaped part (165) of the said stanchions.

The stanchions (166), which are positioned vertically, mainly for securing the internal ceiling/roof sections of the mould, that are used in the present invention, are of the type already described in the previous patent number P9401135 from the same applicant, and can be adjusted in terms of level thanks to the telescopic mechanism which allows the upper element (167) of the same to rise up until it reaches the right height, as per the requirement in each case. For setting the required height, on this stanchion (166), a security pin (10) is used, as already used on other parts that make up the system, which is included in and attached to the said stanchion, on its fixed element (168), and which is inserted into the round orifice (169) in the same, thus joining the two elements via the said orifices at the required height, as shown in FIG. 172. This stanchion has, by way of a complement, an adjustment thread (170) which rests on its base (171), the thread of which has a fine pitch, which allows for turning the same by means of an inclined handle (172), even once the concrete has been poured into the mould, since it is designed for withstanding great pressures without yielding, and, at the same time, facilitates unscrewing for removal, without complications and without damaging the stanchion itself. This implies a longer lifetime for the part, better adjustment of the same and an enormous speeding up of work on site, since, at the same time, it carries out its duties with total accuracy, which it to say, it levels and makes the ceiling/roof panels flush, and it constitutes a completely effective support which helps, once again, with the task of mechanisation of this essential and basic construction sequence covered by the invention.

For its part, the system also incorporates two new types of stanchions for external overhangs, which are also represented in FIG. 172. One of these is a straight structural stanchion (173) comprising three tubular elements, two of them fixed (168), one at the bottom and another at the top, and another extendible telescopic element (167), contained inside the upper fixed one, which is adjusted to the appropriate height by means of the security pin (10) explained above, which passes through the round orifices (169). This stanchion (173) is not directly secured to the foundation raft (27), but has a securing and support device (174) which is secured to the peripheral plates (93) on the wall panels (41), in a simple, safe, resistant and practical way.

The said securing device (174), represented on a large scale in FIG. 173, is made up of two identical trapezoidal U-shaped plates joined to one another at one point, leaving the four ends of the U-shaped element separated, in such a way that they form a double recess (175) in the form of a cross, these spaces allowing for the insertion of both the horizontal and vertical plates on the adjoining modular panels (41) and securing the same, which is realised by matching the holes in the four ends of the said U-shaped plates with the corresponding round centring orifices (79) in the peripheral plates (93), by means of the relevant security pins (10) which are inserted into the said matching orifices. This securing device (174) is secured to the fixed tubular element (168) of the stanchion (173) by means of a tapered pin (176) which is inserted into the orifice in the base or plate attachment area, and which is immobilised by means of cotter pins (177) which are inserted into the through holes (178) situated close to the ends of the said pin. On top of the said pin (176), the stanchion (173) is supported and swivels in such a way that it allows for the angular inclination required in each case, depending, of course, on the height defined by the telescopic tubing (167) and the width of the overhang being constructed.

Moreover, this straight general structural stanchion (173) also has, as can be seen in FIG. 172, a fine-pitched thread (170) with a handle (172) which separates the two fixed elements (168) of the same, the thread of which can withstand great pressures without in any way affecting unscrewing at the time of removing the stanchion, which is effected without any effort or damage to the stanchion itself or to the modular panels (41) that it supports via the corresponding joist (46).

The other stanchion for overhangs (179) that has been conceived, and is represented in FIG. 172, is an angular structure, and its function is the same as that of the stanchion (173) described above. However, mention should be made of certain features in terms of its configuration and use. Its securing and support mechanism in respect of the wall panels (41) is the same as on the other stanchion for overhangs (173), but adjustment thereof, heightwise, is effected by means of the handle (172) which moves the two fixed tubular elements (168 and 181) of the stanchion (179) thanks to a double left-hand/right-hand thread which brings together or separates the two tubular elements, as necessary. Moreover, another of the distinguishing characteristics is the fact that it has a bend in its fixed lower element (181), which is reinforced by means of a triangular plate (182), since it is used on less prominent overhangs, where the straight stanchion (173) type referred to above would not be practical, since it would have to be positioned at an acute angle of very few degrees and the adjustment handle (173) would hit the wall panels when the worker had to turn it, and might then cause damage to the wall panel (41) in question.

All the parts and elements described, which form part of the system covered by the invention, fulfil their specific duties with a logic that is inherent in the system as a whole, with a view to optimising, to the full, the performance of the said system at all times and in any of the stages of the construction process.

The system of constructing structures using high-precision integral and modular formworks, which is described in the present invention, makes provision for the creation of a great variety of new modular parts which imply a step forward in terms of resolving and achieving the results envisaged for the structure, without requiring any subsequent specialist work, since these parts and other component elements of the said construction system afford a new dimension for the concept of modular formwork, which, thanks to this invention, becomes a complete mechanised industry capable of realising any construction idea without limits of any kind, optimising timescales and achieving high levels of efficiency in each of the phases in the system.

To this end, FIG. 174 represents one of these new parts, which consists of a modular cover (183) comprising two adjoining halves (184 and 185) which each have, on their front face, a protruding prismatic box, one of the shorter sides of which is at an oblique angle, which corresponds to the oblique angle on the other. These boxes, following concreting, form a recess or suitable space for housing the drum of a shutter. This new structure of the part described speeds up and guarantees correct formwork removal for this part of the mould, without damaging the modular cover (183), the panels adjoining the same, or the actual structure cast inside the mould, just like the mitred panels in ceilings/roofs and walls and the mitred internal angles on corners, as has been described above.

FIG. 175 shows the position of this modular cover (183) above the recess for a window (186), as an integral part of the mould assembly, which has had the formwork partially removed following concreting of the structure inside the same. This part (183), structurally reinforced on its rear face with reinforcement battens or plates (82), is secured to the rest of the modular panels (41) by means of self-centring attachment clamps (92), or similar elements, such as self-centring screws (96), which join their peripheral plates (93) drilled with oblong orifices (7) and round centring orifices (79) that are equidistant and symmetrical in terms of those on the remaining parts and modular panels (41) in the system, in such a way that they can be secured and fitted together with total precision in order to guarantee the total quality result envisaged (see, by way of a complement, the previous FIG. 174).

FIG. 176 shows another new modular part that has been conceived for contributing likewise to the mechanisation and industrialisation of construction work realised in integral and monolithic manner, as well as with total precision and without the possibility of errors or maladjustments arising out of improvisation. This is a cover (187) of general rectangular structure with a central longitudinal rib (189), suitable for forming the guide for the shutter, the cover of which has oblong orifices (7) and round centring orifices (79) in a row close to its lateral periphery. This cover (187) is secured vertically to the lateral edges of the window recess (186) and is attached to the modular panels (41) by means of self-centring securing clamps (92), as shown graphically in FIG. 178. The said cover (187) for the shutter guide makes provision for a low step (188) which allows it to fit perfectly on top of the part on which it is supported, consisting of a cover (190) for the window sill.

FIG. 177 depicts the said cover (190) for the window sill, comprising a rectangular plate that is inclined slightly downwards (192) and which continues, on its upper part, in the form of a step (191) likewise inclined, in the opposite direction, all of which allows water to run off on rainy days. The said cover is attached to the peripheral plates (93) on the mould panels (41) which give the window recess (186) its form by means of the oblong orifices (7) and round orifices (79) drilled in the front and rear ends of the said cover, using, for such purposes, the relevant self-centring securing clamps (92), as can be appreciated in the overall view in FIG. 178.

In the said FIG. 178, it can be observed how these two parts, as detailed in FIGS. 176 and 177, fit together millimetrically, ensuring that the integral and monolithic structure to be cast inside the mould is one of total precision and has the necessary elements in the appropriate places.

FIG. 179 represents a window located in the peripheral wall of the dwelling, viewed from the outside, with the integrated details of the shutter guide (193), the sill for the window (194) and the space for the shutter drum (195) located inside the wall, all of this at an initial phase during dismantling of the mould.

FIG. 180 shows the final result of the construction of a window, once the whole of the mould has been removed, it being possible to see the same elements as referred to in the previous figure, that is to say, the shutter guide (193), the sill for the window (194) and the recess for the shutter drum (195), all of these viewed from the inside of the dwelling.

Another of the new elements provided for in the high-precision modular construction system covered by the present invention is the assembly of specific modular panels conceived for the fabrication of integral and monolithic stairways, both internally and externally, in any construction and without any limit in terms of dimensions or form.

FIG. 181 shows the modular assembly of a monolithic stairway (196) inside a dwelling, consisting of two flights (197), separated by a landing (198), using modular panels (199) with specific forms and dimensions to allow for constructing the steps and reaching the required height. Assembly of the mould for the stairway is the same as in the rest of the construction. The panels are attached to one another by means of simple securing angles (200) with high-precision millimetric adjustment, thanks to the self-centring screws and clamps (8), in any of their variants, and concreting is realised at the same time as the rest of the dwelling, by pouring the liquid concrete from the upper part of the mould.

FIG. 182 details, precisely and thanks to a partial section, the way in which the mould (196) for the said stairway is attached to the mould for the wall (163) of the dwelling, and it is also possible to appreciate the point where the two join, consisting of an opening (201) made in the vertical panel of the mould (163), with identical dimensions to that of the said mould (196) for the staircase attached to the same. Through this opening (201), the liquid concrete flows without any difficulty from the inside (102) of the wall mould (163) to inside the mould (196) for the stairway, where the said stairway (202) is cast in integral and monolithic manner and with high precision, since the modular parts used for this have precise, clean joints, without maladjustments, thus allowing a total quality result.

FIG. 183 shows the assembly comprising the wall of the dwelling and the integral and monolithic stairway (202) forming a single part during final concreting, obtained with full guarantees regarding sturdiness, durability and safety, thanks to the refinements introduced in the high-precision modular construction system covered by the invention.

FIG. 184 shows some dwellings at an advanced stage of construction, the external stairway of which (203), affording access to the various floors of apartments that make up the same, has a monolithic curved structure, as an example of the unlimited possibilities of the system. The specific modular panels (199) that configure the same determine its rounded structure, and also make provision for each and every one of the elements that make up the same, such as the steps or treads of differing forms and measurements, the handrail, rails and others. Their high-precision joints, using self-centring clamps (8), allow for forming a complete stairway mould which, following concreting, will result in an integral monolithic stairway consisting of a single piece attached to the rest of the construction, as has been described and depicted in FIG. 182. For assembly and dismantling of the mould for the said external stairway, use is made of safety walkways likewise with a rounded structure (204), which are installed on each floor of the dwelling in question as construction of the same progresses and which, as will be specified later on, guarantee safety on site during the construction process.

FIG. 185 shows the final result of the said external stairway (203), concreted at the same time as general filling of the mould for the floor in question took place, once the mould in which the said structure was cast has been removed. The mould for the following floor of the dwelling, with its corresponding section of stairway (197), with a rounded landing (198), is constructed as a continuation of the method indicated in the previous FIG. 184, for proceeding, subsequently, with concreting and in this way taking overall construction of the dwelling forward. Following this procedure, results that cannot be bettered are obtained in the construction of stairways, irrespective of the design thereof, achieving, in a simple, fast and economic way, identical stairways in any one construction, with flights that are perfectly straight, well-seated and plumb and without any differences from one another.

For assembly, dismantling and general handling of the modular panels necessary for the construction of both external and internal monolithic stairways, the system covered by the present invention has made provision for a new element which is represented in FIG. 186. This is a set of steps that is adjustable in terms of height (205), the rear legs of which are made up of two elements, one fixed (207) and the other telescopic (208), which fits into the former, thus achieving the required height, both elements being provided with through orifices (206). Securing of these elements is realised by means of security pins (10) which are inserted into the said orifices (206) when their positions coincide. This set of steps allows for working on different treads, even when they are not adjoining, facilitating the worker's task at the time of dismantling or handling panels for sections above the said stairway or any other operation or manoeuvre.

As has been explained throughout this description, mechanised construction using dimensional high-precision moulds affords speed, agility and quality in the structures constructed, but these constructions, irrespective of their nature and purpose, do not need to be isolated and separate from one another, but may be joined in a complete and continuous row of buildings. For this, the refinements in the system covered by the invention allow for the modular fabrication of continuous walls that overlap one another, so that there is no gap between the same, except for those which, in accordance with construction standards in force at the site, are necessary for making provision for expansions in the main joints.

FIG. 187 represents an assembly of overlap elements in adjoining peripheral walls of dwellings or any other type of construction, such assembly consisting of three covers (209) for continuous walls which allow for the positioning of double reticular reinforcement rods (20), positioned inside the mould and which are integrated into the wall following concreting, without the concrete leaving the said modular structure (163). These covers are secured, using self-centring clamps (92), in any of their variants, to the modular panels (41) that make up the peripheral wall, using, for such purposes, simple angles or brackets (200) which serve as an element for securing and retaining the said covers (209) and to ensure that they do not yield as a result of the pressures exerted by the concrete inside the mould during the process of casting the same. In this way, and thanks to the high precision to tenths of a millimetre for which provision is made within the invention, it is possible to assemble another mould as a continuation of the structure previously cast, sharing its reticular reinforcements (20), which allows for continuing with a row of constructions joined to one another in a precise manner with clean and almost unappreciable joins.

FIG. 188 shows the way in which, after removing the formwork, the walls and roofs of the construction are left, in particular, showing the reticular reinforcements protruding outwards from the concreted structure so that, subsequently, it is possible to effect assembly of another formwork which shares these internal reinforcements, which allow for joining two adjoining elements to create dwellings or other aligned and overlapping constructions.

FIG. 189 shows an assembly of three covers (209) for overlapping continuous external peripheral walls, the covers for which are secured, centred and fitted together with total precision, with the help of securing brackets (200) which are attached to the modular panels of the mould (41) using self-centring clamps. The said brackets for securing, retaining and reinforcement (200) coincide, in terms of length, with the thickness of the wall, leaving room for the double reticular reinforcements (20) which pass through the spaces or recesses existing between the joints of adjoining covers (209), but, at the same time, holding back the concrete which is being cast inside the mould giving form to the structure of the wall.

FIG. 190, for its part, shows the same assembly of overlap elements, but, on this occasion, for continuous internal walls. The only difference between this assembly and that shown in the previous figure stems from the use of two covers (210) instead of three, for the simple reason that the internal walls do not, usually, have a double reticular reinforcement but a single one, for which reason only one recess is needed for the same to pass through, as detailed in the drawing.

FIG. 191 represents, in perspective, one of these securing brackets (200) which secure the covers to the modular panels that make up the formwork as a whole. This bracket has, close to its ends, and suitably aligned, round centring orifices (79) and oblong orifices (7) of identical dimensions and equidistant as per those in the plates on the panels themselves and other modular parts within the system, so that they can be used as an attachment and reinforcement element in various circumstances and at different stages of the construction sequence that is being carried out.

Up until now, with all the phases specified and organised rationally in the refinements in the improved high-precision modular construction system covered by the present invention, it is possible to achieve the complete assembly of a ground floor mould for the fabrication of a structure of any kind, in this case a single-family dwelling, in which each and every one of the elements mentioned and detailed is provided for, adjusted, centred and perfectly positioned, without the possibility of human error or maladjustments of any kind.

FIG. 192 shows a perspective of the complete mould (211) for the ground floor of a single-family dwelling. This is a general view which provides an overall idea of the nature of a complete mould ready for concreting, that is to say, with its peripheral walls, internal partitions, ceiling/roof covers and other components of the same. For this, all the phases prior to assembly of the mould indicated up until this point, such as assembly of the foundation formwork with all its necessary basic installations, fabrication of the foundation raft itself, cast inside the raft formwork, nailing of the U-shaped stop parts for determining the position, measurements and thicknesses of the walls and partitions, positioning of the wall template for positioning of the reticular reinforcement rods, assembly of the wall template and its electrical and sanitation installations, and, finally, the general assembly of the mould have been carried out in an orderly, mechanised and rational manner. In this way, the mould depicted in this figure has all the elements and installations necessary, as well as all the details already indicated for which provision is made in the said mould, these depending on the plans and design of the same. Moreover, this figure also depicts two alignment joists (46), which are attached to the mould as a whole by means of securing brackets (44) which, in this case, serve as another element for correct positioning and alignment of the panels that make up the mould for the dwelling. But, above all, and mainly, the function of these joists consists of providing rigidity for the external lateral face of the mould, with a view to the crane being able to move and transfer the said assembly as a single piece, without any of the panels that make up the same shifting in the least and jeopardising the smooth and precise structure of the wall once it has been concreted. Other details of interest which one has wanted to stress in the drawing are the separator devices for doors or spaces (157), already explained above, as well as the covers for ceilings/roofs (212), which close off the various rooms or areas in the dwelling, so that, subsequently, concreting of the structure formed by the peripheral walls and internal partitions can be realised, with all the elements provided for in the said mould, in order to achieve an integral monolithic structure executed using a mechanised, rationalised and fully industrialised construction system.

The ceiling units of the ground floor moulds constitute, at the same time, intermediate slabs between the lower floor and that immediately above, as also happens in other constructions or buildings comprising several floors, where the ceilings on each floor constitute the floor of the adjoining level heightwise. For this, before proceeding with concreting of the mould, and following positioning of the roof/ceiling covers represented in FIG. 192, reticular reinforcements are prepared and welded together for the intermediate slabs, as can be seen in FIG. 193. On top of standard templates (213), positioned on the floor, the necessary reticular reinforcements are formed (20) (for creating the slab), which are subsequently transferred by crane to their definitive position. It is therefore advantageous to be able to assemble the reticular reinforcements for intermediate slabs on a large flat piece of ground, for use straightaway or for storing the same and using them in each construction or on each floor of the same, as and when work progresses. As has been indicated above, for assembling the reticular reinforcements (20), the standard template (213) is placed in position on a large piece of ground that is as flat as possible, and, taking this as a reference, the double reinforcements are placed on top, as shown in the drawing, the standby rods (21) being welded at the corresponding points indicated by the said template, in order to determine, with total accuracy, the position of the peripheral walls and internal partitions.

FIG. 194 represents a variant of the standard template, with a sloping structure (214) and stabiliser supports (215) for preparing the reticular reinforcements for sloping roofs on the top floors of any type of construction.

Once the reinforcements for intermediate slabs have been assembled and formed on top of the standard templates, and after welding of the standby rods (21) to the reticular reinforcements has been carried out at the corresponding points, the complete assembly of reticular reinforcements (20) is hitched up, as shown in FIG. 195, as a block, using specific hitches which are lifted by crane, being transferred and placed in position, on top of the first floor, second floor, or whatever floor it is, in each case, to form the intermediate slab between two adjoining floors, or else on top of the top floor in the case of FIG. 194, where the reinforcements correspond to a sloping roof. The said FIG. 195 shows how the crane lifts the assembly made up of the reticular reinforcements (20) with the standby rods (21) welded on and all the essential elements for forming the structural reinforcement element for an error-proof intermediate slab, where there is no possibility of maladjustments or off-centring of any kind, since everything has been provided for in accordance with the precision measurements and references indicated by the standard template used for such purposes, which, in turn, determines, with total safety, the exact measurements for the concrete covering, in accordance with standards in force on site.

Lifting of the reinforcements as a block is realised by means of a crane, preferably using five straps (216), provision being made for four of these to be attached to the edges of the assembly made up of the reticular reinforcements (20) and the standby rods (21), and the fifth to the centre of the same. Attachment is realised in a studied manner, depending on the surface area of the assembly, so that movement can be realised in a balanced, stable manner and under safe conditions and positioning of the same is effected precisely and simply.

Once the assembly of reticular reinforcements has been placed in its definitive position, and after proceeding with concreting of the ground floor of the mould, or the corresponding floor, as the case may be, the following step or stage envisaged in the improved high-precision modular construction system covered by the present invention consists of installing the wall template with its respective reticular reinforcement rods and insulation for the peripheral walls of the upper floor or floors.

FIG. 196 shows an example of a wall template for the various floors in the dwelling other than the ground floor, which is assembled separately, following the same steps and identical principles as used in assembly of the wall template for the ground floor, as considered and detailed above. The wall template (37) is prepared by supporting it on trestles (217) which allow for working speedily and comfortably at the time of realising assembly of the same. Thanks to these, the tasks of positioning the reticular reinforcements (20), insulation for the peripheral walls (61) and permanent separators (64) is enormously simplified, since it is possible to work on both sides of the template with greater ease and with a considerable saving in time, which is essential in industrialised construction carried out using the system covered by the present invention. The said wall template (37) is taken as a basic reference and, on top of this, the reticular peripheral wall reinforcements (20) and the wall insulation material (61) are placed in position inside the said reinforcements, respecting the recesses for windows and doors, as well as all measurements and indications shown by the template and which are extremely important for positioning the modular elements that form the complete mould for the walls. Finally, the permanent separators (64), described above, are placed in position, with a view to securing and maintaining the assembly made up of the reinforcements (20) and insulation at the necessary distance, without any maladjustments or movements occurring which might subsequently jeopardise the successive phases within the system.

FIGS. 197 and 198 show the type of hitch conceived for securing and transferring, by crane, the assembly made up of the wall template (37), the reticular reinforcements (20) and the insulation (61), the last two being precisely held in place by means of the permanent separators (64) (FIG. 62), to the storage position or else to the floor of the dwelling where it is going to be placed in position for subsequent assembly of the mould. This hitch (218) comprises a triangular body (219), from which hooks extend (220), positioned at equal distances along the base of the same, and which are used for securing the assembly made up of the template and complementary elements indicated.

More specifically, FIG. 198 shows the practical and simple way in which the hitch (218) is used, and shows the manoeuvre of lifting, transferring and subsequent positioning of the reticular reinforcements (20), secured with the insulation (61), along with the wall template (37), on top of a ground floor that has already been concreted, in a single-family dwelling used for reference. The reason why the complete template/reinforcement/insulation assembly is lifted and transferred as a whole is that of making provision for the fact that the reticular reinforcements, because of their flexibility, may suffer off-centring or maladjustments, due, for example, to winds or any other unforeseen sudden movement that may occur during transfer of the same by crane. In this way, the complete assembly is transferred to the relevant upper floor or level and, once secured in its corresponding position, in accordance with references for the U-shaped stop parts (28), standby rods (21) and others, the wall template (37) can then be removed, leaving the reinforcements (20) perfectly secured and centred, along with the insulation (61), in the case of peripheral walls, for proceeding with assembly of the basic general installations and subsequent assembly of the mould. This hitch (218) is, therefore, an ancillary element created for contributing to the system covered by the invention affording the sequential continuity that turns it into a mechanised and industrialised construction system, since it facilitates and speeds up, in this case, the phase of assembly of the wall template (37) for upper floors with all the elements for which provision is made therein, so that subsequent assembly of the mould can be effected without the possibility of faults, human errors or maladjustments of any kind.

For proceeding with the tasks of assembly and dismantling of the mould on the upper floors of constructions, the invention has made provision for safety walkways (221), which are represented graphically in FIG. 199, and which, because of their conception and design, allow for carrying out work at height. Around the periphery of the construction, the said walkways (221) form a platform with a non-slip floor (222), enclosed with handrails (223), which afford total safety guarantees for carrying out, mainly, tasks relating to assembly and dismantling of the mould, reducing the risk of accident and mishaps on site. These are, therefore, walkways that improve the system and afford great versatility, easy and rapid assembly, and important safety guarantees for workers.

FIGS. 200 and 201 show, jointly, the different elements that make up the said safety walkways (221), which have non-slip platforms (222) secured by means of supports with a trapezoidal base (224) to double horizontal support profiles or rails (225), which are mounted at the necessary height, as the actual construction work progresses at height. These rails (225) are secured to the walls using special screws (226), with a U-shaped head (227), which prevents the said screws (226) from rocking or shifting within the said rails (225), the screws in which make use, for installation purposes, of the orifices left by the tapered wall separators in the mould, following concreting of the same.

FIG. 201 shows, in detail, how a walkway (221) can be secured at the necessary height, as the case may be, irrespective of the height of the round orifices in the wall produced by positioning the tapered wall separators (98) during concreting of the same, this being achieved thanks to flanges (228) (cf. FIG. 200), which are secured by means of security pins (10), which allow for moving the walkway supports (224) with a trapezoidal base vertically and, consequently, the walkways themselves, securing the same by means of the drilled round orifices (169) that the said supports (224) have. Moreover, the walkways may also be moved horizontally, for positioning the same at the appropriate point within a construction row, via the attachment device provided in the form of the special screws (226) which are inserted and held in place by means of the thread (229) to the said profiles or rails (225). The said safety walkways (221) have a support stop (230) on the bottom part of the trapezoidal securing support (224), which rests against the actual wall of the construction (232), and the function of which consists of stabilising the walkway (221) so that it does not suffer any sagging or wobbling when in use and, in this way, fulfils all the safety conditions necessary for workers.

The said FIG. 201 shows, moreover, a part which plays an important role in the assembly as a whole. This is narrow fold-down member (231) fitted with a longitudinal hinge and lower triangular reinforcement brackets, such member helping to secure, correctly, the overlap on the modular panels (41) of the mould with the structure that has already been concreted (232) adjoining the formwork assembled and corresponding to a lower level or floor. With the help of this member (231), it is possible for overlapping of the modular panel (41) with the concreted wall (232) immediately below to be achieved perfectly and be fitted together with total precision so that subsequent complications do not arise in the following phase of the construction sequence.

FIG. 202 depicts two perspectives, from different points-of-view, of one of these fold-down members (231), which, as shown in the previous figure, is attached to the actual floor or main platform (222) of the safety walkway, on the inside of the same, by means of a longitudinal hinge (233). The said member, when folded down, that is to say, in its horizontal position, rests on the modular panel, to form an overlap attachment, with total precision and without leaving gaps, with the help of a tubular part (234), likewise longitudinal, situated along the rear face of the said fold-down member. For removal of this member from its position, it has a small flange bent downwards (235) and situated along the rear part of its back face, which allows it to be used as a flange for lifting the same with ease.

This fold-down member (231) complements the function of the safety walkways (221) by allowing, in an easy and straightforward way, assembly of the mould for the upper floors to be realised with total precision so that it is perfectly aligned and secured in the appropriate place.

FIGS. 203 and 204, for their part, represent two views in perspective of two corner pieces (236) for safety rails (223), one being right-hand and the other left-hand, which, together with the straight parts of the said handrails, form a protective barrier so that the worker can move around freely using the safety walkways, without any risk to the same.

FIG. 205 shows an ancillary support part (237) for the safety walkways (221). This type of part, like the one represented, is positioned at the ends or shorter sides of the platforms (222), the parts thereof not being attached to the double horizontal supporting profile (225) of the walkways, this double profile being secured to the concreted wall of the construction (cf. FIGS. 200 and 201), but being attached to the lower part of the said platform or floor of the walkway (222) by means of reinforcement battens (238) that the walkways have, as can be seen with greater clarity in FIG. 206. These support parts (237) serve to secure and provide rigidity for the corner sections (236) that are attached to the corresponding straight sections (239) of all the handrails on the safety walkway, achieving even greater safety and stability of the same.

FIG. 207 represents the implementation of a new safety stairway (240), likewise conceived for making good different levels in the safety walkways (221). This type of stairway, designed in a range of between one and five steps, is attached to the safety walkways (221) by means of plates (241), which have oblong orifices (7) drilled in them, which rest on the platform of the higher walkway (222) and are secured to the same by means of self-centring screws (96), the legs resting on the floor of the walkway immediately below. Stairways with more or less steps are used, depending on the height to be made good. These attachable stairways (240) afford the walkway system greater safety and, at the same time, use simple mechanisms which allow flexible and rapid assembly and dismantling of the same.

FIGS. 208 and 209 show two variants of the safety stairway (240) that can be attached to the walkways, with one and three steps respectively, by way of examples.

For assembling and dismantling the mould and its various components inside a construction, a very simple new idea of great practical application has been conceived, consisting of an extendible joist (242) which, when several of them are used, support plates (243) which serve as staging, especially for operating on high parts of the said construction.

FIG. 210 shows use of this extendible joist (242) for staging. Each joist (242) is made up of two elements, one fixed (244) and the other telescopic (245) which is inserted into the former, thus providing a whole range of lengths which allow it to be used in confined spaces between facing walls, and also in more spacious areas where the modular structures that give form to the internal walls are much farther apart. It is precisely this point that gives rise to its practical usefulness and its versatility for being used in constructions with substantially different dimensions, such as single-family dwellings, industrial sheds, buildings and others. Its main purpose is to act as a support for plates (243) used as staging inside forms of great height where the ceilings/roofs are very high, as has been indicated above and as shown in the drawing, since, these being internal areas, it is not possible to use the peripheral safety walkways referred to above for assembling, dismantling and, in general, manipulating panels and parts for ceilings or the upper wall sections of the formwork. The extendible joists are secured to the peripheral plates (93) on the wall panels (41) of the mould that face one another within the overall structure, using securing and support devices (246) with a cross-shaped structure, which are soldered on to the ends of the two joist elements (242) and are attached and secured, using security pins (10). The joists are positioned at a set distance from one another and always at the same height so that, subsequently, the said metal plates (243) can be positioned on top of them, to serve as staging inside the formwork.

In the example in FIG. 210, a single plate (243) has been represented as staging, with a view to showing, clearly, the form of the joists, the way in which their elements fit together and operation and positioning of the same, although in practice, and as shown in FIG. 211, there should be as many plates (243) on top of the joists (242) as will fit, in order to cover the whole space that exists between a modular wall structure (163) and the one opposite, allowing the worker, in this way, to move around and affording comfortable and safe manoeuvrability within the space available between the walls at either end for carrying out his tasks more speedily and safely.

FIG. 212 shows, in detail, an extendible joist (242) of the type suggested for supporting internal staging, in which it is possible to observe the attachment element using cross-shaped parts (246) with a flat base (247) secured by means of security pins (10) to the peripheral plates (93) on the modular panels (41) that make up the mould assembly for the walls.

An easy method for safely securing the joists consists of using the round centring orifices (79) in the peripheral plates (93) on the panels (41) and those on the said attachment element on the joist. The two elements, the fixed one (244) and the telescopic one (245), which allow for adapting the length of the joist in terms of the specific requirements of each case, or, which is the same thing, in terms of the distance available between the two formwork walls that mark the boundaries of the work area, are also depicted.

FIG. 213 shows, schematically, and on a larger scale, the structure of the telescopic moving element (245) in the extendible joist, which has, advantageously, two stops (248), one at the bottom and another at the top. Both serve as levelling parts which allow the telescopic element (245) to rest inside the fixed element (244) without the joist flexing, bending or tilting, since they compensate for the difference in height and size necessary for one of them to be able to enter the other and move inside the same with complete safety and stability, this safety condition being very necessary given that the plates for staging are subsequently positioned on top of these joists, at considerable heights, and the worker has to work on top of these. Moreover, the fixed element (244) in the joist (242), for its part, has an upper stop (249) welded inside the same, which prevents the telescopic element from extending beyond the maximum safety distance defined, by ensuring that the two upper stops on both elements of the joist come up against one another.

For a full and complete understanding of the new possibilities of the construction system in question, a series of ancillary parts are explained below for forming all the details relating to the upper part of a dwelling, such as, for example, the chimney, the upper parapet walls, mouldings and embellishments for doors and windows.

FIG. 214 shows the upper part or roof of a dwelling, in which it is possible to appreciate various architectural details and how these can be constructed by using moulds to produce an integral monolithic structure. These moulds, formed, of course, from modular panels, allow for creating the structure of a chimney (250), with a central opening for a pipe located inside the same (251), the peripheral parapet walls (252) which form a small wall on the upper part of the construction, the moulding (253) positioned over the window, as well as a small decorative overhang (254) on the front of the dwelling. Once the modular panels have been assembled and fully attached to one another by means of self-centring clamps (92), in any of their variants, and other adjustment elements, concreting takes place, as has already been realised in the figure, ensuring perfect filling of the inside of the mould and a complete dwelling with an integral structure. To facilitate filling of the mould cleanly and quickly from the upper part of the formwork for the parapet walls, these have a flat or check zone (255) of lesser or greater width, depending on the height of the said parapet wall, on the internal formwork of the same; this zone prevents the casting material, because of its liquid state, from flowing and creating a siphon and making it necessary to fill the mould in interrupted manner and waiting for the concrete to be cast in the lower part of the inside of the mould. In this way, concreting is effected on a single occasion, without there being any problems, and obtaining, as a result, an integral monolithic structure.

FIG. 215 details positioning of the mould for forming the parapet walls that are integrated into the dwelling as a whole, in integral monolithic manner. It clearly shows the check zone (255) referred to in the previous figure, as well as the location of the tapered wall separators (98) with their respective locking clips (99) which define and maintain the exact distance between the mould panels (41) that form the said parapet wall and those that make up the peripheral wall of the dwelling. In this figure, it can be clearly seen, moreover, how the mould that forms the parapet walls or upper walls (252) of the dwelling has a securing and reinforcement part (256) consisting of L-shaped plates (257) and a device for attachment (258) to the special drilled reinforcement plates (93′) on the mould, such part (256) securing and attaching, at a specified distance, the modular panels (41) on either side that form the parapet wall (252) so that the said panels do not yield during casting of the concrete inside the same. This securing and reinforcement part (256) is specifically designed for fulfilling this function of securing, containing, levelling and aligning, with total guarantees regarding precision and operability. The drawing clearly shows how both the L-shaped plates (257) and the attachment device (258) work, reducing the margin of error and ensuring excellent results.

FIG. 216 represents, in perspective, this same securing part (256), from which its structure can be appreciated more clearly. Its aforementioned attachment device (258), which is secured, using self-centring clamps or screws (96), to the drilled reinforcement plates (93′) on the modular panels (41) that form the parapet wall, has a stepped structure which allows it to clear the upper peripheral plate (93) on the modular panel that forms the parapet wall, as can be seen in the previous figure. This attachment device (258) is soldered to one of the L-shaped plates (257) that run across the width of the parapet wall, whereas the other L-shaped plate, positioned to form a T in respect of the former and welded to the same, has, in turn, one round orifice (79) and two oblong ones (7) of identical dimensions to those formed in all the modular parts that make up the system. This allows this last plate (257) to be secured to the upper peripheral plate (93) on the modular panel (41) that forms the parapet wall, at the same time as the device for attachment (258) of the said part (256) is attached, via the equivalent orifices, to the reinforcement plates (93′) on the modular panel on the opposite side. In this way, perfect adjustment and alignment of the mould that forms the parapet wall in question is achieved, with total guarantees regarding resistance to casting of the concrete, since this double joint on the securing part (256) for attachment to the matching modular panels (41) means that these cannot yield, shift or change position, and so the fit is perfect and, consequently, the final concreting has a smooth, flat and level aspect, moreover affording savings in terms of speed and effectiveness.

FIG. 217 shows a general perspective of a two-storey dwelling already concreted, in the state known as “grey structure”, with all the details previously configured in the mould, such as, for example, the chimney (250), the parapet walls (252), the window mouldings (253) and the upper overhang on the dwelling (254), in addition to the dwelling's door and windows and all the installations integrated into the said dwelling. This is, therefore, the final result of the dwelling, before applying any finishes considered suitable, such as tiles, flooring, carpentry and grills, all of which are made-to-measure, and the paintwork which, thanks to the smooth finish of the “grey structure” produced with the refinements of the invention, can be applied, without any problem, directly to the surface constructed. All of this implies a considerable saving in time, together with an increase in quality, durability, resistance and precision, as well as a reduction in costs, all of these aspects being of great interest.

With all the elements, parts and procedures detailed up until now, the system ensures the high-precision integral and monolithic construction of single-family dwellings on several floors, buildings, industrial sheds, or any other type of construction of any kind. With this, the construction system covered by the present invention becomes a simple, mechanised, systematised and industrialised method that is error-proof and without limitations regarding its usage for the execution of all types of construction ideas previously planned in the technical office.

In this new industrialised and rationally organised construction range, FIG. 218 represents a row of two-storey single-family dwellings (259) under construction, by way of an illustration to facilitate an overall appreciation of the system covered by the invention.

The ground floors of the dwellings depicted (260) show, after concreting and subsequent removal of the formwork, a smooth, flat and perfect aspect in their overall structure, on top of which the second floor is being built, this being shown at different stages of construction. It is possible to observe three different stages of the construction system on the second floor in this figure: one upper floor (261) completely concreted and with the formwork removed, in the “grey structure” stage; another upper floor with its formwork in place, using the mould (262) with its corresponding roof covers (212), and ready for subsequent concreting; and, finally, the least advanced in the order of execution, which appears simply with the reticular reinforcement rods (20) in position and secured to the already concreted intermediate slab (263).

Around the whole periphery of the upper floor in the row of single-family dwellings depicted in this FIG. 218, it is possible to observe the safety walkways (221) (cf. FIG. 199), the purpose of which, as has been said, consists of facilitating work on the structure and serving as a safety element for erectors and other workers.

For the construction of dwellings in a row, such as those in FIG. 218, the system makes provision for suitable mechanisms for overlapping walls, which allow for reassembling a complete mould alongside a construction that has already been concreted, with total and absolute precision, without losing alignment of the peripheral walls and partitions, whether internal or external, or the verticality and plumb level of the same. Thanks to these mechanisms which are described below, it is possible to produce a row of constructions with identical characteristics and without errors or maladjustments between them which would have repercussions on the final result of the structure.

For realising these mould overlaps in the lateral peripheral walls in such a way that they are aligned inside the construction, the invention has made provision for the said devices, some of which are new double-wall separators, which facilitate and simplify the process.

Thus, FIG. 219 shows one type of these new double-wall separators (264), of suitable length, which terminate, at one end, in a washer (265) which facilitates handling thereof, its tapered central structure (266) gradually becoming cylindrical (267) with a view to positioning thereof being effected in a manner that is simple and fast, as well as being effective. The said cylindrical part ends in a double tapered head (101), on to which a complementary device is firmly fitted, consisting of a clip or locking retainer (99) which determines, precisely, the thickness of the new wall to the constructed in terms of the structure already concreted.

FIG. 220 depicts, in section view, the positioning of some double-wall separators (264). These are inserted, first of all, into the orifices formed by the peripheral semi-circular recesses (80) on the modular panels (41) that make up the mould assembly, coinciding perfectly with the cylindrical orifices left, following removal of the formwork, by the single-wall separators in the concreted structure adjoining the mould that is the subject of the overlap. In this way, it is possible to achieve the necessary securing and fitting of the mould to the wall of the concreted structure, without there being any errors or any possibility of movement of the said mould which would have direct repercussions on the subsequent formation of the integral monolithic structure following concreting. This exact matching of the holes in the wall with those in the mould assembled is the result of the high precision of the panels, parts and other elements that make up the system.

Once the double-wall separator has been placed in position in the manner indicated in the said FIG. 220, the appropriate clip or locking retainer (99) is placed on the second tapered head (101) of the same, which secures it at the correct distance, preventing the mould from shifting or suffering the least maladjustment in respect of the concreted wall, thereby ensuring a structure that is identical to the one alongside, with all the high-precision characteristics inherent in the system covered by the invention.

FIGS. 221 and 222 represent another type of double-wall separator with its corresponding locking retainer mechanism (270), this separator performing an identical function to that explained in the previous figure, and its difference stemming from its general structure which is offered as a solution to possible problems that may arise at the time of realising overlaps.

This double-wall separator (268) has a washer for handling purposes (265), followed by a projection or round base (106) with a stop (107), which precedes the body of the same, formed of a tapered part (266) and another cylindrical part (267), which extends through to a threaded end for positioning and tightening the locking retainer device, consisting of a special nut (270), as represented in FIG. 222. The said double-wall separator (268) is an alternative solution for the overlapping of walls during construction, since its threaded end allows, by adjusting the relevant nut, for exerting the necessary traction on the mould used for the overlap towards the wall of the concreted structure when, for various reasons, the mould may afford minor difficulties with regards to securing the same at the exact distance required. Thanks to the thread on its end (269), along with the rear stop (107) on the rear protrusion (106), the mould can be moved to the exact position envisaged so that the overlap is effected under conditions that afford total guarantees with regards to precision, alignment, being flush, verticality and plumb level, as shown in the cross-section depicted in FIG. 223.

For overlapping the front peripheral walls of two adjoining horizontal constructions in a row, the system makes provision for overlap devices that have been perfectly studied so that this can be realised in a simple, safe and effective manner.

FIG. 224 shows, in perspective, a general view, in which it is possible to appreciate, by way of an example, the deployment of certain overlap devices (271) on the front part of the mould (272) for a single-floor dwelling under construction, for overlapping with the front wall (273) of the adjoining dwelling that has already been constructed.

FIG. 255 shows, in two views, one of the parts designed for realising this type of overlap. This is an elongated part with a U-shaped section (274), with oblong orifices (7) drilled in its base or bottom, which has one end with a separator stop (275) of identical thickness to that of the modular panels that make up the mould, so that the overlap can be realised precisely, without any play and with millimetric adjustment.

FIG. 226 represents another of the complementary parts for the devices indicated above, which consists of an overlap tie rod (276) which has, at one end, a plate or flange (277), which acts as an adjustment stop for the U-shaped part for the overlap (274), such tie rod being longitudinally threaded and having, at the other end, a locking retainer nut (270) for securing and exact adjustment of the said tie rod for the overlap (276).

The position of these overlap devices is shown very clearly in FIG. 227. The U-shaped part (274) acts as an overlap element for the modular panel (41) with the said adjoining wall that has already been concreted (273), which means that the mould is perfectly adjusted, flush and aligned with the wall of the adjoining structure, thanks to the separator stop and levelling mechanism (275) provided by the U-shaped part. For securing this U-shaped part (274), use is made of the overlap tie rod (276) with its corresponding locking retainer nut (270), which, when fully inserted in its adjustment plate (277), using the oblong orifices (7) in the base of the U-shaped part (274), secures it to the adjoining concreted wall (273) by means of the orifices (278) created beforehand in the concrete structure by the simple wall separators.

Moreover, in this same FIG. 227, it is possible to appreciate overlapping of the mould over the adjoining structure on the inside, with the help of a double-wall separator (264), as already explained above (cf. FIG. 219).

This overlap mechanism can be clearly appreciated in the perspective view in FIG. 228, which shows each of the parts used for such purposes.

With these overlap devices, it is possible to achieve adjoining constructions in a simple manner and with excellent results, without errors in alignment and flush with one another, which means that appreciable marks do not appear in joins between walls or roof sections of the adjoining dwellings, which constitutes an important advance in industrialised construction, since it is possible to achieve integral monolithic structures with identical characteristics at a fast and efficient work rate, with total guarantees with regards to quality and resistance.

As an example of the infinite construction possibilities of the perfected system covered by the invention, FIG. 229 shows a row of two-storey dwellings (261) at different stages of construction, which, in this case, are also built on top of a garage (279). For this, it is necessary to excavate the ground sufficiently in cases where the land is more or less level, so as to take advantage of terraces or differences in level inherent in the land at the time of creating the foundation rafts to be used as a base for the garage, dwellings or any other type of construction. Once the foundation raft has been prepared on the land, following the process of assembling the formwork, positioning the installations and concreting, as already specified above, the mould is assembled on top of the prepared raft and with all its elements marked out, and after concreting of the same, the formwork is removed at the right moment, thereby producing the first floor or floor below ground, as the case may be, consisting of the garage represented in FIG. 229. On top of this floor, which constitutes the garage, and following the stages indicated in the present invention for the construction of upper floors, assembly and concreting of the different levels or floors of the dwelling then takes place in an orderly, mechanised manner, with evident speed.

As can be seen in the example in the said FIG. 229, the garage has, in this case, lateral openings (280) at either end of the same, in which automatic doors will subsequently be positioned for access to a common roadway (281) for all garage spaces belonging to the different dwellings within the row. Within this roadway, provision has been made for the various accesses to each individual space (282), positioned, of course, below each dwelling to which they belong.

This is, as has been indicated, an example of a special construction structure that is not, in any event, limitative, since the system covered by the invention has the capacity for putting into practice any plans previously drawn up in the technical office, without limitations in terms of dimensions or designs, since it has all those elements, parts and tools, as well as a rationally organised, mechanised and industrialised process for making any type of construction idea feasible, being adapted to suit standards relating to resistance, durability, quality and others in force at each site.

In the same way, as shown in FIG. 230, multiple dwellings or any other type of high-rise vertical construction (283) can be constructed on top of a garage (279). This figure serves as an example to illustrate how the refinements covered by the invention allow for constructing, without any limitation, all types of dwellings, using an industrialised methodology that affords a new dimension in this field.

As an example of a high-precision modular construction realised with this perfected system, as covered by the present invention, FIG. 231 shows the execution of a block of flats or tall tower block (284) in its “grey structure” stage, and with the top floor (261) still with its formwork in place and with the safety walkways (221) installed around its periphery.

The constructional bases for dwellings of more than two floors realised using this system are identical to those for the single-family dwellings described above, mention being made, at this point, of the existence of double rails (285) positioned vertically on the construction itself, as and when it advances upwards, for vertical movement of the safety walkways (221), which are used for lifting, positioning and assembling the mould and all its elements, such walkways, moreover, assisting with manoeuvrability and access to the whole of the floor that has its formwork in place at all times, as construction of the corresponding floors proceeds upwards. For securing the said walkways at different heights, the system makes provision for a mechanism with a safety lock installed inside the said corresponding double rails (285).

The intermediate slabs on each floor of the construction for the block of flats are realised by assembling the reinforcements on the ground, with the help of the standard template explained above, and are moved into their corresponding position using the crane, as has also been indicated above.

The smaller modular parts of the internal formwork of the mould can be brought up to the various floors within the block under construction via the internal stairway concreted in sections as the height of the building proceeds, it also being possible to use the well located and set aside inside the mould for the lifts, always depending on the size of the same.

FIG. 232 shows the dual purpose of the safety walkways (221) in tall constructions. In addition to being, mainly, an element for site safety, their great sturdiness and the fact that they have high, reinforced handrails (223) turns them into external lifts for raising and lowering, to the required height at any time, the modular panels, both individually and assembled, which will subsequently be placed in position as part of the peripheral formwork for the corresponding floor or level. In this way, transferral and lifting of the said panels to the floor under construction is realised in a practical way, making use of the said rail system (285) on which the said safety walkways (221) are positioned.

Moreover, and following explanation of the multiple possibilities afforded by the refinements covered by the invention with regards to the construction of single-family dwellings and blocks or flats or offices, the possibility of also constructing boundary walls, divisions, garden walls and the like will be explained below, various options being considered for the integral monolithic construction of the same, depending on the characteristics of the land or ground on which the structure, for example, a boundary wall, is to be built, the dimensions of the same or, simply, the user's personal preference. Irrespective of these aspects, the common basic ideas on which the construction principles for the same will be based are described below.

FIG. 233 represents a template (286) for the creation on top of the ground of the foundation raft which will subsequently be used for seating the mould for the boundary wall, garden wall or similar to be constructed, and, showing the mechanism used for making good minor differences in level in the land on which building is to take place. This mechanism, which has considerable practical application, consists of a drilled rectangular plate (287), to which reinforced end-pieces on the template's double element (289), which has an upper part (290) and a lower part (291, at right angles, are secured, at the height required. For adjusting the said template (286) heightwise and for making good any differences in level in the land on which it is seated, use is made of the aforementioned self-centring securing screws (96) which secure the said reinforced ends (288), drilled with oblong orifices (7), to the adjustment plate (287), which has matching oblong holes on the ends of its laterals and at different heights on the same.

To ensure that the elements of the template, which will give the foundation raft for the boundary wall, garden wall or the like its form, are perfectly aligned and adjusted, and to indicate, with precision, the thickness and structure of the same, use is made of adjustment angles (292), drilled longitudinally at their ends with round orifices at different levels, which are secured by means of self-centring clamps (8) to plates (293) positioned on the upper part (290) of the template element (289).

As a final securing element for the said template, provision is made for the use of anchorages (11) which, once nailed to the ground, afford the said template total stability, which is essential for achieving a raft of millimetric precision and without errors which will subsequently have repercussions on the said boundary wall, garden wall or division.

FIG. 234 shows, in perspective and conveniently cross-sectioned, the inverted L-shaped upper (290) and lower (291) double profile (289) of the template (286), which allows for achieving, after concreting, a stepped wall raft (295), which is represented in the said figure inside the said template (286). Moreover, it is possible to appreciate the perfect separation of the template elements at the appropriate distance by means of the adjustment angle (292) secured by means of self-centring clamps (8) to the plates (293) which are positioned on the said elements for such purposes, it also being possible to appreciate other rectangular plates emerging from the said elements, provided with a central orifice through which an anchorage (11) is inserted to secure the template (286) to the ground (296) (cross-sectioned in this figure) with total precision, so that it does not shift or suffer any variation during the process of casting the concrete for the foundation raft (295) which is formed inside the same.

FIG. 235 shows, in perspective, a stepped raft (295), as formed inside the template.

On the basis of the details depicted in FIGS. 233 to 235, FIG. 236 shows a general view, in perspective and as a partial cross-section, of the positioning of the template (286) on the ground (296) that has been previously excavated and prepared, in which it is possible to observe, in schematic form and by way of an example, the double profile of the template (289), secured to the ground by means of anchorages (11), which allows for the construction of the raft with a stepped form perfectly seated on the ground and with the appropriate resistance, in keeping with calculations, in accordance with standards in force at the site for the stability and anchorage to the ground of the said boundary wall or garden wall to be constructed. It also shows, once again, the angles (292) secured by means of self-centring clamps (8) to the plates (293) on the template (286), which serve as a reinforcement and securing mechanism, as well as for determining the exact distance between each of the profiles in the said template, which serve as a mould for the concrete raft for the wall. Finally, it is possible to appreciate, in the said figure, the deeper excavations realised in the said ground (296) for positioning rounded pits (297) which house the reinforcement rods (20), joined together with hoops (298), the position of which indicates the places where, subsequently, the tall pillars in the boundary wall will be constructed, and the standby rods (21) for the said boundary wall or division are also depicted.

FIG. 237 shows the result obtained following concreting and removal of the template (286) for the wall raft represented in the previous figure, it being possible to observe both the said stepped raft (295), for subsequent construction of the wall, and the reinforcements (20) bound with hoops (298) and also the standby rods (21) suitably positioned for subsequent assembly of the mould that will give form to the boundary wall, garden wall or similar.

FIG. 238 is a perspective view of the mould assembly for construction of the wall, formed of modular panels (41) and other elements inherent in the refinements to the system covered by the invention, the mould being positioned on top of the said raft (295). In this modular structure, provision is made for recesses for electrical boxes (75), water meters (299), and other installations necessary, so that the result obtained using the mould is, in this case too, a solid, integral and monolithic structure, with all the elements and installations envisaged inside the same.

FIG. 239 depicts, in detail, the structure of the mould (300) for the bottom part of the wall, showing provision made therein for suitable modular parts for creating the recesses for the pipes or bars (301) in the said wall which will subsequently surround the dwelling or construction it encloses. Moreover, it is possible to appreciate a tubular U-shaped separator/tie (302) used for securing the mould, which serves a dual purpose: serving as a reinforcement so that, when the liquid concrete is poured into the mould, this does not yield under the pressure exerted and, at the same time, keeping the faces of the panels (41) that make up the mould separated, at a specified distance, so that the boundary wall cast inside the same is even and equidistant at all points. This is a single separator/tie, which is easy to install and dismantle, that allows for speeding up the rate of construction, and at the same time guarantees high-precision results.

FIG. 240 shows a section of the mould for the bottom part of the wall (300), in which it is possible to observe the separator/tie (302), as well as the internal structure of the modular panels (41) that comprise boxes of trapezoidal form (303) on the internal face, which give a chamfered form to the peripheral profile of the whole wall in order to provide the same with a decorative form.

FIG. 241 represents a general view of the same wall once it has been concreted (304) and seated on top of the said raft (295), showing the recesses created for the relevant electrical boxes (75), water meters (299), or similar, in the said structure during the process of integral concreting of the same.

FIG. 242 shows, by way of an example, a column in a boundary wall, with the electricity (75) and water (299) meters already installed in the spaces left, as well as bars (305) inserted into their respective recesses formed in the boundary wall, such bars being useful for erecting metal screens or screens made from some other material on the boundary wall, garden wall or division.

In FIG. 243, it is possible to appreciate, in even greater detail, a lower section of the wall (300), where, using the mould, as shown in FIG. 240, a chamfered form (306) has been created as an embellishment.

This methodology for the construction of boundary walls seated on top of foundation rafts is one of the refinements created and explained in the present invention, although it is just a constructional option, since the invention also covers another new high-precision mechanised method for the fabrication of boundary walls, garden walls or divisions which are secured to the ground itself, without any need for creating, beforehand, a foundation raft like that shown above.

The said mechanised method is explained below with a view to specifying its features and providing an account of the new developments introduced into the system, which extend and considerably improve patent P9401135 granted in respect of the same applicant.

FIG. 244 depicts an example of application of the new modular and integral formwork system for the construction of boundary walls, which serves the same purpose and affords the same basic principles as that described above, the difference being that in this case the boundary wall, garden wall or division is constructed directly on top of the land or ground itself (296), after digging a trench (307) of suitable dimensions. Its use as an alternative to the boundary wall seated on top of a raft will depend, of course, on the actual characteristics of the land.

The modular panels (41) for the wall have, as has already been indicated, a relief on their inner face, preferably of trapezoidal form, to form the chamfer or ornamentation for the wall (303), and they have, at their ends, semicircular recesses (308) which, when matched up with those on the adjoining panel, form a complete circular orifice to allow for the insertion of tapered wall separators (98) which are complemented by their corresponding locking retainer clip (99), which define, with absolute precision, the distance between the mould panels on either side of the wall structure.

These modular panels (41) rest directly on reinforced rectangular plates (309) which have a central orifice (310) at one end, such plates being positioned at a distance of approximately one metre from one another and being secured to the ground by means of anchorages (11) inserted into the said central orifices (310). The said plates (309) serve as a support so that the panels that form the mould cannot slip and fall into the holes in the ground excavated for the foundations for the wall.

For levelling and securing the modular structure, use is made of alignment joists (46) on both the upper and lower part, as can be observed in the said FIG. 244. The upper joist is supported by angles (311), which have rectangular rebates for supporting and fitting the said joists, as shown in FIG. 245, these also being positioned at distances of approximately one metre apart and being secured to the panels with the appropriate self-centring clamps (8) via drilled rectangular lugs (312) positioned on either side of the base of the said angle (311) for securing the joists. This is a simple, practical and effective part, which ensures perfect alignment of the formwork, and, at the same time, helps to reinforce the structure so that it does not suffer any modification during casting of the concrete inside the same.

For its part, the lower joist, which is depicted in FIG. 244, is secured to the ground by means of inverted brackets (313), with the help of an attachment clamp (314) that is built into the same. These brackets are easily positioned and removed, owing to their structure, and secure the joists, aligning the formwork and preventing the same from shifting.

In FIG. 246, it is possible to observe a detail of how the said attachment clamp (314) on the bracket (313) is attached to the two peripheral plates (93) on the adjoining modular panels (41) of the mould by means of their matching round orifices (79), so that they are joined together as shown in FIG. 244. Securing of the same is simple, since they just have to be attached to the plates and placed in the appropriate position, as shown by the downward arrow on the figure, whereas their removal following concreting is also easy, by raising them and disconnecting them.

FIG. 247 depicts a variant of the new method for constructing boundary walls on top of the ground itself, which also constitutes an improvement in several construction aspects. Firstly, it uses a formwork which, because of all the elements that make up the same, affords simple, fast assembly, with total guarantees in terms of safety and high precision in the concreting thereof.

Secondly, the improvements in the aspects of securing, anchorage, attachment and alignment of the said formwork imply that it is stable in terms of its exact position, so that it cannot yield inwards or outwards once the casting material has been poured in, despite the high pressures that this can exert on the structure.

Here, several new elements are combined, these being: a ridged rod as a separator/tie (315) for the formwork, a moving angle (316) with a tube (317) welded on to its outer end for inserting and securing the ridged rod, the aforementioned alignment joists (46), the bottom ones having suitable welded angular plates (318) for securing the moving angle (316) and, finally, support angles (319) for the said formwork which, at the same time, support the said lower alignment joist (46).

FIG. 248 represents, on a larger scale, the said new elements for the separation, determination of distances and securing of the formwork for boundary walls, garden walls or divisions, as seen in the previous figure.

As represented in FIGS. 247 and 248, the lower alignment joist (46) is placed in position resting on the ground (296) and against the rear face of the modular panels (41). The land has been excavated beforehand, to create a longitudinal trench (307), a ridged rod, bent into a U-shape (315) being placed in position as a separator element, its dimensions corresponding to the thickness of the wall to be constructed, and in turn this prevents the said joist from turning and prevents the said formwork that rests on top of the same from shifting outwards under the pressure exerted during casting of the concrete inside the mould. This is achieved thanks to the action of drilled angular plates (318) which are welded on to the said lower joist (46) and a moving angle (316) of the same height, likewise drilled so that their respective orifices match, and which can be secured thanks to the self-centring clamps (8). The said moving angle has a tube (317) welded on to its outer end, the said ridged rod (315) fitting into the said tube. This results in a simple, fast and effective form of securing the formwork, which will be held firmly in place without its being able to shift or yield under any pressure from the casting material subsequently poured into the same or any other unforeseen event. Moreover, dismantling is guaranteed without any problems, since all that has to be done is remove the self-centring clamp (8) which joins the moving angle (316) to the angular plates (318), remove the said moving angle (316) and, immediately afterwards, remove the lower joist (46) followed by the panels (41) of the said formwork, leaving, as the result, the concreted boundary wall. To complete this operation, the ends of the ridged rod (315), which may protrude from the wall, are cut off.

On the other hand, FIG. 249 shows the part that is placed in position as an alternative to that described above in FIG. 248. This is a support angle (319) consisting of a rectangular plate that is wider than it is high, which has an orifice on its flat horizontal end, which is placed in position on top of the ground (296) and which supports the modular panels (41) that form the said formwork for the boundary wall, so that this is secured and centred by means of this support angle (319) which, once secured to the ground by means of the corresponding anchorage (11) inserted into the orifice in the plate on the said support angle (319), serves to align the said formwork perfectly, without this being able to shift outwards thanks to this anchorage (11), to the angles and to the joists represented in the previous figure. Moreover, as this plate (319) has a right-angle structure and is perfectly secured to the ground, it prevents the said formwork from being able to yield inwards, since the vertical part is kept in line and does not allow the formwork to yield inwards.

These new parts detailed in FIGS. 248 and 249 allow for creating boundary walls, garden walls or divisions in a safe, simple, mechanised way, without errors and with high precision in terms of the process of assembly, dismantling and final result of the same.

The construction of boundary walls, garden walls or divisions is not only possible on land that is more or less smooth and flat, but can also be realised on land with pronounced differences in level, thanks to the new terracing system represented in FIG. 250. In this figure, it is possible to observe how boundary walls can be constructed on land with considerable differences in level, through use of a method that combines what has been stated above (cf. FIG. 47) with the improvements and refinements to the boundary wall system described in FIGS. 247 to 249.

For such purposes, the modular panels (41) necessary for making good the difference in height of the land are used and, flush with the ground, the formwork is placed in position for the boundary wall, with all the components listed in FIG. 247. On the lower part of the terrace (320), the angular support plate (319) is placed in position, which, once secured to the said ground by means of anchorages (11), supports the alignment joist (46). This ensures levelling, alignment and securing of the corresponding panel, preventing the same from slipping inwards or outwards in respect of the difference in level.

Furthermore, at the point where this difference in level occurs in the ground (321), ridged rods (315), smaller than those used in boundary walls without differences in level, are placed in position, since the lower alignment joist (46) to be placed in position forms an overhang, not requiring securing angles or manoeuvring space, unlike the complementary joist which rests on the ground on the upper part of the difference in level (321), which is secured in the way already explained in FIGS. 248 and 249. Finally, the upper part of the formwork for the boundary wall is aligned by means of other alignment joists (46) held in place by brackets (44) secured to the peripheral plates (93) on the modular panels (41) in the formwork.

FIG. 251 represents, by way of an example, a new form for a boundary wall, garden wall or division, formed of modular panels (41), positioned directly on the ground, which has been excavated beforehand, so that the structure, once concreted, is perfectly secured to the ground. Its construction is realised using either of the two systems described and represented in FIG. 244 or 247. In this modular structure, provision has been made for the recesses for electrical boxes (75), water meters (299), anchorages for railings and the like.

In the case represented, the lower alignment joists (46) are secured to the ground by means of inverted brackets (313), with a built-in securing clamp (314), which prevent movement of the mould, and the upper joists are supported by other simple brackets (44), with a built-in securing clamp, likewise used on terraces for identical purposes (cf. FIG. 44).

As a reinforcement for securing the mould, use is made of stabilisers (322) (already identified), secured to the peripheral plates (93) of the adjoining modular panels (41), which are aligned with reinforcement boards (327) positioned on top of supports (323) located at different heights on the said stabiliser, as necessary.

FIG. 252 shows, in plan view and schematically, the method of centring the pillars and dividing walls of the said boundary wall. For this, use is made of centring stops (324) secured to the said alignment joists (46), which determine the exact location of each panel in the boundary wall, without leaving any room for error, which speeds up the process of centring and securing each section enormously, by determining, with millimetric precision, the spaces for doors and gateways within the said boundary wall. It is a very practical and precise system which implies a considerable saving in time since it does not require any adjustment and because of the self-sufficiency that it affords for alignment and centring in a simple and guaranteed way. This stop mechanism on the alignment joists can be used with any type of boundary wall, irrespective of the system used for its construction or the dimensions or form of the same, being of great importance for mechanised and industrialised construction, since it avoids having to realise any type of measurement, which speeds up the process, at the same time affording greater precision.

FIG. 253 shows the same boundary wall as in FIG. 251 once it has been concreted and the formwork that gave it is form has been removed, producing, as can be seen, a completely smooth and precise result.

FIGS. 254 and 255 depict another representative example, with a different design, which can be produced using the system covered by the present invention, the first (FIG. 254) with the formwork still in place, with all the elements described above, and the second (FIG. 255) already concreted, in the state referred to as “grey structure”.

FIG. 256 represents one of the stabilisers (of the type already known) (322) used in the system and consisting of a fixed tube (325), which is secured to the peripheral plates (93) on the adjoining modular panels (41) in the mould assembly by means of security pins (329), serving, in this way, as additional reinforcement for the boundary wall, and another tube (325′) attached to the foot. It is also possible to observe the positioning of reinforcement boards (327) positioned on top of the supports (323) on the said stabiliser. Moreover, as a complementary measure, it has a central adjustment handle (172) which acts upon a rod with a double left-hand and right-hand thread, which brings together or separates the two tubular elements of the stabiliser (325-325′).

FIG. 257 shows a new variant of the telescopic stabiliser (322′). Its function is the same as that of the known stabiliser, and its special feature stems from its having a tube that is drilled at several points (328) which can be slid inside another, likewise drilled (326) and adjustable in height, which allows for supporting the modular panels for walls of different heights at a suitable point, as applicable in each case. A security pin (329) adjusts and secures the said tubes at the required height by passing through the matching drilled holes in each of them and a stabiliser jack (9) anchors the same to the ground, in a non-slip and safe manner.

At the rear of the telescopic stabiliser, there is a removable support (330) held in place by screws (330′) for supporting the reinforcement boards (327), so that it can be removed when necessary and/or when it impedes securing of the extendible tube (328) to the formwork at the required height.

This stabiliser is easy to handle and has great practical application since it keeps the mould in the exact position without yielding to the pressures of the concrete cast inside the same, affords it rigidity and keeps it aligned so that the boundary wall remains in its exact position.

Pillars and columns are absolutely necessary structures in construction, and the system or process described below for producing the same is provided with a series of advantages and technical details which speed up the construction sequence for the same enormously, in addition to affording high-quality results, thanks to the high precision of the formwork used.

FIG. 258 represents a pillar with its formwork consisting of modular panels (41), which are attached to one another by means of self-centring clamps (8), using, at the corners thereof, the reinforced external angles (90) inherent in the system, for perfect installation and adjustment of the whole assembly. In the said pillar or column, the plumb level mechanism developed in these refinements for ensuring perfect alignment and affording rigidity and verticality for the whole assembly is depicted. This is a mechanism which consists of two small angles, one at the top (331) and another at the bottom (332), which are secured by means of self-centring clamps (8) to the top and bottom parts, respectively, of one of the reinforced external angles (90) that join the formwork for the pillar or column at its corners.

FIG. 259 shows the way in which the upper angle (331), drilled with oblong orifices (7), is attached, using self-centring clamps (8), to the reinforced external angle (90) which joins the two lateral plates of two adjoining modular panels (41) in the modular formwork for the pillar, and, as a consequence of this, the faces of the said panels are positioned at right angles.

The upper angles (331) for defining the plumb level have a strap handle (334) for gripping the said formwork as a whole, thanks to hitch elements the crane has, which will be referred to later on. The said plumb-level angle (331) will be secured by means of self-centring clamps (8) to the external angle (90) of the formwork for the pillar or column, using another of these on the side diagonally opposite the location or position of the first angle (331) in the formwork, so that, as a consequence of this distribution, the said formwork for the pillar or column can be transferred in a balanced manner under safe conditions, as a whole, to the position required.

Thus, as can be appreciated in FIG. 260, for facilitating the rigidity of the angle (331), there is a complementary part with a U-shaped section (333) duly welded to both angular faces of the said angle, this part being complemented by a pivot (335) to which a string (336) supporting the appropriate plumb bob (339) is attached. This complementary part (333), for centring the string (336) on the said plumb bob (339), has a recess (337) on its edge, which acts as a guide.

Similarly, FIG. 261 shows the lower angle (332) which acts in the same way as the top one, with the addition, in the central area of the complementary part, likewise U-shaped (333′), as shown in FIG. 262, of a circular hole (338) which provides the suitable position for insertion of the said plumb bob (339), which hangs, held by the string (336), from the upper angle (331) by means of the part (333) containing the recess (337).

FIG. 263 represents the precision plumb bob (339) which allows for defining the plumb level of a column or pillar in a simple, fast and safe manner. For this, this plumb bob has two triangular centring washers, a fixed one at the top (340) welded on to the said precision bob (339) at the top, and another moving triangular washer at the bottom (341), which is attached to the said bob by means of a specific security pin (342) once the said precision bob (339) has been inserted into the centre of the centring orifice (338) on the part with a U-shaped section (333′) (cf. FIGS. 261 and 262) belonging to the lower angle (332) for defining the plumb level of the column or pillar, since it is at just this point that the plumb mechanism described will indicate the perfect verticality of the formwork for the column or pillar in question.

The reason why the centring washers (340 and 341) have a triangular geometrical form is that the said structure allows the worker, by direct vision, to check and verify that the precision bob (339) is indeed in the centre of the centring orifice (338) intended for such purposes, without there being anything that would prevent good visibility of the same for corroborating the fact that the formwork for the pillar or column is perfectly plumb.

Once the plumb bob (339) has been centred within the said centring orifice (338), to indicate a perfect plumb level, and the said bob has been secured without any possibility of its coming out from the said orifice or being moved off-centre, thanks to the securing mechanism afforded by the triangular washers (340 and 341), as depicted in FIG. 262, the formwork for the pillar or column can be lifted and transferred by crane to its corresponding position, as shown in FIGS. 264 to 267, without the verticality of the same being altered, thanks to the centring facilitated by the plumb mechanism described and also thanks to the sufficient margin for swinging of the precision bob (339) and the string from which it is suspended (336), which allows a certain movement and flexibility without this affecting the plumb level defined.

In FIG. 264, it is possible to observe a hitch (343) similar to that in FIG. 162, which allows for transferring a complete form for a pillar, column or part thereof. This hitch (346), triangular in form, and attached by the crane's straps (347), has safety chains (345) which end in their respective hooks (344), which are inserted into the strap handles (334) on the upper angles (331) represented in FIG. 260. During transfer of the assembly, as has already been indicated, the plumb level of the same is not affected in the least, although the mechanism described allows the plumb bob and the string from which it hangs to sway sufficiently, to ensure that there is no possibility of snapping the said string.

FIGS. 265 to 267 show a sequence of the processes of gripping and unhooking a pillar or column that has previously been assembled, using the crane hitch (343) in the previous figure. The said processes, thanks to the hook (344), are realised without any problems and, what is more important, without any help from any worker.

Indeed, FIG. 265 represents gripping of the said formwork by means of the strap handles (334) using the said hooks (344) prior to transferral. FIGS. 266 and 267 show unhooking of the same once it has been transferred to the point required. For this, the crane slackens and de-stresses the chains (345) which support the said hooks (344), and these drop straight down, as can be seen more clearly in FIG. 266, and, when they come up against the upper angle (331), to which the strap handle (334) is welded, they move outwards as a result of the position of the securing chain (345), as can be appreciated more clearly in FIG. 267.

Intervention on the part of the worker is therefore replaced by the action of the crane itself which, in its normal movement and thanks to the design and position of the two upper angles (331), located diagonally opposite one another, and to the practical straps (344) conceived for such purposes, allows for hitching up or removal of the crane's hooks (344) from the strap handles (344) referred to above, for lifting, transferring and releasing the form for the pillar or column, as appropriate.

As represented in FIG. 268, thanks to this hitch (343) covered by the invention, the crane positions the perfectly assembled and plumbed mould in the place required, by gripping it by the said straps (334), leaving, inside the said mould, the necessary reinforcements (20) secured to the standby rods (21) welded on to the foundation raft (27), which will constitute the core of the column or pillar.

Finally, and as yet another aspect of the great practical usefulness of the said crane hitch (343), FIG. 269 depicts how the said hitch allows for removal of the mould formwork for the pillar or column. Using the crane and its hitch (343), the said formwork is pulled by means of the strap handles (334) in such a way that the said formwork opens up, leaving the actual pillar or column (346) already cast inside the same. The reticular reinforcements (20) remain inside the body of the column as reinforcement for the same. The final result is a smooth column (346), on which no joins are visible, thanks to the high-precision system with which it has been constructed, and is perfectly plumb, thanks to the simple, practical and mechanised mechanism used for such purposes.

In short, the adaptability and versatility of the new high-precision modular formwork system covered by the present invention allows for putting into practice, on site, any type of design planned and drawn up beforehand, by technicians, without any limitation in terms of form, dimensions or structure. This is so as a consequence of the refinements introduced in each of the construction phases or stages of the system covered by the present invention, which constitute a system that goes beyond the construction of structures, or their application for specific constructions, but which afford an overall formula for constructing, in a modern, mechanised, industrialised and rationalised way, any design planned beforehand, with the intention of modifying and improving the sphere of construction known up until now, based on obsolete concepts, in many cases, that have remained anchored in time without any substantial advances that would have caused it to evolve.

All the elements, tools, implements and procedures inherent in execution of the subject of the invention are aimed at achieving an orderly and rationally organised construction sequence, divided into logical phases and which, when suitably combined, mechanise the construction system, that is in keeping with the present times and affords a multitude of advantages, as explained, over traditional construction systems.

1. A foundation framework for structures in a reinforced setting material, comprising:
a foundation raft, said foundation raft comprising a form having a plurality of modular panels, said modular panels including faces and peripheral plates, said faces forming at least one right-angle dihedral;
angular reinforcements for joining at least two faces of the at least one right-angle dihedral, said reinforcements having oblong orifices for resisting pressure exerted by the setting material;
layout and positioning template disposed on top of the form of the foundation raft for correctly dimensioning, positioning, and fitting walls, installations and reinforcements in the foundation raft;
adjustment legs for centering the layout and positioning template, wherein said adjustment legs protrude through openings in said peripheral plates;
self-centering clamps, wherein said self-centering clamps extend through oblong holes in external lateral plates on said modular panels to connect said modular parts to one another; and
a stabilizer having security pins and an anchorage means for securing the form to a support surface.

2. The foundation framework according to claim 1, wherein the layout and positioning template comprises a plurality of separate elements, said elements having reinforced tie rods, wherein said tie rods facilitate alignment and transportation of elements to be positioned in the foundation raft.

3. The foundation framework according to claim 1, wherein said layout and positioning template includes an integrated centering device for accurate positioning of outlets for piping and drains in structures positioned in the foundation raft.

4. The foundation framework according to claim 3, wherein said foundation raft includes a mold for at least one sanitation chamber, wherein said mold for the at least one sanitation chamber is connected to said outlets via said piping and wherein said outlets for drains lead to positions outside the foundation raft.

5. The foundation framework according to claim 1, wherein the peripheral plates on the modular panels are inclined at selected angles to facilitate dismantling of the modular panels following pouring and setting of the setting material.

6. The foundation framework according to claim 1, wherein each of the self-centering clamps comprises a U-shaped element having two arms and a base, wherein a first one of said two arms is longer than a second one of said two arms, wherein said longer, first one of the two arms is bent at one end to be parallel to the base of the U-shaped element, wherein a free end of the second one of the two arms is pointed for insertion into at least one centering orifice and at least one orifice in two adjoining peripheral plates, whereby said U-shaped element holds said plates together.

7. The foundation framework according to claim 1, wherein each of the self-centering clamps comprises two parts, wherein a first part is a U-shaped element and a second part is an angled element bent into right-angles to terminate in a point, wherein the U-shaped element holds the peripheral plates together and the angled element centers the plates.

8. The foundation framework according to claim 1, further comprising tapered wall separators inserted in circular recesses formed by four corners of adjoining modular panels, wherein said tapered wall separators comprise a tapered head with a double handle and a body comprising a shaft terminating in said tapered head, wherein said wall separators determine and define distances between the modular panels.

9. The foundation framework according to claim 1, and further comprising a separator mechanism for securing and defining a distance at a lower end of a frame for a door, wherein said separator mechanism includes securing plates on at least one end and a central spindle with at least two adjustment stops attached thereto for establishing an appropriate door separation distance, wherein the separator is secured to the form by means of the self-centering clamps.

10. The foundation framework according to claim 1, further comprising a wall template, said wall template comprising a plurality of tubular elements transversely drilled with a plurality of orifices spaced at equal distance from one another, said wall template positioned and attached on top of a completed foundation raft by fitting said wall template into U-shaped stop parts secured to said foundation raft, said wall template adapted to precisely position and defined thicknesses of peripheral walls and partitions of a completed structure.

11. The foundation framework according to claim 1, further comprising modular covers joined to the modular panels by means of self-centering securing devices, wherein said modular covers comprise two adjoining halves, wherein each of said halves has a protruding prismatic box on a front face, wherein each of said halves has a shorter, oblique side complementing an oblique angle on the other half to facilitate dismantling of the modular cover following casting of the setting material.

12. The foundation framework according to claim 1, further comprising a set of elements comprising a group of at least two abutting covers for use in construction of continuous walls, wherein said covers are secured by means of self-centering clamps and right-angle brackets to modular panels forming a peripheral wall, wherein a recess is formed between said at least two abutting covers, wherein a reticular reinforcement rod extends through and out of said recess for assembly of a further mold onto said assembled cover.

13. The foundation framework according to claim 1, further comprising a cover for a ceiling of a room being constructed in said framework, wherein said cover simultaneously comprises an intermediate slab between a lower floor and an upper floor, wherein reticular reinforcements are formed on top of templates provided on said support surface and wherein standby rods are joined to said reticular reinforcements at corresponding points indicated by the template for accurately positioning walls and internal partitions on the upper floor.
